(19) United States
(12) Patent Application Publication
(10) Pub. No.: US 2005/0210145 A1
(43) Pub. Date: Sep. 22, 2005

(54) Delivering and processing multimedia bookmark

(75) Inventors: Hyeokman Kim, Seoul (KR); Ja-Cheon Yoon, Seoul (KR); Sanghoon Sull, Seoul (KR); Jung Rim Kim, Seoul (KR); Seong Soo Chun, Songnam City (KR)

Correspondence Address: D.A. STAUFFER PATENT SERVICES LLC, 1006 MONTFORD ROAD, CLEVLAND HTS., OH, 44121-2016, US

(73) Assignee: Vivcom, Inc., Palo Alto, CA (US)

(21) Appl. No.: 11/071,894

(22) Filed: Mar. 3, 2005

Related U.S. Application Data
(63) Continuation-in-part of application No. 09/911,293, filed on Jul. 23, 2001.
(63) Continuation-in-part of application No. 10/361,794, filed on Feb. 10, 2003.
(63) Continuation-in-part of application No. 10/365,576, filed on Feb. 12, 2003.
(60) Provisional application No. 60/550,200, filed on Mar. 4, 2004.
(60) Provisional application No. 60/550,534, filed on Mar. 5, 2004.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.
(60) Provisional application No. 60/359,564, filed on Feb. 25, 2002.
(60) Provisional application No. 60/359,566, filed on Feb. 25, 2002.
(60) Provisional application No. 60/434,173, filed on Dec. 17, 2002.

(51) Int. Cl. G06F 15/16

(52) U.S. Cl. 709/231; 709/219

(57) ABSTRACT

A multimedia bookmark (VMark) bulletin board service (BBS) system comprises: a web host comprising storage for messages, a web server, and a VMark BBS server; a media host comprising storage for audiovisual (AV) files, and a streaming server; a client comprising storage for VMark, a web browser, a media player and a VMark client; and a VMark server located at the media host or at the client; a communication network connecting the web host, the media host and the client. A method of performing a multimedia bookmark bulletin board service (BBS) comprises: creating a message including a multimedia bookmark for an AV file; and posting the message into the multimedia bookmark BBS. A method of sending multimedia bookmark (VMark) between clients comprises: at a first client, making a VMark indicative of a bookmarked position in an AV program; sending the VMark from the first client to a second client; and playing the program at the second client from the bookmarked position. A system for sharing multimedia content comprises: a multimedia bookmark bulletin board system (BBS); and means for posting a multimedia bookmark to the BBS.

### CROSS-REFERENCE TO RELATED APPLICATIONS

All of the below-referenced applications for which priority claims are being made, or for which this application is a continuation-in-part of, are incorporated in their entirety by reference herein.

This application claims priority of U.S. Provisional Application No. 60/550,200 filed Mar. 4, 2004.

This application claims priority of U.S. Provisional Application No. 60/550,534 filed Mar. 5, 2004.

This is a continuation-in-part of U.S. patent application Ser. No. 09/911,293 filed Jul. 23, 2001 (published as U.S. 2002/0069218 A1 on Jun. 6, 2002), which is a non-provisional of:
U.S. Provisional Application No. 60/221,394 filed Jul. 24, 2000;
U.S. Provisional Application No. 60/221,843 filed Jul. 28, 2000;
U.S. Provisional Application No. 60/222,373 filed Jul. 31, 2000;
U.S. Provisional Application No. 60/271,908 filed Feb. 27, 2001; and
U.S. Provisional Application No. 60/291,728 filed May 17, 2001.

This is a continuation-in-part of U.S. patent application Ser. No. 10/361,794 filed Feb. 10, 2003 (Published as U.S. 2004/0126021 on Jul. 1, 2004), which claims priority of U.S. Provisional Application No. U.S. Ser. No. 60/359,564 filed Feb. 25, 2002.

This is a continuation-in-part of U.S. patent application Ser. No. 10/365,576 filed Feb. 12, 2003 (Published as U.S. 2004/0128317 on Jul. 1, 2004), which claims priority of U.S. Provisional Application No. 60/359,566 filed Feb. 25, 2002 and of U.S. Provisional Application No. 60/434,173 filed Dec. 17, 2002.

### TECHNICAL FIELD

The present disclosure relates to multimedia bookmark and an electronic bulletin board system (hereinafter referred to as a “BBS”) on computer networks. As used in this disclosure, the term multimedia bookmark includes video bookmark (VMark).

### BACKGROUND

Advances in technology continue to create a wide variety of contents and services in audio, visual, and/or audiovisual (hereinafter referred generally and collectively as “audio-visual” or audiovisual”) programs/contents including related data(s) (hereinafter referred as a “program” or “content”) delivered to users through various media including broadcast terrestrial, cable and satellite as well as Internet.

Digital vs. Analog Television

In December 1996 the Federal Communications Commission (FCC) approved the U.S. standard for a new era of digital television (DTV) to replace the analog television (TV) system currently used by consumers. The need for a DTV system arose due to the demands for a higher picture quality and enhanced services required by television viewers. DTV has been widely adopted in various countries, such as Korea, Japan and throughout Europe.

The DTV system has several advantages over conventional analog TV system to fulfill the needs of TV viewers. The standard definition television (SDTV) or high definition television (HDTV) system allows for much clearer picture viewing, compared to a conventional analog TV system. HDTV viewers may receive high-quality pictures at a resolution of 1920×1080 pixels displayed in a wide screen format with a 16 by 9 aspect (width to height) ratio (as found in movie theatres) compared to analog's traditional analog 4 by 3 aspect ratio. Although the conventional TV aspect ratio is 4 by 3, wide screen programs can still be viewed on conventional TV screens in letter box format leaving a blank screen area at the top and bottom of the screen, or more commonly, by cropping part of each scene, usually at both sides of the image to show only the center 4 by 3 area. Furthermore, the DTV system allows multicasting of multiple TV programs and may also contain ancillary data, such as subtitles, optional, varied or different audio options (such as optional languages), broader formats (such as letterbox) and additional scenes. For example, audiences may have the benefits of better associated audio, such as current 5.1-channel compact disc (CD)-quality surround sound for viewers to enjoy a more complete “home” theater experience.

The U.S. FCC has allocated 6 MHz (megaHertz) bandwidth for each terrestrial digital broadcasting channel which is the same bandwidth as used for an analog National Television System Committee (NTSC) channel. By using video compression, such as MPEG-2, one or more high picture quality programs can be transmitted within the same bandwidth. A DTV broadcaster thus may choose between various standards (for example, HDTV or SDTV) for transmission of programs. For example, Advanced Television Systems Committee (ATSC) has 18 different formats at various resolutions, aspect ratios, frame rates examples and descriptions of which may be found at “ATSC Standard A/53C with Amendment No. 1: ATSC Digital Television Standard”, Rev. C, 21 May 2004 (see World Wide Web at atsc.org). Pictures in digital television system is scanned in either progressive or interlaced modes. In progressive mode, a frame picture is scanned in a raster-scan order, whereas, in interlaced mode, a frame picture consists of two temporally-alternating field pictures each of which is scanned in a raster-scan order. A more detailed explanation on interlaced and progressive modes may be found at “Digital Video: An Introduction to MPEG-2 (Digital Multimedia Standards Series)” by Barry G., Atul Puri, Arun N. Netravali. Although SDTV will not match HDTV in quality, it will offer a higher quality picture than current or recent analog TV.

Digital broadcasting also offers entirely new options and forms of programming. Broadcasters will be able to provide additional video, image and/or audio (along with other possible data transmission) to enhance the viewing experience of TV viewers. For example, one or more electronic program guides (EPGs) which may be transmitted with a video (usually a combined video plus audio with possible additional data) signal can guide users to channels of interest. The most common digital broadcasts and replays (for example, by video compact disc (VCD) or digital video disc (DVD)) involve compression of the video image for storage and/or broadcast with decompression for program presentation. Among the most common compression standards (which may also be used for associated data, such as audio) are JPEG and various MPEG standards.

JPEG

1. Introduction

JPEG (Joint Photographic Experts Group) is a standard for still image compression. The JPEG committee has developed standards for the lossy, lossless, and nearly lossless compression of still images, and the compression of continuous-tone, still-frame, monochrome, and color images. The JPEG standard provides three main compression techniques from which applications can select elements satisfying their requirements. The three main compression techniques are (i) Baseline system, (ii) Extended system and (iii) Lossless mode technique. The Baseline system is a simple and efficient Discrete Cosine Transform (DCT)-based algorithm with Huffman coding restricted to 8 bits/pixel inputs in sequential mode. The Extended system enhances the baseline system to satisfy broader application with 12 bits/pixel inputs in hierarchical and progressive mode and the Lossless mode is based on predictive coding, DPCM (Differential Pulse Coded Modulation), independent of DCT with either Huffman or arithmetic coding.

2. JPEG Compression

An example of JPEG encoder block diagram may be found at Compressed Image File Formats: JPEG, PNG, GIF, XBM, BMP (ACM Press) by John Miano, more complete technical description may be found ISO/IEC International Standard 10918-1 (see World Wide Web at jpeg.org/jpeg/). An original picture, such as a video frame image is partitioned into 8×8 pixel blocks, each of which is independently transformed using DCT. DCT is a transform function from spatial domain to frequency domain. The DCT transform is used in various lossy compression techniques such as MPEG-1, MPEG-2, MPEG-4 and JPEG. The DCT transform is used to analyze the frequency component in an image and discard frequencies which human eyes do not usually perceive. A more complete explanation of DCT may be found at “Discrete-Time Signal Processing” (Prentice Hall, 2^{nd} edition, February 1999) by Alan V. Oppenheim, Ronald W. Schafer, John R. Buck. All the transform coefficients are uniformly quantized with a user-defined quantization table (also called a q-table or normalization matrix). The quality and compression ratio of an encoded image can be varied by changing elements in the quantization table. Commonly, the DC coefficient in the top-left of a 2-D DCT array is proportional to the average brightness of the spatial block and is variable-length coded from the difference between the quantized DC coefficient of the current block and that of the previous block. The AC coefficients are rearranged to a 1-D vector through zig-zag scan and encoded with run-length encoding. Finally, the compressed image is entropy coded, such as by using Huffman coding. The Huffman coding is a variable-length coding based on the frequency of a character. The most frequent characters are coded with fewer bits and rare characters are coded with many bits. A more detailed explanation of Huffman coding may be found at “Introduction to Data Compression” (Morgan Kaufmann, Second Edition, February, 2000) by Khalid Sayood.

A JPEG decoder operates in reverse order. Thus, after the compressed data is entropy decoded and the 2-dimensional quantized DCT coefficients are obtained, each coefficient is dequantized using the quantization table. JPEG compression is commonly found in current digital still camera systems and many Karaoke “sing-along” systems.

Wavelet

Wavelets are transform functions that divide data into various frequency components. They are useful in many different fields, including multi-resolution analysis in computer vision, sub-band coding techniques in audio and video compression and wavelet series in applied mathematics. They are applied to both continuous and discrete signals. Wavelet compression is an alternative or adjunct to DCT type transformation compression and is considered or adopted for various MPEG standards, such as MPEG-4. A more complete description may be found at “Wavelet transforms: Introduction to Theory and Application” by Raghuveer M. Rao.

MPEG

The MPEG (Moving Pictures Experts Group) committee started with the goal of standardizing video and audio for compact discs (CDs). A meeting between the International Standards Organization (ISO) and the International Electrotechnical Commission (IEC) finalized a 1994 standard titled MPEG-2, which is now adopted as a video coding standard for digital television broadcasting. MPEG may be more completely described and discussed on the World Wide Web at mpeg.org along with example standards. MPEG-2 is further described at “Digital Video: An Introduction to MPEG-2 (Digital Multimedia Standards Series)” by Barry G. Haskell, Atul Puri, Arun N. Netravali and the MPEG-4 described at “The MPEG-4 Book” by Touradj Ebrahimi, Fernando Pereira.

MPEG Compression

The goal of MPEG standards compression is to take analog or digital video signals (and possibly related data such as audio signals or text) and convert them to packets of digital data that are more bandwidth efficient. By generating packets of digital data it is possible to generate signals that do not degrade, provide high quality pictures, and to achieve high signal to noise ratios.

MPEG standards are effectively derived from the Joint Pictures Expert Group (JPEG) standard for still images. The MPEG-2 video compression standard achieves high data compression ratios by producing information for a full frame video image only occasionally. These full-frame images, or “intra-coded” frames (pictures) are referred to as “I-frames”. Each I-frame contains a complete description of a single video frame (image or picture) independent of any other frame, and takes advantage of the nature of the human eye and removes redundant information in the high frequency which humans traditionally cannot see. These “I-frame” images act as “anchor frames” (sometimes referred to as “key frames” or “reference frames”) that serve as reference images within an MPEG-2 stream. Between the I-frames, delta-coding, motion compensation, and a variety of interpolative/predictive techniques are used to produce intervening frames. “Inter-coded” B-frames (bidirectionally-coded frames) and P-frames (predictive-coded frames) are examples of such “in-between” frames encoded between the I-frames, storing only information about differences between the intervening frames they represent with respect to the I-frames (reference frames). The MPEG system consists of two major layers namely, the System Layer (timing information to synchronize video and audio) and Compression Layer.

The MPEG standard stream is organized as a hierarchy of layers consisting of Video Sequence layer, Group-Of-Pictures (GOP) layer, Picture layer, Slice layer, Macroblock layer and Block layer.

The Video Sequence layer begins with a sequence header (and optionally other sequence headers), and usually includes one or more groups of pictures and ends with an end-of-sequence-code. The sequence header contains the basic parameters such as the size of the coded pictures, the size of the displayed video pictures if different, bit rate, frame rate, aspect ratio of a video, the profile and level identification, interlace or progressive sequence identification, private user data, plus other global parameters related to a video.

The GOP layer consists of a header and a series of one or more pictures intended to allow random access, fast search and edition. The GOP header contains a time code used by certain recording devices. It also contains editing flags to indicate whether Bidirectional (B)-pictures following the first Intra (I)-picture of the GOP can be decoded following a random access called a closed GOP. In MPEG, a video picture is generally divided into a series of GOPs.

The Picture layer is the primary coding unit of a video sequence. A picture consists of three rectangular matrices representing luminance (Y) and two chrominance (Cb and Cr or U and V) values. The picture header contains information on the picture coding type of a picture (intra (I), predicted (P), Bidirectional (B) picture), the structure of a picture (frame, field picture), the type of the zigzag scan and other information related for the decoding of a picture. For progressive mode video, a picture is identical to a frame and can be used interchangeably, while for interlaced mode video, a picture refers to the top field or the bottom field of the frame.

A slice is composed of a string of consecutive macroblocks which is commonly built from a 2 by 2 matrix of blocks and it allows error resilience in case of data corruption. Due to the existence of a slice in an error resilient environment, a partial picture can be constructed instead of the whole picture being corrupted. If the bitstream contains an error, the decoder can skip to the start of the next slice. Having more slices in the bitstream allows better error hiding, but it can use space that could otherwise be used to improve picture quality. The slice is composed of macroblocks traditionally running from left to right and top to bottom where all macroblocks in the I-pictures are transmitted. In P and B-pictures, typically some macroblocks of a slice are transmitted and some are not, that is, they are skipped. However, the first and last macroblock of a slice should always be transmitted. Also the slices should not overlap.

A block consists of the data for the quantized DCT coefficients of an 8×8 block in the macroblock. The 8 by 8 blocks of pixels in the spatial domain are transformed to the frequency domain with the aid of DCT and the frequency coefficients are quantized. Quantization is the process of approximating each frequency coefficient as one of a limited number of allowed values. The encoder chooses a quantization matrix that determines how each frequency coefficient in the 8 by 8 block is quantized. Human perception of quantization error is lower for high spatial frequencies (such as color), so high frequencies are typically quantized more coarsely (with fewer allowed values).

The combination of the DCT and quantization results in many of the frequency coefficients being zero, especially those at high spatial frequencies. To take maximum advantage of this, the coefficients are organized in a zig-zag order to produce long runs of zeros. The coefficients are then converted to a series of run-amplitude pairs, each pair indicating a number of zero coefficients and the amplitude of a non-zero coefficient. These run-amplitudes are then coded with a variable-length code, which uses shorter codes for commonly occurring pairs and longer codes for less common pairs. This procedure is more completely described in “Digital Video: An Introduction to MPEG-2” (Chapman & Hall, December, 1996) by Barry G. Haskell, Atul Puri, Arun N. Netravali. A more detailed description may also be found at “Generic Coding of Moving Pictures and Associated Audio Information—Part 2: Videos”, ISO/IEC 13818-2 (MPEG-2), 1994 (see World Wide Web at mpeg.org).

Inter-Picture Coding

Inter-picture coding is a coding technique used to construct a picture by using previously encoded pixels from the previous frames. This technique is based on the observation that adjacent pictures in a video are usually very similar. If a picture contains moving objects and if an estimate of their translation in one frame is available, then the temporal prediction can be adapted using pixels in the previous frame that are appropriately spatially displaced. The picture type in MPEG is classified into three types of picture according to the type of inter prediction used. A more detailed description of Inter-picture coding may be found at “Digital Video: An Introduction to MPEG-2” (Chapman & Hall, December, 1996) by Barry G. Haskell, Atul Puri, Arun N. Netravali.

Picture Types

The MPEG standards (MPEG-1, MPEG-2, MPEG-4) specifically define three types of pictures (frames) Intra (I), Predicted (P), and Bidirectional (B).

Intra (I) pictures are pictures that are traditionally coded separately only in the spatial domain by themselves. Since intra pictures do not reference any other pictures for encoding and the picture can be decoded regardless of the reception of other pictures, they are used as an access point into the compressed video. The intra pictures are usually compressed in the spatial domain and are thus large in size compared to other types of pictures.

Predicted (P) pictures are pictures that are coded with respect to the immediately previous I or P-frame. This technique is called forward prediction. In a P-picture, each macroblock can have one motion vector indicating the pixels used for reference in the previous I or P-frames. Since the a P-picture can be used as a reference picture for B-frames and future P-frames, it can propagate coding errors. Therefore the number of P-pictures in a GOP is often restricted to allow for a clearer video.

Bidirectional (B) pictures are pictures that are coded by using immediately previous I- and/or P-pictures as well as immediately next I- and/or P-pictures. This technique is called bidirectional prediction. In a B-picture, each macroblock can have one motion vector indicating the pixels used for reference in the previous I- or P-frames and another motion vector indicating the pixels used for reference in the next I- or P-frames. Since each macroblock in a B-picture can have up to two motion vectors, where the macroblock is obtained by averaging the two macroblocks referenced by the motion vectors, this results in the reduction of noise. In terms of compression efficiency, the B-pictures are the most efficient, P-pictures are somewhat worse, and the I-pictures are the least efficient. The B-pictures do not propagate errors because they are not traditionally used as a reference picture for inter-prediction.

Video Stream Composition

The number of I-frames in a MPEG stream (MPEG-1, MPEG-2 and MPEG-4) may be varied depending on the applications needed for random access and the location of scene cuts in the video sequence. In applications where random access is important, I-frames are used often, such as two times a second. The number of B-frames in between any pair of reference (I or P) frames may also be varied depending on factors such as the amount of memory in the encoder and the characteristics of the material being encoded. A typical display order of pictures may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org). The sequence of pictures is re-ordered in the encoder such that the reference pictures needed to reconstruct B-frames are sent before the associated B-frames. A typical encoded order of pictures may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

Motion Compensation

In order to achieve a higher compression ration, the temporal redundancy of a video is eliminated by a technique called motion compensation. Motion compensation is utilized in P- and B-pictures at macro block level where each macroblock has a spatial vector between the reference macroblock and the macroblock being coded and the error between the reference and the coded macroblock. The motion compensation for macroblocks in P-picture may only use the macroblocks in the previous reference picture (I-picture or P-picture), while macroblocks in a B-picture may use a combination of both the previous and future pictures as a reference pictures (I-picture or P-picture). A more extensive description of aspects of motion compensation may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

MPEG-2 System Layer

A main function of MPEG-2 systems is to provide a means of combining several types of multimedia information into one stream. Data packets from several elementary streams (ESs) (such as audio, video, textual data, and possibly other data) are interleaved into a single stream. ESs can be sent either at constant-bit rates or at variable-bit rates simply by varying the lengths or frequency of the packets. The ESs consist of compressed data from a single source plus ancillary data needed for synchronization, identification, and characterization of the source information. The ESs themselves are first packetized into either constant-length or variable-length packets to form a Packetized Elementary stream (PES).

MPEG-2 system coding is specified in two forms: the Program Stream (PS) and the Transport Stream (TS). The PS is used in relatively error-free environment such as DVD media, and the TS is used in environments where errors are likely, such as in digital broadcasting. The PS usually carries one program where a program is a combination of various ESs. The PS is made of packs of multiplexed data. Each pack consists of a pack header followed by a variable number of multiplexed PES packets from the various ESs plus other descriptive data. The TSs consists of TS packets, such as of 188 bytes, into which relatively long, variable length PES packets are further packetized. Each TS packet consists of a TS Header followed optionally by ancillary data (called an adaptation field), followed typically by one or more PES packets. The TS header usually consists of a sync (synchronization) byte, flags and indicators, packet identifier (PID), plus other information for error detection, timing and other functions. It is noted that the header and adaptation field of a TS packet shall not be scrambled.

In order to maintain proper synchronization between the ESs, for example, containing audio and video streams, synchronization is commonly achieved through the use of time stamp and clock reference. Time stamps for presentation and decoding are generally in units of 90 kHz, indicating the appropriate time according to the clock reference with a resolution of 27 MHz that a particular presentation unit (such as a video picture) should be decoded by the decoder and presented to the output device. A time stamp containing the presentation time of audio and video is commonly called the Presentation Time Stamp (PTS) that maybe present in a PES packet header, and indicates when the decoded picture is to be passed to the output device for display whereas a time stamp indicating the decoding time is called the Decoding Time Stamp (DTS). Program Clock Reference (PCR) in the Transport Stream (TS) and System Clock Reference (SCR) in the Program Stream (PS) indicate the sampled values of the system time clock. In general, the definitions of PCR and SCR may be considered to be equivalent, although there are distinctions. The PCR that maybe be present in the adaptation field of a TS packet provides the clock reference for one program, where a program consists of a set of ESs that has a common time base and is intended for synchronized decoding and presentation. There may be multiple programs in one TS, and each may have an independent time base and a separate set of PCRs. As an illustration of an exemplary operation of the decoder, the system time clock of the decoder is set to the value of the transmitted PCR (or SCR), and a frame is displayed when the system time clock of the decoder matches the value of the PTS of the frame. For consistency and clarity, the remainder of this disclosure will use the term PCR. However, equivalent statements and applications apply to the SCR or other equivalents or alternatives except where specifically noted otherwise. A more extensive explanation of MPEG-2 System Layer can be found in “Generic Coding of Moving Pictures and Associated Audio Information—Part 2: Systems,” ISO/IEC 13818-1 (MPEG-2), 1994.

Differences Between MPEG-1 and MPEG-2

The MPEG-2 Video Standard supports both progressive scanned video and interlaced scanned video while the MPEG-1 Video standard only supports progressive scanned video. In progressive scanning, video is displayed as a stream of sequential raster-scanned frames. Each frame contains a complete screen-full of image data, with scanlines displayed in sequential order from top to bottom on the display. The “frame rate” specifies the number of frames per second in the video stream. In interlaced scanning, video is displayed as a stream of alternating, interlaced (or interleaved) top and bottom raster fields at twice the frame rate, with two fields making up each frame. The top fields (also called “upper fields” or “odd fields”) contain video image data for odd numbered scanlines (starting at the top of the display with scanline number 1), while the bottom fields contain video image data for even numbered scanlines. The top and bottom fields are transmitted and displayed in alternating fashion, with each displayed frame comprising a top field and a bottom field. Interlaced video is different from non-interlaced video, which paints each line on the screen in order. The interlaced video method was developed to save bandwidth when transmitting signals but it can result in a less detailed image than comparable non-interlaced (progressive) video.

The MPEG-2 Video Standard also supports both frame-based and field-based methodologies for DCT block coding and motion prediction while MPEG-1 Video Standard only supports frame-based methodologies for DCT. A block coded by field DCT method typically has a larger motion component than a block coded by the frame DCT method.

MPEG-4

The MPEG-4 is a Audiovisual (AV) encoder/decoder (codec) framework for creating and enabling interactivity with a wide set of tools for creating enhanced graphic content for objects organized in a hierarchical way for scene composition. The MPEG-4 video standard was started in 1993 with the object of video compression and to provide a new generation of coded representation of a scene. For example, MPEG-4 encodes a scene as a collection of visual objects where the objects (natural or synthetic) are individually coded and sent with the description of the scene for composition. Thus MPEG-4 relies on an object-based representation of a video data based on video object (VO) defined in MPEG-4 where each VO is characterized with properties such as shape, texture and motion. To describe the composition of these VOs to create audiovisual scenes, several VOs are then composed to form a scene with Binary Format for Scene (BIFS) enabling the modeling of any multimedia scenario as a scene graph where the nodes of the graph are the VOs. The BIFS describes a scene in the form a hierarchical structure where the nodes may be dynamically added or removed from the scene graph on demand to provide interactivity, mix/match of synthetic and natural audio or video, manipulation/composition of objects that involves scaling, rotation, drag, drop and so forth. Therefore the MPEG-4 stream is composed BIFS syntax, video/audio objects and other basic information such as synchronization configuration, decoder configurations and so on. Since BIFS contains information on the scheduling, coordinating in temporal and spatial domain, synchronization and processing interactivity, the client receiving the MPEG-4 stream needs to firstly decode the BIFS information that which composes the audio/video ES. Based on the decoded BIFS information the decoder accesses the associated audio-visual data as well as other possible supplementary data. To apply MPEG-4 object-based representation to a scene, objects included in the scene should first be detected and segmented which cannot be easily automated by using the current state-of-art image analysis technology.

H.264 (AVC)

H.264 also called Advanced Video Coding (AVC) or MPEG-4 part 10 is the newest international video coding standard. Video coding standards such as MPEG-2 enabled the transmission of HDTV signals over satellite, cable, and terrestrial emission and the storage of video signals on various digital storage devices (such as disc drives, CDs, and DVDs). However, the need for H.264 has arisen to improve the coding efficiency over prior video coding standards such MPEG-2.

Relative to prior video coding standards, H.264 has features that allow enhanced video coding efficiency. H.264 allows for variable block-size quarter-sample-accurate motion compensation with block sizes as small as 4×4 allowing more flexibility in the selection of motion compensation block size and shape over prior video coding standards.

H.264 has an advanced reference picture selection technique such that the encoder can select the pictures to be referenced for motion compensation compared to P- or B-pictures in MPEG-1 and MPEG-2 which may only reference a combination of a adjacent future and previous picture. Therefore a high degree of flexibility is provided in the ordering of pictures for referencing and display purposes compared to the strict dependency between the ordering of pictures for motion compensation in the prior video coding standard.

Another technique of H.264 absent from other video coding standards is that H.264 allows the motion-compensated prediction signal to be weighted and offset by amounts specified by the encoder to improve the coding efficiency dramatically.

All major prior coding standards (such as JPEG, MPEG-1, MPEG-2) use a block size of 8×8 for transform coding while H.264 design uses a block size of 4×4 for transform coding. This allows the encoder to represent signals in a more adaptive way, enabling more accurate motion compensation and reducing artifacts. H.264 also uses two entropy coding methods, called CAVLC and CABAC, using context-based adaptivity to improve the performance of entropy coding relative to prior standards.

H.264 also provides robustness to data error/losses for a variety of network environments. For example, a parameter set design provides for robust header information which is sent separately for handling in a more flexible way to ensure that no severe impact in the decoding process is observed even if a few bits of information are lost during transmission. In order to provide data robustness H.264 partitions pictures into a group of slices where each slice may be decoded independent of other slices, similar to MPEG-1 and MPEG-2. However the slice structure in MPEG-2 is less flexible compared to H.264, reducing the coding efficiency due to the increasing quantity of header data and decreasing the effectiveness of prediction.

In order to enhance the robustness, H.264 allows regions of a picture to be encoded redundantly such that if the primary information regarding a picture is lost, the picture can be recovered by receiving the redundant information on the lost region. Also H.264 separates the syntax of each slice into multiple different partitions depending on the importance of the coded information for transmission.

ATSC/DVB

The ATSC is an international, non-profit organization developing voluntary standards for digital television (TV) including digital HDTV and SDTV. The ATSC digital TV standard, Revision B (ATSC Standard A/53B) defines a standard for digital video based on MPEG-2 encoding, and allows video frames as large as 1920×1080 pixels/pels (2,073,600 pixels) at 19.29 Mbps, for example. The Digital Video Broadcasting Project (DVB—an industry-led consortium of over 300 broadcasters, manufacturers, network operators, software developers, regulatory bodies and others in over 35 countries) provides a similar international standard for digital TV. Digitalization of cable, satellite and terrestrial television networks within Europe is based on the Digital Video Broadcasting (DVB) series of standards while USA and Korea utilize ATSC for digital TV broadcasting.

In order to view ATSC and DVB compliant digital streams, digital STBs which may be connected inside or associated with user's TV set began to penetrate TV markets. For purpose of this disclosure, the term STB is used to refer to any and all such display, memory, or interface devices intended to receive, store, process, repeat, edit, modify, display, reproduce or perform any portion of a program, including personal computer (PC) and mobile device. With this new consumer device, television viewers may record broadcast programs into the local or other associated data storage of their Digital Video Recorder (DVR) in a digital video compression format such as MPEG-2. A DVR is usually considered a STB having recording capability, for example in associated storage or in its local storage or hard disk. A DVR allows television viewers to watch programs in the way they want (within the limitations of the systems) and when they want (generally referred to as “on demand”). Due to the nature of digitally recorded video, viewers should have the capability of directly accessing a certain point of a recorded program (often referred to as “random access”) in addition to the traditional video cassette recorder (VCR) type controls such as fast forward and rewind.

In standard DVRs, the input unit takes video streams in a multitude of digital forms, such as ATSC, DVB, Digital Multimedia Broadcasting (DMB) and Digital Satellite System (DSS), most of them based on the MPEG-2 TS, from the Radio Frequency (RF) tuner, a general network (for example, Internet, wide area network (WAN), and/or local area network (LAN)) or auxiliary read-only disks such as CD and DVD.

The DVR memory system usually operates under the control of a processor which may also control the demultiplexor of the input unit. The processor is usually programmed to respond to commands received from a user control unit manipulated by the viewer. Using the user control unit, the viewer may select a channel to be viewed (and recorded in the buffer), such as by commanding the demultiplexor to supply one or more sequences of frames from the tuned and demodulated channel signals which are assembled, in compressed form, in the random access memory, which are then supplied via memory to a decompressor/decoder for display on the display device(s).

The DVB Service Information (SI) and ATSC Program Specific Information Protocol (PSIP) are the glue that holds the DTV signal together in DVB and ATSC, respectively. ATSC (or DVB) allow for PSIP (or SI) to accompany broadcast signals and is intended to assist the digital STB and viewers to navigate through an increasing number of digital services. The ATSC-PSIP and DVB-SI are more fully described in “ATSC Standard A/53C with Amendment No. 1: ATSC Digital Television Standard”, Rev. C, and in “ATSC Standard A/65B: Program and System Information Protocol for Terrestrial Broadcast and Cable”, Rev. B 18 Mar. 2003 (see World Wide Web at atsc.org) and “ETSI EN 300 468 Digital Video Broadcasting (DVB); Specification for Service Information (SI) in DVB Systems” (see World Wide Web at etsi.org).

Within DVB-SI and ATSC-PSIP, the Event Information Table (EIT) is especially important as a means of providing program (“event”) information. For DVB and ATSC compliance it is mandatory to provide information on the currently running program and on the next program. The EIT can be used to give information such as the program title, start time, duration, a description and parental rating.

In the article “ATSC Standard A/65B: Program and System Information Protocol for Terrestrial Broadcast and Cable,” Rev. B, 18 Mar. 2003 (see World Wide Web at atsc.org), it is noted that PSIP is a voluntary standard of the ATSC and only limited parts of the standard are currently required by the Federal Communications Commission (FCC). PSIP is a collection of tables designed to operate within a TS for terrestrial broadcast of digital television. Its purpose is to describe the information at the system and event levels for all virtual channels carried in a particular TS. The packets of the base tables are usually labeled with a base packet identifier (PID, or base PID). The base tables include System Time Table (STT), Rating Region Table (RRT), Master Guide Table (MGT), Virtual Channel Table (VCT), EIT and Extent Text Table (ETT), while the collection of PSIP tables describe elements of typical digital TV service.

The STT is the simplest and smallest table in the PSIP table to indicate the reference for time of day to receivers. The System Time Table is a small data structure that fits in one TS packet and serves as a reference for time-of-day functions. Receivers or STBs can use this table to manage various operations and scheduled events, as well as display time-of-day. The reference for time-of-day functions is given in system time by the system_time field in the STT based on current Global Positioning Satellite (GPS) time, from 12:00 a.m. Jan. 6, 1980, in an accuracy of within 1 second. The DVB has a similar table called Time and Date Table (TDT). The TDT reference of time is based on the Universal Time Coordinated (UTC) and Modified Julian Date (MJD) as described in Annex C at “ETSI EN 300 468 Digital Video Broadcasting (DVB); Specification for Service Information (SI) in DVB systems” (see World Wide Web at etsi.org).

The Rating Region Table (RTT) has been designed to transmit the rating system in use for each country having such as system. In the United States, this is incorrectly but frequently referred to as the “V-chip” system; the proper title is “Television Parental Guidelines” (TVPG). Provisions have also been made for multi-country systems.

The Master Guide Table (MGT) provides indexing information for the other tables that comprise the PSIP Standard. It also defines table sizes necessary for memory allocation during decoding, defines version numbers to identify those tables that need to be updated, and generates the packet identifiers that label the tables. An exemplary Master Guide table (MGT) and its usage may be found at “ATSC Standard A/65B: Program and System Information Protocol for Terrestrial Broadcast and Cable, Rev. B 18 Mar. 2003” (see World Wide Web at atsc.org).

The Virtual Channel Table (VCT), also referred to as the Terrestrial VCT (TVCT), contains a list of all the channels that are or will be on-line, plus their attributes. Among the attributes given are the channel name, channel number, the carrier frequency and modulation mode to identify how the service is physically delivered. The VCT also contains a source identifier (ID) which is important for representing a particular logical channel. Each EIT contains a source ID to identify which minor channel will carry its programming for each 3 hour period. Thus the source ID may be considered as a Universal Resource Locator (URL) scheme that could be used to target a programming service. Much like Internet domain names in regular Internet URLs, such a source ID type URL does not need to concern itself with the physical location of the referenced service, providing a new level of flexibility into the definition of source ID. The VCT also contains information on the type of service indicating whether analog TV, digital TV or other data is being supplied. It also may contain descriptors indicating the PIDs to identify the packets of service and descriptors for extended channel name information.

The EIT table is a PSIP table that carries information regarding the program schedule information for each virtual channel. Each instance of an EIT traditionally covers a three hour span, to provide information such as event duration, event title, optional program content advisory data, optional caption service data, and audio service descriptor(s). There are currently up to 128 EITs—EIT-0 through EIT-127—each of which describes the events or television programs for a time interval of three hours. EIT-0 represents the “current” three hours of programming and has some special needs as it usually contains the closed caption, rating information and other essential and optional data about the current programming. Because the current maximum number of EITs is 128, up to 16 days of programming may be advertised in advance. At minimum, the first four EITs should always be present in every TS, and 24 are recommended. Each EIT-k may have multiple instances, one for each virtual channel in the VCT. The current EIT table contains information only on the current and future events that are being broadcast and that will be available for some limited amount of time into the future. However, a user might wish to know about a program previously broadcast in more detail.

The ETT table is an optional table which contains a detailed description in various languages for an event and/or channel. The detailed description in the ETT table is mapped to an event or channel by a unique identifier.

In the Article “ATSC Standard A/65B: Program and System Information Protocol for Terrestrial Broadcast and Cable,” Rev. B, 18 Mar. 2003 (see World Wide Web at atsc.org), it is noted that there may be multiple ETTs, one or more channel ETT sections describing the virtual channels in the VCT, and an ETT-k for each EIT-k, describing the events in the EIT-k. The ETTs are utilized in case it is desired to send additional information about the entire event since the number of characters for the title is restricted in the EIT. These are all listed in the MGT. An ETT-k contains a table instance for each event in the associated EIT-k. As the name implies, the purpose of the ETT is to carry text messages. For example, for channels in the VCT, the messages can describe channel information, cost, coming attractions, and other related data. Similarly, for an event such as a movie listed in the EIT, the typical message would be a short paragraph that describes the movie itself. ETTs are optional in the ATSC system.

The PSIP tables carry a mixture of short tables with short repeat cycles and larger tables with long cycle times. The transmission of one table must be complete before the next section can be sent. Thus, transmission of large tables must be complete within a short period in order to allow fast cycling tables to achieve specified time interval. This is more completely discussed at “ATSC Recommended Practice: Program and System Information Protocol Implementation Guidelines for Broadcasters” (see World Wide Web at atsc.org/standards/a_{—}69.pdf).

DVD

Digital Video (or Versatile) Disc (DVD) is a multi-purpose optical disc storage technology suited to both entertainment and computer uses. As an entertainment product DVD allows home theater experience with high quality video, usually better than alternatives, such as VCR, digital tape and CD.

DVD has revolutionized the way consumers use pre-recorded movie devices for entertainment. With video compression standards such as MPEG-2, content providers can usually store over 2 hours of high quality video on one DVD disc. In a double-sided, dual-layer disc, the DVD can hold about 8 hours of compressed video which corresponds to approximately 30 hours of VHS TV quality video. DVD also has enhanced functions, such as support for wide screen movies; up to eight (8) tracks of digital audio each with as many as eight (8) channels; on-screen menus and simple interactive features; up to nine (9) camera angles; instant rewind and fast forward functionality; multi-lingual identifying text of title name; album name, song name, and automatic seamless branching of video. The DVD also allows users to have a useful and interactive way to get to their desired scenes with the chapter selection feature by defining the start and duration of a segment along with additional information such as an image and text (providing limited, but effective random access viewing). As an optical format, DVD picture quality does not degrade over time or with repeated usage, as compared to video tapes (which are magnetic storage media). The current DVD recording format uses 4:2:2 component digital video, rather than NTSC analog composite video, thereby greatly enhancing the picture quality in comparison to current conventional NTSC.

TV-Anytime and MPEG-7

TV viewers are currently provided with information on programs such as title and start and end times that are currently being broadcast or will be broadcast, for example, through an EPG At this time, the EPG contains information only on the current and future events that are being broadcast and that will be available for some limited amount of time into the future. However, a user might wish to know about a program previously broadcast in more detail. Such demands have arisen due to the capability of DVRs enabling recording of broadcast programs. A commercial DVR service based on proprietary EPG data format is available, as by the company TiVo (see World Wide Web at tivo.com).

The simple service information such as program title or synopsis that is currently delivered through the EPG scheme appears to be sufficient to guide users to select a channel and record a program. However, users might wish to fast access to specific segments within a recorded program in the DVR. In the case of current DVD movies, users can access to a specific part of a video through “chapter selection” interface. Access to specific segments of the recorded program requires segmentation information of a program that describes a title, category, start position and duration of each segment that could be generated through a process called “video indexing”. To access to a specific segment without the segmentation information of a program, viewers currently have to linearly search through the video from the beginning, as by using the fast forward button, which is a cumbersome and time-consuming process.

TV-Anytime

Local storage of AV content and data on consumer electronics devices accessible by individual users opens a variety of potential new applications and services. Users can now easily record contents of their interests by utilizing broadcast program schedules and later watch the programs, thereby taking advantage of more sophisticated and personalized contents and services via a device that is connected to various input sources such as terrestrial, cable, satellite, Internet and others. Thus, these kinds of consumer devices provide new business models to three main provider groups: content creators/owners, service providers/broadcasters and related third parties, among others. The global TV-Anytime Forum (see World Wide Web at tv-anytime.org) is an association of organizations which seeks to develop specifications to enable audio-visual and other services based on mass-market high volume digital local storage in consumer electronics platforms. The forum has been developing a series of open specifications since being formed on September 1999.

The TV-Anytime Forum identifies new potential business models, and introduced a scheme for content referencing with Content Referencing Identifiers (CRIDs) with which users can search, select, and rightfully use content on their personal storage systems. The CRID is a key part of the TV-Anytime system specifically because it enables certain new business models. However, one potential issue is, if there are no business relationships defined between the three main provider groups, as noted above, there might be incorrect and/or unauthorized mapping to content. This could result in a poor user experience. The key concept in content referencing is the separation of the reference to a content item (for example, the CRID) from the information needed to actually retrieve the content item (for example, the locator). The separation provided by the CRID enables a one-to-many mapping between content references and the locations of the contents. Thus, search and selection yield a CRID, which is resolved into either a number of CRIDs or a number of locators. In the TV-Anytime system, the main provider groups can originate and resolve CRIDs. Ideally, the introduction of CRIDs into the broadcasting system is advantageous because it provides flexibility and reusability of content metadata. In existing broadcasting systems, such as ATSC-PSIP and DVB-SI, each event (or program) in an EIT table is identified with a fixed 16-bit event identifier (EID). However, CRIDs require a rather sophisticated resolving mechanism. The resolving mechanism usually relies on a network which connects consumer devices to resolving servers maintained by the provider groups. Unfortunately, it may take a long time to appropriately establish the resolving servers and network.

TV-Anytime also defines the metadata format for metadata that may be exchanged between the provider groups and the consumer devices. In a TV-Anytime environment, the metadata includes information about user preferences and history as well as descriptive data about content such as title, synopsis, scheduled broadcasting time, and segmentation information. Especially, the descriptive data is an essential element in the TV-Anytime system because it could be considered as an electronic content guide. The TV-Anytime metadata allows the consumer to browse, navigate and select different types of content. Some metadata can provide in-depth descriptions, personalized recommendations and detail about a whole range of contents both local and remote. In TV-Anytime metadata, program information and scheduling information are separated in such a way that scheduling information refers its corresponding program information via the CRIDs. The separation of program information from scheduling information in TV-Anytime also provides a useful efficiency gain whenever programs are repeated or rebroadcast, since each instance can share a common set of program information.

The schema or data format of TV-Anytime metadata is usually described with XML Schema, and all instances of TV-Anytime metadata are also described in an eXtensible Markup Language (XML). Because XML is verbose, the instances of TV-Anytime metadata require a large amounts of data or high bandwidth. For example, the size of an instance of TV-Anytime metadata might be 5 to 20 times larger than that of an equivalent EIT (Event Information Table) table according to ATSC-PSIP or DVB-SI specification. In order to overcome the bandwidth problem, TV-Anytime provides a compression/encoding mechanism that converts an XML instance of TV-Anytime metadata into equivalent binary format. According to TV-Anytime, compression specification, the XML structure of TV-Anytime metadata is coded using BiM, an efficient binary encoding format for XML adopted by MPEG-7. The Time/Date and Locator fields also have their own specific codecs. Furthermore, strings are concatenated within each delivery unit to ensure efficient Zlib compression is achieved in the delivery layer. However, despite the use of the three compression techniques in TV-Anytime, the size of a compressed TV-Anytime metadata instance is hardly smaller than that of an equivalent EIT in ATSC-PSIP or DVB-SI because the performance of Zlib is poor when strings are short, especially fewer than 100 characters. Since Zlib compression in TV-Anytime is executed on each TV-Anytime fragment that is a small data unit such as a title of a segment or a description of a director, good performance of Zlib can not generally be expected.

MPEG-7

Motion Picture Expert Group—Standard 7 (MPEG-7), formally named “Multimedia Content Description Interface,” is the standard that provides a rich set of tools to describe multimedia content. MPEG-7 offers a comprehensive set of audiovisual description tools for the elements of metadata and their structure and relationships), enabling the effective and efficient access (search, filtering and browsing) to multimedia content. MPEG-7 uses XML schema language as the Description Definition Language (DDL) to define both descriptors and description schemes. Parts of MPEG-7 specification such as user history are incorporated in TV Anytime specification.

Generating Visual Rhythm

Visual Rhythm (VR) is a known technique whereby video is sub-sampled, frame-by-frame, to produce a single image (visual timeline) which contains (and conveys) information about the visual content of the video. It is useful, for example, for shot detection. A visual rhythm image is typically obtained by sampling pixels lying along a sampling path, such as a diagonal line traversing each frame. A line image is produced for the frame, and the resulting line images are stacked, one next to the other, typically from left-to-right. Each vertical slice of visual rhythm with a single pixel width is obtained from each frame by sampling a subset of pixels along the predefined path. In this manner, the visual rhythm image contains patterns or visual features that allow the viewer/operator to distinguish and classify many different types of video effects, (edits and otherwise) including: cuts, wipes, dissolves, fades, camera motions, object motions, flashlights, zooms, and so forth. The different video effects manifest themselves as different patterns on the visual rhythm image. Shot boundaries and transitions between shots can be detected by observing the visual rhythm image which is produced from a video. Visual Rhythm is further described in commonly-owned, copending U.S. patent application Ser. No. 09/911,293 filed Jul. 23, 2001 (Publication No. 2002/0069218).

Interactive TV

The interactive TV is a technology combining various mediums and services to enhance the viewing experience of the TV viewers. Through two-way interactive TV, a viewer can participate in a TV program in a way that is intended by content/service providers, rather than the conventional way of passively viewing what is displayed on screen as in analog TV. Interactive TV provides a variety of kinds of interactive TV applications such as news tickers, stock quotes, weather service and T-commerce. One of the open standards for interactive digital TV is Multimedia Home Platform (MHP) (in the united states, MHP has its equivalent in the Java-Based Advanced Common Application Platform (ACAP), and Advanced Television Systems Committee (ATSC) activity and in OCAP, the Open Cable Application Platform specified by the OpenCable consortium) which provides a generic interface between the interactive digital applications and the terminals (for example, DVR) that receive and run the applications. A content producer produces an MHP application written mostly in JAVA using a set of MHP Application Program Interface (API) set. The MHP API set contains various API sets for primitive MPEG access, media control, tuner control, graphics, communications and so on. MHP broadcasters and network operators then are responsible for packaging and delivering the MHP application created by the content producer such that it can be delivered to the users having an MHP compliant digital appliances or STBs. MHP applications are delivered to SBTs by inserting the MHP-based services into the MPEG-2 TS in the form of Digital Storage Media-Command and Control (DSM-CC) object carousels. A MHP compliant DVR then receives and process the MHP application in the MPEG-2 TS with a Java virtual machine.

Real-Time Indexing of TV Programs

A scenario, called “quick metadata service” on live broadcasting, is described in the above-referenced U.S. patent application Ser. No. 10/369,333 filed Feb. 19, 2003, and U.S. patent application Ser. No. 10/368,304 filed Feb. 18, 2003 where descriptive metadata of a broadcast program is also delivered to a DVR while the program is being broadcast and recorded. In the case of live broadcasting of sports games such as football, television viewers may want to selectively view and review highlight events of a game as well as plays of their favorite players while watching the live game. Without the metadata describing the program, it is not easy for viewers to locate the video segments corresponding to the highlight events or objects (for example, players in case of sports games or specific scenes or actors, actresses in movies) by using conventional controls such as fast forwarding.

The metadata includes time positions such as start time positions, duration and textual descriptions for each video segment corresponding to semantically meaningful highlight events or objects. If the metadata is generated in real-time and incrementally delivered to viewers at a predefined interval or whenever new highlight event(s) or object(s) occur or whenever broadcast, the metadata can then be stored at the local storage of the DVR or other device for a more informative and interactive TV viewing experience such as the navigation of content by highlight events or objects. Also, the entirety or a portion of the recorded video may be re-played using such additional data. The metadata can also be delivered just one time immediately after its corresponding broadcast television program has finished, or successive metadata materials may be delivered to update, expand or correct the previously delivered metadata. One of the key components for the quick metadata service is a real-time indexing of broadcast television programs. Various methods have been proposed for video indexing, such as U.S. Pat. No. 6,278,446 (“Liou”) which discloses a system for interactively indexing and browsing video; and, U.S. Pat. No. 6,360,234 (“Jain”) which discloses a video cataloger system. These current and existing systems and methods, however, fall short of meeting their avowed or intended goals, especially for real-time indexing systems.

The various conventional methods can, at best, generate low-level metadata by decoding closed-caption texts, detecting and clustering shots, selecting key frames, attempting to recognize faces or speech, all of which could perhaps synchronized with video. However, with the current state-of-art technologies on image understanding and speech recognition, it is very difficult to accurately detect highlights and generate semantically meaningful and practically usable highlight summary of events or objects in real-time for many compelling reasons.

Media Localization

The media localization within a given temporal audio-visual stream or file has been traditionally described using either the byte location information or the media time information that specifies a time point in the stream. In other words, in order to describe the location of a specific video frame within an audio-visual stream, a byte offset (for example, the number of bytes to be skipped from the beginning of the video stream) has been used. Alternatively, a media time describing a relative time point from the beginning of the audio-visual stream has also been used. For example, in the case of a video-on-demand (VOD) through interactive Internet or high-speed network, the start and end positions of each audio-visual program is defined unambiguously in terms of media time as zero and the length of the audio-visual program, respectively, since each program is stored in the form of a separate media file in the storage at the VOD server and, further, each audio-visual program is delivered through streaming on each client's demand. Thus, a user at the client side can gain access to the appropriate temporal positions or video frames within the selected audio-visual stream as described in the metadata.

However, as for TV broadcasting, since a digital stream or analog signal is continuously broadcast, the start and end positions of each broadcast program are not clearly defined. Since a media time or byte offset are usually defined with reference to the start of a media file, it could be ambiguous to describe a specific temporal location of a broadcast program using media times or byte offsets in order to relate an interactive application or event, and then to access to a specific location within an audio-visual program.

One of the existing solutions to achieve the frame accurate media localization or access in broadcast stream is to use PTS. The PTS is a field that may be present in a PES packet header as defined in MPEG-2, which indicates the time when a presentation unit is presented in the system target decoder. However, the use of PTS alone is not enough to provide a unique representation of a specific time point or frame in broadcast programs since the maximum value of PTS can only represent the limited amount of time that corresponds to approximately 26.5 hours. Therefore, additional information will be needed to uniquely represent a given frame in broadcast streams. On the other hand, if a frame accurate representation or access is not required, there is no need for using PTS and thus the following issues can be avoided: The use of PTS requires parsing of PES layers, and thus it is computationally expensive. Further, if a broadcast stream is scrambled, the descrambling process is needed to access to the PTS. The MPEG-2 System specification contains an information on a scrambling mode of the TS packet payload, indicating the PES contained in the payload is scrambled or not. Moreover, most of digital broadcast streams are scrambled, thus a real-time indexing system cannot access the stream in frame accuracy without an authorized descrambler if a stream is scrambled.

Another existing solution for media localization in broadcast programs is to use MPEG-2 DSM-CC Normal Play Time (NPT) that provides a known time reference to a piece of media. MPEG-2 DSM-CC Normal Play Time (NPT is more fully described at “ISO/IEC 13818-6, Information technology—Generic coding of moving pictures and associated audio information—Part 6: Extensions for DSM-CC” (see World Wide Web at iso.org). For applications of TV-Anytime metadata in DVB-MHP broadcast environment, it was proposed that the NPT should be used for the purpose of time description, more fully described at “ETSI TS 102 812: DVB Multimedia Home Platform (MHP) Specification” (see World Wide Web at etsi.org) and “MyTV: A practical implementation of TV-Anytime on DVB and the Internet” (International Broadcasting Convention, 2001) by A. McPrland, J. Morris, M. Leban, S. Rarnall, A. Hickman, A. Ashley, M. Haataja, F. dejong. In the proposed implementation, however, it is required that both head ends and receiving client device can handle NPT properly, thus resulting in highly complex controls on time.

Schemes for authoring metadata, video indexing/navigation and broadcast monitoring are known. Examples of these can be found in U.S. Pat. No. 6,357,042, U.S. patent application Ser. No. 10/756,858 filed Jan. 10, 2001 (Pub. No. U.S. 2001/0014210 A1), and U.S. Pat. No. 5,986,692.

Multimedia Bookmark and Bulletin Board System

Audiovisual (AV) contents are increasingly populated in the Internet and there might be many people who want to talk about and share their AV files or AV segments of interest with others. Bulletin board systems enable users to share their messages with others through computer network. Unfortunately, the conventional bulletin board systems do not have a capability of easily handling a multimedia bookmark for AV content. Within the conventional BBS, a user who wants to share a AV segment of interest might post into the BBS a message including the information on a AV segment such as its start time, duration (or end time), and the URI (Uniform Resource Identifier) of the AV file itself. Thus, other BBS users who are interested in the AV segment can locate the starting point of the AV segment by fast forwarding and rewinding the whole AV file, and then start to play the AV file from that point. Commonly-owned, copending U.S. patent application Ser. No. 09/911,293 filed Jul. 23, 2001 (Publication No. 2002/0069218) discloses a method and system that includes a multimedia bookmark. The multimedia bookmark has information on the content and position of a segment of interest, wherein a user can utilize the multimedia bookmark to directly access the segment. Various methods have been proposed for multimedia bookmark and its application, such as a method proposed by “Haga” with a title of “Concept of Video Bookmark (videomark) and its Application to the Collaborative Indexing of Lecture Video in Video-based Distance Education.”

Multimedia bookmark for AV content is a functionality that allows a user to access the content at a later time from the position of the multimedia file that the user or any other people have specified. The multimedia bookmark stores the relative time or byte position from the beginning of an AV file along with the file name, and URI. Additionally the multimedia bookmark can also store an image extracted from the multimedia bookmark position marked by a user such that the user can easily reach the segment of interest through the title of the multimedia bookmark displayed along with the stored image of the corresponding location. Also, the multimedia bookmark for an AV content which is marked by a user can be transferred to other people by an electronic mail, thus any people receiving the e-mail can play the video from the exact point marked by the user.

However, there does not exist an exciting mechanism to send or publish the multimedia bookmark to a group of people. Therefore, it is needed for a system and method of a BBS to utilize multimedia bookmark facilities so that users can conveniently share their AV contents or AV segments of interest with others.

Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used in the description contained herein:

ACAP Advanced Common Application Platform (ACAP) is the result of harmonization of the CableLabs OpenCable (OCAP) standard and the previous DTV Application Software Environment (DASE) specification of the Advanced Television Systems Committee (ATSC). A more extensive explanation of ACAP may be found at “Candidate Standard: Advanced Common Application Platform (ACAP)” (see World Wide Web at atsc.org).

API Application Program Interface (API) is a set of software calls and routines that can be referenced by an application program as means for providing an interface between two software application. An explanation and examples of an API may be found at “Dan Appleman's Visual Basic Programmer's guide to the Win32 API” (Sams, February, 1999) by Dan Appleman.

ATSC Advanced Television Systems Committee, Inc. (ATSC) is an international, non-profit organization developing voluntary standards for digital television. Countries such as U.S. and Korea adopted ATSC for digital broadcasting. A more extensive explanation of ATSC may be found at “ATSC Standard A/53C with Amendment No. 1: ATSC Digital Television Standard, Rev. C,” (see World Wide Web at atsc.org). More description may be found in “Data Broadcasting: Understanding the ATSC Data Broadcast Standard” (McGraw-Hill Professional, April 2001) by Richard S. Chernock, Regis J. Crinon, Michael A. Dolan, Jr., John R. Mick; and may also be available in “Digital Television, DVB-T COFDM and ATSC 8-VSB” (Digitaltvbooks.com, October 2000) by Mark Massel. Alternatively, Digital Video Broadcasting (DVB) is an industry-led consortium committed to designing global standards that were adopted in European and other countries, for the global delivery of digital television and data services.

AV Audiovisual.

AVC Advanced Video Coding (H.264) is newest video coding standard of the ITU-T Video Coding Experts Group and the ISO/IEC Moving Picture Experts Group. An explanation of AVC may be found at “Overview of the H.264/AVC video coding standard”, Wiegand, T., Sullivan, G. J., Bjntegaard, G., Luthra, A., Circuits and Systems for Video Technology, IEEE Transactions on, Volume: 13, Issue: 7, July 2003, Pages:560-576; another may be found at “ISO/IEC 14496-10: Information technology—Coding of audio-visual objects—Part 10: Advanced Video Coding” (see World Wide Web at iso.org); Yet another description is found in “H.264 and MPEG-4 Video Compression” (Wiley) by lain E. G Richardson, all three of which are incorporated herein by reference. MPEG-1 and MPEG-2 are alternatives or adjunct to AVC and are considered or adopted for digital video compression.

BBS Bulletin Board Service or Bulletin Board System.

BIFS Binary Format for Scene is a scene graph in the form of hierarchical structure describing how the video objects should be composed to form a scene in MPEG-4. A more extensive information of BIFS may be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.

BiM Binary Metadata (BiM) Format for MPEG-7. A more extensive explanation of BiM may be found at “ISO/IEC 15938-1: Multimedia Context Description Interface—Part 1 Systems” (see World Wide Web at iso.ch).

codec enCOder/DECoder is a short word for the encoder and the decoder. The encoder is a device that encodes data for the purpose of achieving data compression. Compressor is a word used alternatively for encoder. The decoder is a device that decodes the data that is encoded for data compression. Decompressor is a word alternatively used for decoder. Codecs may also refer to other types of coding and decoding devices.

COFDM Coded Octal frequency division multiplex (COFDM) is a modulation scheme used predominately in Europe and is supported by the Digital Video Broadcasting (DVB) set of standards. In the U.S., the Advanced Television Standards Committee (ATSC) has chosen 8-VSB (8-level Vestigial Sideband) as its equivalent modulation standard. A more extensive explanation on COFDM may be found at “Digital Television, DVB-T COFDM and ATSC 8-VSB” (Digitaltvbooks.com, October 2000) by Mark Massel.

CRID Content Reference IDentifier (CRID) is an identifier devised to bridge between the metadata of a program and the location of the program distributed over a variety of networks. A more extensive explanation of CRID may be found at “Specification Series: S-4 On: Content Referencing” (http://tv-anytime.org).

DCT Discrete Cosine Transform (DCT) is a transform function from spatial domain to frequency domain, a type of transform coding. A more extensive explanation of DCT may be found at “Discrete-Time Signal Processing” (Prentice Hall, 2^{nd} edition, February 1999) by Alan V. Oppenheim, Ronald W. Schafer, John R. Buck. Wavelet transform is an alternative or adjunct to DCT for various compression standards such as JPEG-2000 and Advanced Video Coding. A more thorough description of wavelet may be found at “Introduction on Wavelets and Wavelets Transforms” (Prentice Hall, 1^{st} edition, August 1997)) by C. Sidney Burrus, Ramesh A. Gopinath. DCT may be combined with Wavelet, and other transformation functions, such as for video compression, as in the MPEG 4 standard, more fully describes at “H.264 and MPEG-4 Video Compression” (John Wiley & Sons, August 2003) by Iain E. G. Richardson and “The MPEG-4 Book” (Prentice Hall, July 2002) by Touradj Ebrahimi, Fernando Pereira.

DDL Description Definition Language (DDL) is a language that allows the creation of new Description Schemes and, possibly, Descriptors, and also allows the extension and modification of existing Description Schemes. An explanation on DDL may be found at “Introduction to MPEG 7: Multimedia Content Description Language” (John Wiley & Sons, June 2002) by B. S. Manjunath, Philippe Salembier, and Thomas Sikora. More generally, and alternatively, DDL can be interpreted as the Data Definition Language that is used by the database designers or database administrator to define database schemas. A more extensive explanation of DDL may be found at “Fundamentals of Database Systems” (Addison Wesley, July 2003) by R. Elmasri and S. B. Navathe.

DMB Digital Multimedia Broadcasting (DMB), first commercialized in Korea, is a new multimedia broadcasting service providing CD-quality audio, video, TV programs as well as a variety of information (for example, news, traffic news) for portable (mobile) receivers (small TV, PDA and mobile phones) that can move at high speeds.

DRM Digital Rights Management.

DSM-CC Digital Storage Media—Command and Control (DSM-CC) is a standard developed for the delivery of multimedia broadband services. A more extensive explanation of DSM-CC may be found at “ISO/IEC 13818-6, Information technology—Generic coding of moving pictures and associated audio information—Part 6:

Extensions for DSM-CC” (see World Wide Web at iso.org).

DTS Decoding Time Stamp (DTS) is a time stamp indicating the intended time of decoding. A more complete explanation of DTS may be found at “Generic Coding of Moving Pictures and Associated Audio Information—Part 1: Systems” ISO/IEC 13818-1 (MPEG-2), 1994 (http://iso.org).

DTV Digital Television (DTV) is an alternative audio-visual display device augmenting or replacing current analog television (TV) characterized by receipt of digital, rather than analog, signals representing audio, video and/or related information. Video display devices include Cathode Ray Tube (CRT), Liquid Crystal Display (LCD), Plasma and various projection systems. Digital Television is more fully described at “Digital Television: MPEG-1, MPEG-2 and Principles of the DVB System” (Butterworth-Heinemann, June, 1997) by Herve Benoit.

DVB Digital Video Broadcasting is a specification for digital television broadcasting mainly adopted in various countered in Europe adopt. A more extensive explanation of DVB may be found at “DVB: The Family of International Standards for Digital Video Broadcasting” by Ulrich Reimers (see World Wide Web at dvb.org). ATSC is an alternative or adjunct to DVB and is considered or adopted for digital broadcasting used in many countries such as the U.S. and Korea.

DVD Digital Video Disc (DVD) is a high capacity CD-size storage media disc for video, multimedia, games, audio and other applications. A more complete explanation of DVD may be found at “An Introduction to DVD Formats” (see World Wide Web at disctronics.co.uk/downloads/tech_docs/dvdintroduction.pdf) and “Video Discs Compact Discs and Digital Optical Discs Systems” (Information Today, June 1985) by Tony Hendley. CD (Compact Disc), minidisk, hard drive, magnetic tape, circuit-based (such as flash RAM) data storage medium are alternatives or adjuncts to DVD for storage, either in analog or digital format.

DVR Digital Video Recorder (DVR) is usually considered a STB having recording capability, for example in associated storage or in its local storage or hard disk A more extensive explanation of DVR may be found at “Digital Video Recorders: The Revolution Remains On Pause” (MarketResearch.com, April 2001) by Yankee Group.

EIT Event Information Table (EIT) is a table containing essential information related to an event such as the start time, duration, title and so forth on defined virtual channels. A more extensive explanation of EIT may be found at “ATSC Standard A/65B: Program and System Information Protocol for Terrestrial Broadcast and Cable,” Rev. B, 18 Mar. 2003 (see World Wide Web at atsc.org).

EPG Electronic Program Guide (EPG) provides information on current and future programs, usually along with a short description. EPG is the electronic equivalent of a printed television program guide. A more extensive explanation on EPG may be found at “The evolution of the EPG: Electronic program guide development in Europe and the US” (MarketResearch.com) by Datamonitor.

ES Elementary Stream (ES) is a stream containing either video or audio data with a sequence header and subparts of a sequence. A more extensive explanation of ES may be found at “Generic Coding of Moving Pictures and Associated Audio Information—Part 1: Systems,” ISO/IEC 13818-1 (MPEG-2), 1994 (http://iso.org).

ETM Extended Text Message (ETM) is a string data structure used to represent a description in several different languages. A more extensive explanation on ETM may be found at “ATSC Standard A/65B: Program and System Information Protocol for Terrestrial Broadcast and Cable”, Rev. B, 18 Mar. 2003” (see World Wide Web at atsc.org).

ETT Extended Text Table (ETT) contains Extended Text Message (ETM) streams, which provide supplementary description of virtual channel and events when needed. A more extensive explanation of ETM may be found at “ATSC Standard A/65B: Program and System Information Protocol for Terrestrial Broadcast and Cable”, Rev. B, 18 Mar. 2003” (see World Wide Web at atsc.org).

FCC The Federal Communications Commission (FCC) is an independent United States government agency, directly responsible to Congress. The FCC was established by the Communications Act of 1934 and is charged with regulating interstate and international communications by radio, television, wire, satellite and cable. More information can be found at their website (see World Wide Web at fcc.gov/aboutus.html).

FLC Fixed Length Code.

GPS Global Positioning Satellite (GPS) is a satellite system that provides three-dimensional position and time information. The GPS time is used extensively as a primary source of time. UTC (Universal Time Coordinates), NTP (Network Time Protocol) Program Clock Reference (PCR) and Modified Julian Date (MJD) are alternatives or adjuncts to GPS Time and is considered or adopted for providing time information.

GUI Graphical User Interface (GUI) is a graphical interface between an electronic device and the user using elements such as windows, buttons, scroll bars, images, movies, the mouse and so forth.

HDTV High Definition Television (HDTV) is a digital television which provides superior digital picture quality (resolution). The 1080i (1920×1080 pixels interlaced), 1080p (1920×1080 pixels progressive) and 720p (1280×720 pixels progressive formats in a 16:9 aspect ratio are the commonly adopted acceptable HDTV formats. The “interlaced” or “progressive” refers to the scanning mode of HDTV which are explained in more detail in “ATSC Standard A/53C with Amendment No. 1: ATSC Digital Television Standard”, Rev. C, 21 May 2004 (see World Wide Web at atsc.org).

Huffman Coding Huffman coding is a data compression method which may be used alone or in combination with other transformations functions or encoding algorithms (such as DCT, Wavelet, and others) in digital imaging and video as well as in other areas. A more extensive explanation of Huffman coding may be found at “Introduction to Data Compression” (Morgan Kaufmann, Second Edition, February, 2000) by Khalid Sayood.

JPEG JPEG (Joint Photographic Experts Group) is a standard for still image compression. A more extensive explanation of JPEG may be found at “ISO/IEC International Standard 10918-1” (see World Wide Web at jpeg.org/jpeg/). Various MPEG, Portable Network Graphics (PNG), Graphics Interchange Format (GIF), XBM (X Bitmap Format), Bitmap (BMP) are alternatives or adjuncts to JPEG and is considered or adopted for various image compression(s).

keyframe Key frame (key frame image) is a single, still image derived from a video program comprising a plurality of images. A more extensive information of keyframe may be found at “Efficient video indexing scheme for content-based retrieval” (Transactions on Circuit and System for Video Technology, April, 2002)” by Hyun Sung Chang, Sanghoon Sull, Sang Uk Lee.

IDCT Inverse DCT (Discrete Cosine Transform).

IP Internet Protocol, defined by IETF RFC791, is the communication protocol underlying the internet to enable computers to communicate to each other. An explanation on IP may be found at IETF RFC 791 Internet Protocol Darpa Internet Program Protocol Specification. (see World Wide Web at ietf.org/rfc/rfc0791.txt).

ISO International Organization for Standardization (ISO) is a network of the national standards institutes in charge of coordinating standards. More information can be found at their website (see World Wide Web at iso.org).

ITU-T International Telecommunication Union (ITU) Telecommunication Standardization Sector (ITU-T) is one of three sectors of the ITU for defining standards in the field of telecommunication. More information can be found at their website (see World Wide Web at itu.int/ITU-T).

LAN Local Area Network (LAN) is a data communication network spanning a relatively small area. Most LANs are confined to a single building or group of buildings. However, one LAN can be connected to other LANs over any distance, for example, via telephone lines and radio wave and the like to form Wide Area Network (WAN). More information can be found by at “Ethernet: The Definitive Guide” (O'Reilly & Associates) by Charles E. Spurgeon.

LUT Lookup Table.

MCU Minimum Coded Unit.

MGT Master Guide Table (MGT) provides information about the tables that comprise the PSIP. For example, MGT provides the version number to identify tables that need to be updated, the table size for memory allocation and packet identifiers to identify the tables in the Transport Stream. A more extensive explanation of MGT may be found at “ATSC Standard A/65B: Program and System Information Protocol for Terrestrial Broadcast and Cable”, Rev. B 18 Mar. 2003 (see World Wide Web at atsc.org).

MHP Multimedia Home Platform (MHP) is a standard interface between interactive digital applications and the terminals. A more extensive explanation of MHP may be found at “ETSI TS 102 812: DVB Multimedia Home Platform (MHP) Specification” (see World Wide Web at etsi.org). Open Cable Application Platform (OCAP), Advanced Common Application Platform (ACAP), Digital Audio Visual Council (DAVIC) and Home Audio Video Interoperability (HAVi) are alternatives or adjuncts to MHP and are considered or adopted as interface options for various digital applications.

MJD Modified Julian Date (MJD) is a day numbering system derived from the Julian calendar date. It was introduced to set the beginning of days at 0 hours, instead of 12 hours and to reduce the number of digits in day numbering. UTC (Universal Time Coordinates), GPS (Global Positioning Systems) time, Network Time Protocol (NTP) and Program Clock Reference (PCR) are alternatives or adjuncts to PCR and are considered or adopted for providing time information.

M-JPEG Motion-JPEG (Joint Photographic Experts Group).

MPEG The Moving Picture Experts Group is a standards organization dedicated primarily to digital motion picture encoding in Compact Disc. For more information, see their web site at (see World Wide Web at mpeg.org).

MPEG-2 Moving Picture Experts Group—Standard 2 (MPEG-2) is a digital video compression standard designed for coding interlaced/noninterlaced frames. MPEG-2 is currently used for DTV broadcast and DVD. A more extensive explanation of MPEG-2 may be found on the World Wide Web at mpeg.org and “Digital Video: An Introduction to MPEG-2 (Digital Multimedia Standards Series)” (Springer, 1996) by Barry G Haskell, Atul Puri, Arun N. Netravali.

MPEG-4 Moving Picture Experts Group—Standard 4 (MPEG-4) is a video compression standard supporting interactivity by allowing authors to create and define the media objects in a multimedia presentation, how these can be synchronized and related to each other in transmission, and how users are to be able to interact with the media objects. A more extensive information of MPEG-4 can be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.

MPEG-7 Moving Picture Experts Group—Standard 7 (MPEG-7), formally named “Multimedia Content Description Interface” (MCDI) is a standard for describing the multimedia content data. More extensive information about MPEG-7 can be found at the MPEG home page (http://mpeg.tilab.com), the MPEG-7 Consortium website (see World Wide Web at mp7c.org), and the MPEG-7 Alliance website (see World Wide Web at mpeg-industry.com) as well as “Introduction to MPEG 7: Multimedia Content Description Language” (John Wiley & Sons, June, 2002) by B. S. Manjunath, Philippe Salembier, and Thomas Sikora, and “ISO/IEC 15938-5:2003 Information technology—Multimedia content description interface—Part 5: Multimedia description schemes” (see World Wide Web at iso.ch).

NPT Normal Playtime (NPT) is a time code embedded in a special descriptor in a MPEG-2 private section, to provide a known time reference for a piece of media. A more extensive explanation of NPT may be found at “ISO/IEC 13818-6, Information Technology—Generic Coding of Moving Pictures and Associated Audio Information—Part 6: Extensions for DSM-CC” (see World Wide Web at iso.org).

NTP Network Time Protocol (NTP) is a protocol that provides a reliable way of transmitting and receiving the time over the Transmission Control Protocol/Internet Protocol (TCP/IP) networks. A more extensive explanation of NTP may be found at “RFC (Request for Comments) 1305 Network Time Protocol (Version 3) Specification” (see World Wide Web at faqs.org/rfcs/rfc1305.html). UTC (Universal Time Coordinates), GPS (Global Positioning Systems) time, Program Clock Reference (PCR) and Modified Julian Date (MJD) are alternatives or adjuncts to NTP and are considered or adopted for providing time information.

NTSC The National Television System Committee (NTSC) is responsible for setting television and video standards in the United States (in Europe and the rest of the world, the dominant television standards are PAL and SECAM). More information is available by viewing the tutorials on the World Wide Web at ntsc-tv.com.

OpenCable The OpenCable managed by CableLabs, is a research and development consortium to provide interactive services over cable. More information is available by viewing their website on the World Wide Web at opencable.com.

PC Personal Computer (PC).

PCR Program Clock Reference (PCR) in the Transport Stream (TS) indicates the sampled value of the system time clock that can be used for the correct presentation and decoding time of audio and video. A more extensive explanation of PCR may be found at “Generic Coding of Moving Pictures and Associated Audio Information—Part 1: Systems,” ISO/IEC 13818-1 (MPEG-2), 1994 (http://iso.org). SCR (System Clock Reference) is an alternative or adjunct to PCR used in MPEG program streams.

PES Packetized Elementary Stream (PES) is a stream composed of a PES packet header followed by the bytes from an Elementary Stream (ES). A more extensive explanation of PES may be found at “Generic Coding of Moving Pictures and Associated Audio Information—Part 1: Systems,” ISO/IEC 13818-1 (MPEG-2), 1994 (http://iso.org).

PID A Packet Identifier (PID) is a unique integer value used to identify Elementary Streams (ES) of a program or ancillary data in a single or multi-program Transport Stream (TS). A more extensive explanation of PID may be found at “Generic Coding of Moving Pictures and Associated Audio Information—Part 1: Systems,” ISO/IEC 13818-1 (MPEG-2), 1994 (http://iso.org).

PS Program Stream (PS), specified by the MPEG-2 System Layer, is used in relatively error-free environment such as DVD media. A more extensive explanation of PS may be found at “Generic Coding of Moving Pictures and Associated Audio Information—Part 1: Systems,” ISO/IEC 13818-1 (MPEG-2), 1994 (http://iso.org).

PSIP Program and System Information Protocol (PSIP) for ATSC data tables for delivering EPG information to consumer devices such as DVRs in countries using ATSC (such as the U.S. and Korea) for digital broadcasting. Digital Video Broadcasting System Information (DVB-SI) is an alternative or adjunct to ATSC-PSIP and is considered or adopted for Digital Video Broadcasting (DVB) used in Europe. A more extensive explanation of PSIP may be found at “ATSC Standard A/65B: Program and System Information Protocol for Terrestrial Broadcast and Cable,” Rev. B, 18 Mar. 2003 (see World Wide Web at atsc.org).

PTS Presentation Time Stamp (PTS) is a time stamp that indicates the presentation time of audio and/or video. A more extensive explanation of PTS may be found at “Generic Coding of Moving Pictures and Associated Audio Information—Part 1: Systems,” ISO/IEC 13818-1 (MPEG-2), 1994 (http://iso.org).

RF Radio Frequency (RF) refers to any frequency within the electromagnetic spectrum associated with radio wave propagation.

RRT A Rate Region Table (RRT) is a table providing program rating information in an ATSC standard. A more extensive explanation of RRT may be found at “ATSC Standard A/65B: Program and System Information Protocol for Terrestrial Broadcast and Cable,” Rev. B, 18 Mar. 2003 (see World Wide Web at atsc.org).

SCR System Clock Reference (SCR) in the Program Stream (PS) indicates the sampled value of the system time clock that can be used for the correct presentation and decoding time of audio and video. A more extensive explanation of SCR may be found at “Generic Coding of Moving Pictures and Associated Audio Information—Part 1: Systems,” ISO/IEC 13818-1 (MPEG-2), 1994 (http://iso.org). PCR (Program Clock Reference) is an alternative or adjunct to SCR.

SDTV Standard Definition Television (SDTV) is one mode of operation of digital television that does not achieve the video quality of HDTV, but are at least equal, or superior to, NTSC pictures. SDTV may usually have either 4:3 or 16:9 aspect ratios, and usually includes surround sound. Variations of frames per second (fps), lines of resolution and other factors of 480p and 480i make up the 12 SDTV formats in the ATSC standard. The 480p and 480i each represent 480 progressive and 480 interlaced format explained in more detail in ATSC Standard A/53C with Amendment No. 1: ATSC Digital Television Standard, Rev. C 21 May 2004 (see World Wide Web at atsc.org).

SGML Standard Generalized Markup Language (SGML) is an international standard for the definition of device and system independent methods of representing texts in electronic form. A more extensive explanation of SGML may be found at “Learning and Using SGML” (see World Wide Web at w3.org/MarkUp/SGML/), and at “Beginning XML” (Wrox, December, 2001) by David Hunter.

SI System Information (SI) for DVB (DVB-SI) provides EPG information data in DVB compliant digital TVs. A more extensive explanation of DVB-SI may be found at “ETSI EN 300 468 Digital Video Broadcasting (DVB); Specification for Service Information (SI) in DVB Systems”, (see World Wide Web at etsi.org). ATSC-PSIP is an alternative or adjunct to DVB-SI and is considered or adopted for providing service information to countries using ATSC such as the U.S. and Korea.

STB Set-top Box (STB) is a display, memory, or interface devices intended to receive, store, process, repeat, edit, modify, display, reproduce or perform any portion of a program, including personal computer (PC) and mobile device.

STT System Time Table (STT) is a small table defined to provides the time and date information in ATSC. Digital Video Broadcasting (DVB) has a similar table called a Time and Date Table (TDT). A more extensive explanation of STT may be found at “ATSC Standard A/65B: Program and System Information Protocol for Terrestrial Broadcast and Cable”, Rev. B, 18 Mar. 2003 (see World Wide Web at atsc.org).

TCP Transmission Control Protocol (TCP) is defined by the Internet Engineering Task Force (IETF) Request for Comments (RFC) 793 to provide a reliable stream delivery and virtual connection service to applications. A more extensive explanation of TCP may be found at “Transmission Control Protocol Darpa Internet Program Protocol Specification” (see World Wide Web at ietf.org/rfc/rfc0793.txt).

TDT Time Date Table (TDT) is a table that gives information relating to the present time and date in Digital Video Broadcasting (DVB). STT is an alternative or adjunct to TDT for providing time and date information in ATSC. A more extensive explanation of TDT may be found at “ETSI EN 300 468 Digital Video Broadcasting (DVB); Specification for Service Information (SI) in DVB systems” (see World Wide Web at etsi.org).

TiVo TiVo is a company providing digital content via broadcast to a consumer DVR it pioneered. More information on TiVo may be found at http://tivo.com.

TS Transport Stream (TS), specified by the MPEG-2 System layer, is used in environments where errors are likely, for example, broadcasting network. TS packets into which PES packets are further packetized are 188 bytes in length. An explanation of TS may be found at “Generic Coding of Moving Pictures and Associated Audio Information—Part 1: Systems,” ISO/IEC 13818-1 (MPEG-2), 1994 (http://iso.org).

TV Television, generally a picture and audio presentation or output device; common types include cathode ray tube (CRT), plasma, liquid crystal and other projection and direct view systems, usually with associated speakers.

TV-Anytime TV-Anytime is a series of open specifications or standards to enable audio-visual and other data service developed by the TV-Anytime Forum. A more extensive explanation of TV-Anytime may be found at the home page of the TV-Anytime Forum (see World Wide Web at tv-anytime.org).

TVPG Television Parental Guidelines (TVPG) are guidelines that give parents more information about the content and age-appropriateness of TV programs. A more extensive explanation of TVPG may be found on the World Wide Web at tvguidelines.org/default.asp.

URI Uniform Resource Identifier is a short string that identifies a resource such as a document, an image, a downloadable file, a service, an electronic mailbox, and other resources. It makes a resource available under a variety of naming scheme and access method such as HTTP, FTP, and Internet mail addressable in the same simple way. URI was registered as an IETF Standard (IETF RFC 2396).

UTC Universal Time Coordinated (UTC), the same as Greenwich Mean Time, is the official measure of time used in the world's different time zones.

VCR Video Cassette Recorder (VCR). DVR is digital alternatives or adjuncts to VCR.

VCT Virtual Channel Table (VCT) is a table which provides information needed for the navigating and tuning of a virtual channels in ATSC and DVB. A more extensive explanation of VCT may be found at “ATSC Standard A/65B: Program and System Information Protocol for Terrestrial Broadcast and Cable,” Rev. B, 18 Mar. 2003 (see World Wide Web at atsc.org).

VOD Video On Demand (VOD) is a service that enables television viewers to select a video program and have it sent to them over a channel via a network such as a cable or satellite TV network.

VR The Visual Rhythm (VR) of a video is a single image or frame, that is, a two-dimensional abstraction of the entire three-dimensional content of a video segment constructed by sampling certain groups of pixels of each image sequence and temporally accumulating the samples along time. A more extensive explanation of Visual Rhythm may be found at “An Efficient Graphical Shot Verifier Incorporating Visual Rhythm”, by H. Kim, J. Lee and S. M. Song, Proceedings of IEEE International Conference on Multimedia Computing and Systems, pp. 827-834, June, 1999.

VSB Vestigial Side Band (VSB) is a method for modulating a signal. A more extensive explanation on VSB may be found at “Digital Television, DVB-T COFDM and ATSC 8-VSB” (Digitaltvbooks.com, October 2000) by Mark Massel.

WAN A Wide Area Network (WAN) is a network that spans a wider area than does a Local Area Network (LAN). More information can be found by at “Ethernet: The Definitive Guide” (O'Reilly & Associates) by Charles E. Spurgeon.

W3C The World Wide Web Consortium (W3C) is an organization developing various technologies to enhance the Web experience. More information on W3C may be found at World Wide Web at w3c.org.

XML extensible Markup Language (XML) defined by W3C (World Wide Web Consortium), is a simple, flexible text format derived from SGML. A more extensive explanation of XML may be found at “XML in a Nutshell” (O'Reilly, 2004) by Elliotte Rusty Harold, W. Scott Means.

XML Schema A schema language defined by W3C to provide means for defining the structure, content and semantics of XML documents. A more extensive explanation of XML Schema may be found at “Definitive XML Schema” (Prentice Hall, 2001) by Priscilla Walmsley.

Zlib Zlib is a free, general-purpose lossless data-compression library for use independent of the hardware and software. More information can be obtained on the World Wide Web at gzip.org/zlib.

### BRIEF DESCRIPTION (SUMMARY)

It is therefore a general object of the disclosure to provide a way of conveniently handling a multimedia bookmark within a BBS.

Generally, according to the disclosure, techniques are provided for posting and retrieving a multimedia bookmark conveniently to and from the multimedia bookmark BBS similar to posting and retrieving a message to and from the conventional BBSs.

Generally, according to the disclosure, the multimedia bookmark BBS comprises a multimedia bookmark BBS server, a multimedia bookmark server, and multimedia bookmark clients located in web host, media host and client computers respectively.

More specifically for the posting method, a process for creating a message including multimedia bookmark (herein referred to as a “multimedia bookmark message”) is provided. Herein, the process includes sub-processes for displaying the multimedia bookmark stored in the storage, selecting one of the multimedia bookmarks to be posted, and creating the message including multimedia bookmark that is composed of an image data (hereinafter referred to as a “Multimedia Bookmark Image”), a video URI, a start time, duration, and a title page URI of the video.

Generally, according to the disclosure, a process for storing the transferred multimedia bookmark into the storage of the multimedia bookmark BBS server is also provided.

Generally, according to the disclosure, a process for retrieving a multimedia bookmark message from the multimedia bookmark BBS server is further provided. Herein, the process includes sub-processes for listing the messages including partial or full multimedia bookmark information, selecting a multimedia bookmark in the message wherein the selection causes the video to be streamed and played in the client computer with or without a restricted duration in consideration for copy right problem.

In addition, according to the disclosure, a method of enhancing the visual quality of the multimedia bookmark image such that viewers can easily perceiving the reduced image captured from video is provided.

According to the techniques disclosed herein, a multimedia bookmark (VMark) bulletin board service (BBS) system comprises: a web host comprising storage for messages, a web server, and a VMark BBS server; a media host comprising storage for audiovisual (AV) files, and a streaming server; a client comprising storage for VMark, a web browser, a media player and a VMark client; and a VMark server located at the media host or at the client; a communication network connecting the web host, the media host and the client.

The media host may comprise the VMark server for capturing a multimedia bookmark image at a requested bookmarked position of a given AV file stored at the storage of the media host and sending the image to the multimedia bookmark client of the client through the communication network.

The client may comprise the VMark server for capturing a multimedia bookmark image at a requested bookmarked position of a given AV file being played at the media player and passing the image to the multimedia bookmark client of the client locally.

According to the techniques disclosed herein, a method of performing a multimedia bookmark bulletin board service (BBS) comprises: creating a message including a multimedia bookmark for an AV file; and posting the message into the multimedia bookmark BBS.

According to the techniques disclosed herein, a method of sending multimedia bookmark (VMark) between clients comprises: at a first client, making a VMark indicative of a bookmarked position in an AV program; sending the VMark from the first client to a second client; and playing the program at the second client from the bookmarked position.

The VMark may comprise bookmarked position; and descriptive information of the program, and may further comprise one or more of Uniform Resource Identifier (URI) of a bookmarked program; content information such as an image captured at a bookmarked position; textual annotations attached to a segment that contains the bookmarked position; title of the bookmark; metadata identification (ID) of the bookmarked program; and bookmarked date.

If, previous to sending the VMark from the first client to a second client, the AV program has not been recorded at the second client, the program may be recorded later at the second client.

Recording the program later may comprise: rebroadcasting the program later; or broadcasting the program on a different channel.

Recording the program later may comprise: searching an electronic program guide (EPG) for the program utilizing descriptive information of the program included in the VMark; or searching remote media hosts connected with a communication network for the program utilizing descriptive information of the program included in the VMark.

According to the techniques disclosed herein, a system for sharing multimedia content comprises: a multimedia bookmark bulletin board system (BBS); and means for posting a multimedia bookmark to the BBS.

Other objects, features and advantages of the techniques disclosed herein will become apparent from the ensuing descriptions thereof.

### BRIEF DESCRIPTION OF THE DRAWINGS

Reference will be made in detail to embodiments of the techniques disclosed herein, examples of which are illustrated in the accompanying drawings (figures). The drawings are intended to be illustrative, not limiting, and it should be understood that it is not intended to limit the techniques to the illustrated embodiments.

FIG. 1 is a representation of an exemplary GUI screen incorporating the multimedia bookmark of previous art and additional features, according to an embodiment of the present disclosure.

FIG. 2 is a diagram of a general system architecture of a multimedia bookmark BBS, according to an embodiment of the present disclosure.

FIG. 3 is a representation of an exemplary GUI screen of a message list window of the multimedia bookmark BBS, according to an embodiment of the present disclosure.

FIG. 4 is a representation of an exemplary GUI screen of a posting window of the multimedia bookmark BBS, according to an embodiment of the present disclosure.

FIG. 5 is a representation of an exemplary GUI screen of a My Multimedia Bookmark window of the multimedia bookmark BBS, according to an embodiment of the present disclosure.

FIG. 6 is a representation of an exemplary GUI screen of a message window of the multimedia bookmark BBS, according to an embodiment of the present disclosure.

FIG. 7 is a flowchart illustrating an exemplary overall method of creating a multimedia bookmark message, posting the message to the multimedia bookmark BBS, and reading the message from the BBS, according to an embodiment of the present disclosure.

FIG. 8 is a flowchart illustrating an exemplary method of creating a multimedia bookmark message, according to an embodiment of the present disclosure.

FIG. 9 is a flowchart illustrating an exemplary method of posting a multimedia bookmark message to the multimedia bookmark BBS, according to an embodiment of the present disclosure.

FIG. 10 is a diagram illustrating an exemplary structure of the multimedia bookmark message, according to an embodiment of the present disclosure.

FIG. 11 is a flowchart illustrating an exemplary method of reading a multimedia bookmark message list from the multimedia bookmark BBS, according to an embodiment of the present disclosure.

FIG. 12 is a flowchart illustrating an exemplary method of reading a multimedia bookmark message from the multimedia bookmark BBS, according to an embodiment of the present disclosure.

FIG. 13 is a flowchart illustrating an exemplary method of playing a multimedia bookmark from the multimedia bookmark BBS, according to an embodiment of the present disclosure.

FIG. 14 is a diagram of an exemplary contrast calibration/enhancement function, according to an embodiment of the present disclosure.

FIG. 15 is a representation of an exemplary GUI screen for monitoring status of the multimedia bookmark server, according to an embodiment of the present disclosure.

FIG. 16 is a representation of an exemplary GUI screens for providing multimedia bookmark usage information, according to an embodiment of the present disclosure.

FIG. 17 is a representation of an exemplary GUI screen of a multimedia bookmark e-mail that has advertising multimedia bookmarks attached automatically, according to an embodiment of the present disclosure.

FIGS. 18A, 18B and 18C are representations of exemplary GUI screens of a managing tool for an administrator to select the advertising multimedia bookmarks from his/her own multimedia bookmarks, according to an embodiment of the present disclosure.

FIGS. 19A, 19B and 19C are representations of exemplary GUI screens of a managing tool for an administrator to make a multimedia bookmark storyboard of a video, according to an embodiment of the present disclosure.

FIGS. 20A and 20B illustrate the general system architectures for making multimedia bookmarks on DRM packaged videos when multimedia bookmark images are captured at a remote host or client computer itself, respectively, according to an embodiment of the present disclosure.

FIG. 21 is a diagram showing the system for sending multimedia bookmark e-mails between media PCs or DVRs, according to an embodiment of the present disclosure.

FIG. 22 is a diagram showing luminance macroblock structure in frame and field DCT coding.

FIG. 23 is a diagram showing a binary code tree for the concatenation of two codewords represented by black leaf nodes.

FIG. 24 is a chart showing block frequency for a LUT count of a block in a frame: averaged by using 38 I-frames of Table-Tennis video sequence.

FIG. 25 is a diagram showing a conventional scheme to obtain the target block size from 8×8 DCT block.

FIG. 26 is a diagram showing a proposed scheme to obtain the target block size from 8×8 DCT block.

FIG. 27 is a flowchart illustrating a technique for no cropping scheme of image resizing.

FIG. 28 is a flowchart illustrating a technique for cropping scheme of image resizing.

FIG. 29 is a block diagram of a typical transcoder based a full decoder and a full encoder.

FIG. 30 is a block diagram of a JPEG decoder.

FIG. 31 is a block diagram of an MPEG-1/2 intra picture encoder.

FIG. 32 is a diagram illustrating an exemplary system of the present disclosure.

FIG. 33 is a block diagram of a transcoder module according to the disclosure.

FIG. 34 is a detailed diagram of the transcoder according to the disclosure.

FIG. 35 is an illustration of the frame conversion according to the disclosure.

FIG. 36 is an illustration of the method using skipped macroblock.

FIG. 37 is a flowchart illustrating an exemplary transcoder, according to the disclosure.

FIG. 38 is a diagram of exemplary media localization.

### DETAILED DESCRIPTION

In the description that follows, various embodiments of the techniques are described largely in the context of a familiar user interface, such as the Microsoft Windows™ operating system and graphic user interface (GUI) environment. It should be understood that although certain operations, such as clicking on a button, selecting a group of items, drag-and-drop, and the like, are described in the context of using a graphical input device, such as a mouse, it is within the scope of the disclosure that other suitable input devices, such as keyboard, voice or other audio input, optical or other video input, tablets, and the like, could alternatively be used to perform the described functions. Also, where certain items are described as being highlighted or marked, so as to be visually distinctive from other (typically similar) items in the graphical interface, that any suitable means of highlighting or identifying or marking the items visually, audibly or otherwise can be employed, and that any and all such alternatives are within the intended scope of the disclosure.

1. Multimedia Bookmark

Commonly-owned, copending U.S. patent application Ser. No. 09/911,293 filed Jul. 23, 2001 (Publication No. 2002/0069218) discloses a method and system that includes a multimedia bookmark for an audiovisual (AV) file. The multimedia bookmark has content information about the segment at the intermediate point, wherein a user can utilize the multimedia bookmark to access the segment without accessing from the beginning of the AV file.

The multimedia bookmark for an AV file comprises the following bookmark information:
1. URI of a bookmarked file;
2. Bookmarked position;
3. Content information such as an image captured at a bookmarked position;
4. Textual annotations attached to a segment that contains the bookmarked position;
5. Title of the bookmark;
6. Metadata identification (ID) of the bookmarked file;
7. URI of an opener web page from which the bookmarked file started to play;
8. Bookmarked date.

The bookmark information includes not only positional information (1 and 2) and content information (3, 4, 5, and 6) but also some other useful information, such as opener web page and bookmarked date, etc wherein the bookmarked date contains the information on date and time.

The content information may be composed of audio-visual features and textual features. The audio-visual features are the information, for example, obtained by capturing or sampling the AV file at or around the bookmarked position. In case of a video bookmark, the audio-visual features can be a thumbnail image of the captured video frame, and visual feature vectors like color histogram for one or more of the frames. In the case of an audio bookmark, the audio-visual features can also be the sampled audio signal (typically of short duration) and its visualized image. The textual features are text information specified by the user, as well as delivered with the AV file. Other aspects of the textual features may be obtained by accessing metadata of the AV file. Hereafter, the present disclosure describes the techniques for delivering and processing of multimedia bookmarks mainly for video contents. The techniques can be easily applied to other multimedia contents such as audios.

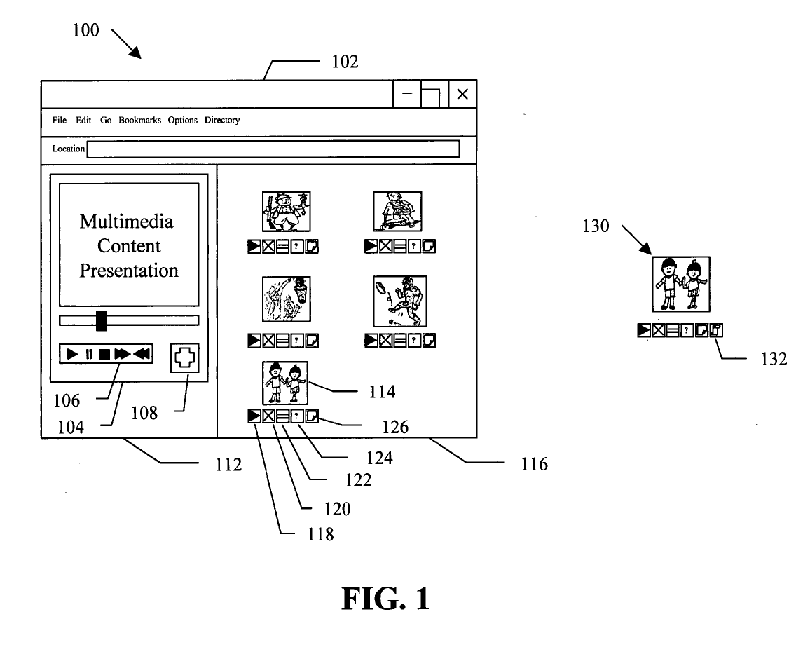

FIG. 1 shows an exemplary GUI screen incorporating the multimedia bookmark of the previous art, that is, commonly-owned, copending U.S. patent application Ser. No. 09/911,293 filed Jul. 23, 2001 (Publication No. 2002/0069218), and additional features, according to an embodiment of the techniques of the present disclosure. The user interface of the player window 102 is composed of a playback area 112 and a bookmark list 116. Further, the playback area 112 includes a multimedia player 104. The multimedia player 104 provides various buttons 106 for normal VCR controls such as play, pause, stop, fast forward and rewind. In addition, it provides an add-bookmark control button 108 for making a multimedia bookmark. If a user selects this button while playing a multimedia content, a new multimedia bookmark having both positional and content information is saved in a persistent storage. Also, in the bookmark list 116, the saved bookmark is visually displayed with its content information. For example, a spatially reduced image (or thumbnail image) corresponding to the temporal location of interest saved by a user in case of multimedia bookmark is presented to help the user to easily recognize the previously bookmarked content of the video.

In the bookmark list 116, which provides a personalization of the stored multimedia bookmarks, every bookmark has five bookmark controls just below its visually displayed content information. The left-most play-bookmark control button 118 is for playing a bookmarked multimedia content from a saved bookmarked position. The delete-bookmark control button 120 is for managing bookmarks. If this button is selected, the corresponding bookmark is deleted from the persistent storage. The add-bookmark-title control button 122 is used to input a title of bookmark given by a user. If this button is not selected, a default title is used. The search control button 124 is used for searching multimedia database for multimedia contents relevant to the selected content information 114 as a multimedia query input. There are a variety of cases when this control might be selected. For example, when a user selects a play-bookmark control to play a saved bookmark, the user might find out that the multimedia content being played is not in accordance with the displayed content information due to the mismatches of positional information for some reason. Further, the user might want to find multimedia contents similar to the content information of the saved bookmark. The send-bookmark control button 126 is used for sending both positional and content information saved in the corresponding bookmark to other people via e-mail. It should be noted that the positional information sent via e-mail includes either a URI or other locator, and a bookmarked position.

In addition, the present disclosure discloses a new control button related with multimedia bookmark BBSs, that is the post-bookmark control button 132 of multimedia bookmark 130 to post both positional and content information saved in the corresponding multimedia bookmark into a BBS.

2. Bulletin Board System for Multimedia Bookmark

A conventional BBS allows a user to leave messages and access information for general interest. In addition to the features provided by the conventional BBS, the multimedia bookmark BBS of the present disclosure allows a user to conveniently post, retrieve, and play the multimedia bookmarks so as to share a video segment of interest with others connected through computer networks.

In the viewpoint of using the multimedia bookmark technology and sharing multimedia bookmark contents, the multimedia bookmark BBS can be distinguished from the conventional BBS wherein the text data or files are just posted and downloaded. In conventional methods such as conventional BBS and e-mail, when a user wishes to share an opinion for a video segment of interest, the user might describe the video URI manually (or upload the video file into the BBS or attach the video file on the e-mail message) and also describe the time position of the video segment of interest within the message. Thus, another user who retrieves (or receives) the message has to locate the time position of the video with manual operations such as fast forward and rewind function supported by the media player.

In the present disclosure, the multimedia bookmark technology is used to conveniently share the multimedia bookmark with others. As shown in FIG. 1, while a user is watching a video, the user can conveniently bookmark the position of the video and save the multimedia bookmark in the user's local machine by clicking the add-bookmark control button 108 in the media player. Then, the bookmark can be uploaded into the multimedia bookmark BBS server by clicking the post-bookmark control button 132, and then another user who retrieves the message including multimedia bookmark from the BBS can directly play the video segment of interest without doing the manual operations related with locating the bookmarked position of the video.

2.1 Overview of Multimedia Bookmark BBS

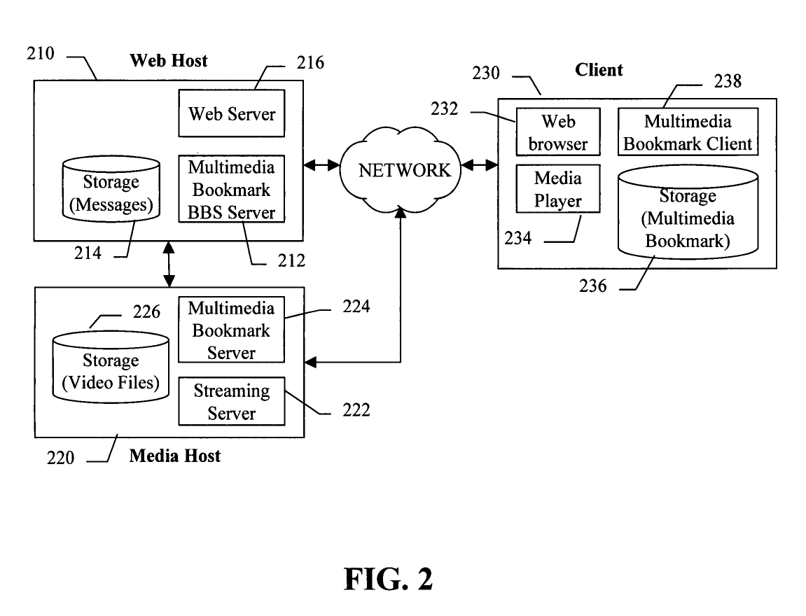

FIG. 2 illustrates the general system architecture of the multimedia bookmark BBS, according to an embodiment of the present disclosure. The system comprises multimedia bookmark BBS server 212 located in web host 210, multimedia bookmark server 224 located in media host 220 and multimedia bookmark client 238 located in client 230. The web host 210, media host 220 and client 230 are connected by a conventional communication network (“NETWORK”).

Web host 210 provides lists of videos which have corresponding links or URIs of the videos stored at media host 220 with a hypertext markup language (HTML). Media host 220 stores the videos in its local storage 226, and provides them to client 230 when they are requested. Client 230 can select one of the videos from the lists displayed in web browser 232. The selection process requests the video to be serviced to media host 220, and client 230 receives the video streamed by streaming server 222 of media host 220 and displays the video on media player 234.

While a user in client 230 is watching a video streamed from media host 220, the user can conveniently bookmark any position of the video and save the multimedia bookmark into the user's local storage 236 by clicking add-bookmark control button 108 in the player shown in FIG. 1.

The multimedia bookmark image (which is a reduced frame of the video captured at the bookmarked position) might be obtained by bookmark server 224 of media host 220 and then delivered to multimedia bookmark client 238 of client 230. Multimedia bookmark BBS server 212 communicates with bookmark server 224 in response to a user's request of capturing a multimedia bookmark image. After receiving the captured multimedia bookmark image from the server 224, bookmark BBS server 212 sends the multimedia bookmark image together with multimedia bookmark information to the web browser 232 of client 230.

Alternatively, the multimedia bookmark image might be obtained by multimedia bookmark client 238 that can capture and reduce a frame of video displayed in media player 234. The client 238, which is application software responsible for interactions between web browser 232 and local storage 236, stores the multimedia bookmark image into local storage 236 together with the bookmark information such as video URI, start time, duration and etc. The bookmark client 238 is also used to load the multimedia bookmark saved at the local storage into the web browser, so that the web browser can display the multimedia bookmark image and its information.

The multimedia bookmark saved at local storage 236 of client 230 regardless of whether its multimedia bookmark image is obtained by the bookmark server 224 of media host 220 or bookmark client 238 of client 230 can be uploaded to multimedia bookmark BBS server 212 of web host 210 and then stored at storage 214 of the web host so that other users can share the multimedia bookmark. Thus, one who retrieves the bookmark from multimedia bookmark BBS server 212 can start to play the video exactly from the bookmarked position.

Media host 220 comprises streaming server 222, bookmark server 224 and storage 226 for archiving media files. Bookmark server 224 is responsible for handling the request from bookmark BBS server 212. The multimedia bookmark server obtains a bookmark image at the required position in accordance with the request and then sends the captured bookmark image to multimedia bookmark BBS server 212 as a reply for the request of multimedia bookmark image. Streaming server 222 is responsible for the request from client 230 to play a video.

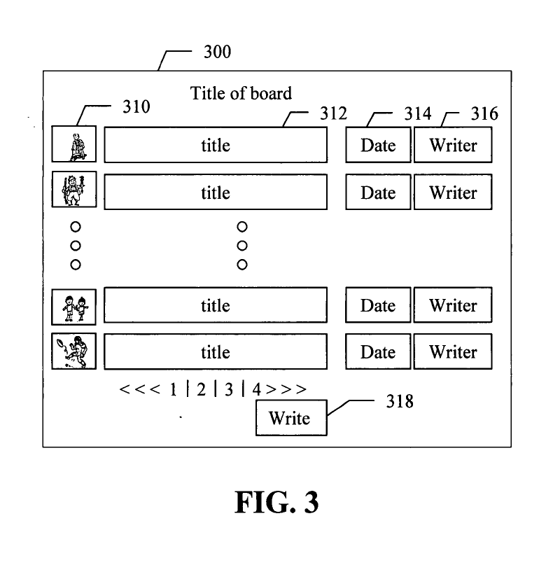

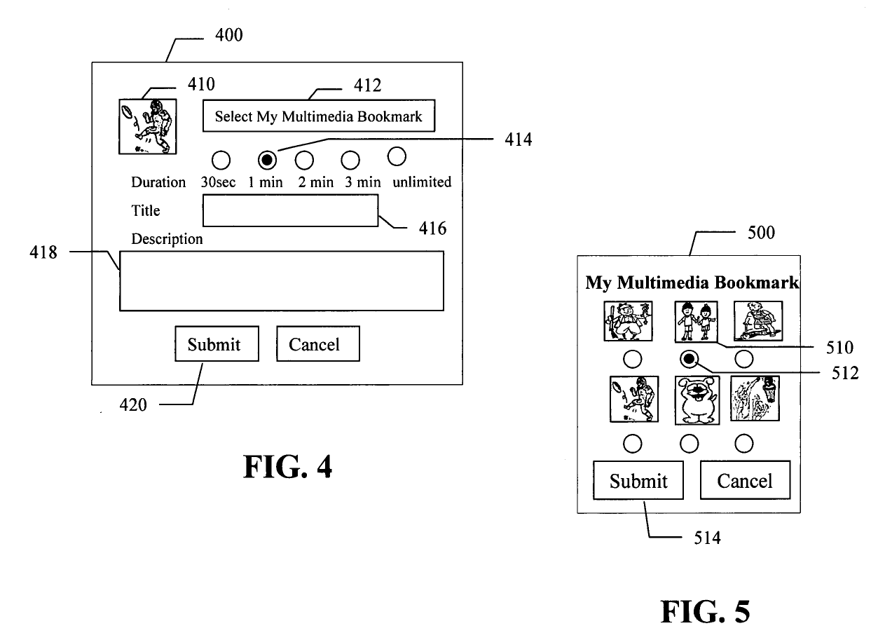

FIGS. 3, 4, 5, and 6 illustrate exemplary GUI screens of a multimedia bookmark BBS, according to an embodiment of the present disclosure. FIG. 3 illustrates an exemplary GUI screen of a message list window 300 of a multimedia bookmark BBS, according to an embodiment of the present disclosure. In the figure, message list window 300 of the multimedia bookmark BBS comprises general components of conventional BBS such as title of a message 312, uploading date of the message 314, and writer of the message 316. Furthermore, message list window 300 of the present disclosure includes multimedia bookmark of the message 310 for each message. By viewing the visual information of multimedia bookmarks, the multimedia bookmark BBS users can easily identify a message in which they are interested. The “write” (post or upload) control button 318 is selected when a user wants to post a multimedia bookmark. FIG. 4 shows the next GUI screen when the user selects the “write” control button.

FIG. 4 illustrates an exemplary GUI screen of a posting window 400 of a multimedia bookmark BBS, according to an embodiment of the present disclosure. In order to post a multimedia bookmark, first the “Select My Bookmark” control button 412 is clicked and then a “My Multimedia Bookmark” window 500 will be displayed as shown in FIG. 5.

FIG. 5 illustrates an exemplary GUI screen of a My Multimedia Bookmark window 500 of a multimedia bookmark BBS, according to an embodiment of the present disclosure. With My Multimedia Bookmark window 500, the user can select a multimedia bookmark 510 of interest by checking the selection control button 512 and clicking on the submit control button 514. Then, the GUI screen of My Multimedia Bookmark window 500 will disappear, and the GUI screen of posting window 400 will be shown again.

Then, with the posting window 400 in FIG. 4, the user selects and fills up other fields such as duration control box 414, title text input field 416 and description text input field 418. The duration control box controls the allowable duration to play the multimedia bookmark from its bookmarked position. For example, the multimedia bookmark can be played for 30 seconds, 1 minutes, 2 minutes, 3 minutes or even to the end of video file. Note that this duration can be set by an administrator of the multimedia bookmark BBS in order to limit or control the allowable duration of playing. Finally, the user can post the message including the selected multimedia bookmark by clicking on the submit control button 420.

Alternatively, the user can post a multimedia bookmark directly from player window 102 of FIG. 1 by clicking the post-bookmark control button 132 that will be displayed in bookmark list 116. When the user clicks the post-bookmark control button, the posting window 400 of FIG. 4 is displayed with the selected multimedia bookmark 410. Thus, unless the user wants to change the selected multimedia bookmark 410 with other, the user does not have to click the “Select My Multimedia Bookmark” control button.

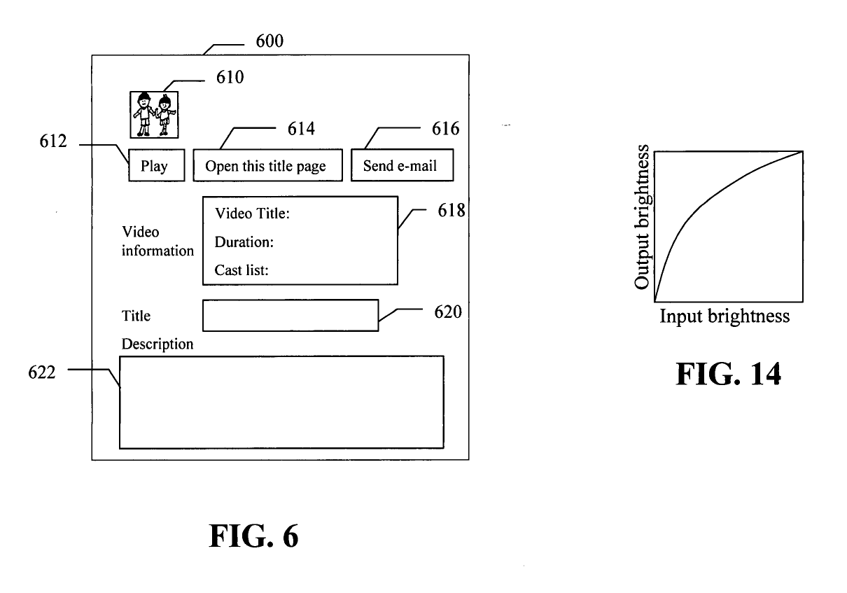

After at least one multimedia bookmark message is posted to a multimedia bookmark BBS by a user, the user and the others can retrieve the message from the multimedia bookmark BBS. FIG. 6 shows a message window 600 that is displayed when a message is selected from the message list window 300 of FIG. 3, herein the selection is caused by clicking multimedia bookmark image 310 or title 312. FIG. 6 illustrates an exemplary GUI screen of a message window 600 of a multimedia bookmark BBS, according to an embodiment of the present disclosure. In the figure, message window 600 comprises multimedia bookmark image 610, play control button 612, opener page control button 614, send-mail control button 616, textual description 618 for the video content from which the corresponding multimedia bookmark included in the selected message is captured, text box 620 for title of the selected message, and user description 622. By selecting the play control button 612, the user can watch the video from the bookmarked position. Note that the video will be played according to the predetermined duration set by a posting user or an administrator of multimedia bookmark BBS. By selecting the opener page control button 614, the user can also access the title page of the video associated with this multimedia bookmark. By selecting the send-mail control button 616, the user can send the multimedia bookmark to others so as to share the bookmark and his/her comments.

2.2 Functional Description of Multimedia Bookmark BBS

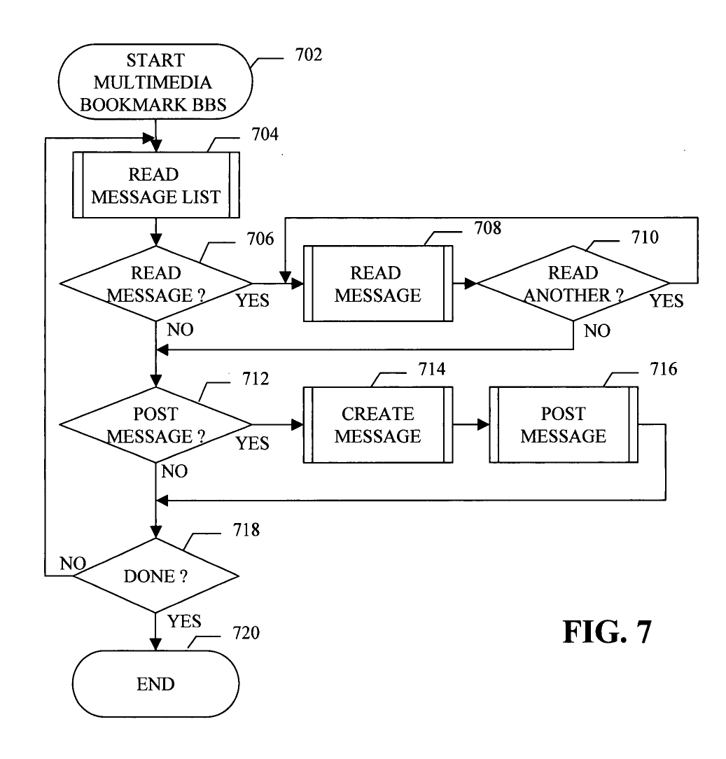

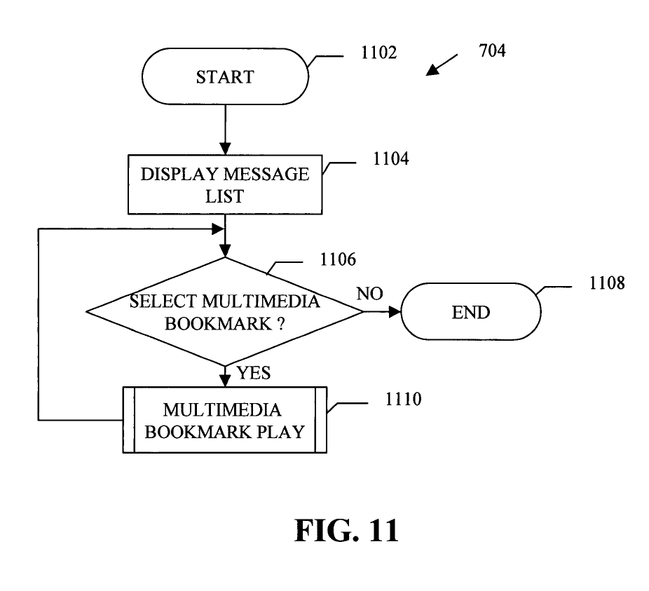

FIG. 7 is an exemplary flowchart illustrating the overall method of creating a multimedia bookmark message, posting the message to a multimedia bookmark BBS, and reading the message from the BBS, according to an embodiment of the present disclosure. As shown in FIG. 7, the operation of multimedia bookmark client 238 of FIG. 2 starts at step 702. The multimedia bookmark client, which is usually embedded in an Internet web browser, reads the list of messages for a message group from multimedia bookmark BBS server 212 of FIG. 2 at step 704, and displays message list window 300 with additional multimedia bookmark images 310 as shown in FIG. 3. The detailed subprocess of the “read message list” is described with reference to FIG. 11.

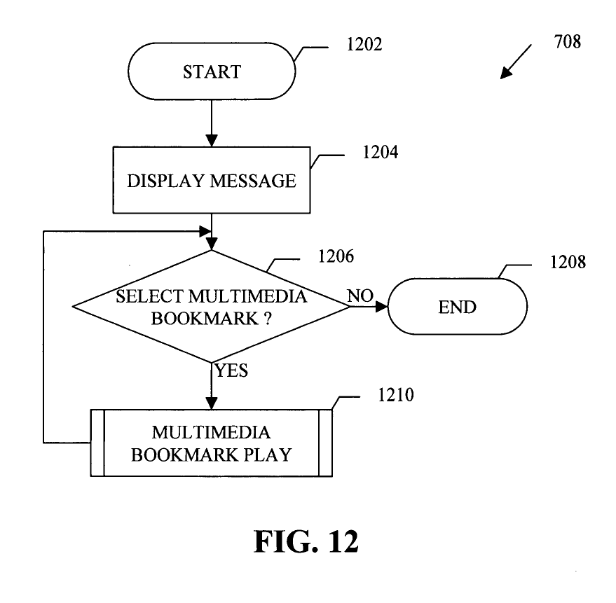

While reading the message titles of the message list window, a user selects a message at step 706, and then the detailed information of the selected message is to be displayed at message window 600 of FIG. 6 at the “read message” step 708. The detailed subprocess of “read message” is described with reference to FIG. 12 in which the user can read the selected message and play the corresponding video included in the message from the position indicated by the multimedia bookmark. If the user wants to see a next message at step 710, the process loops back to the “read message” step 708. Otherwise, the process moves to the “post message” decision step 712.

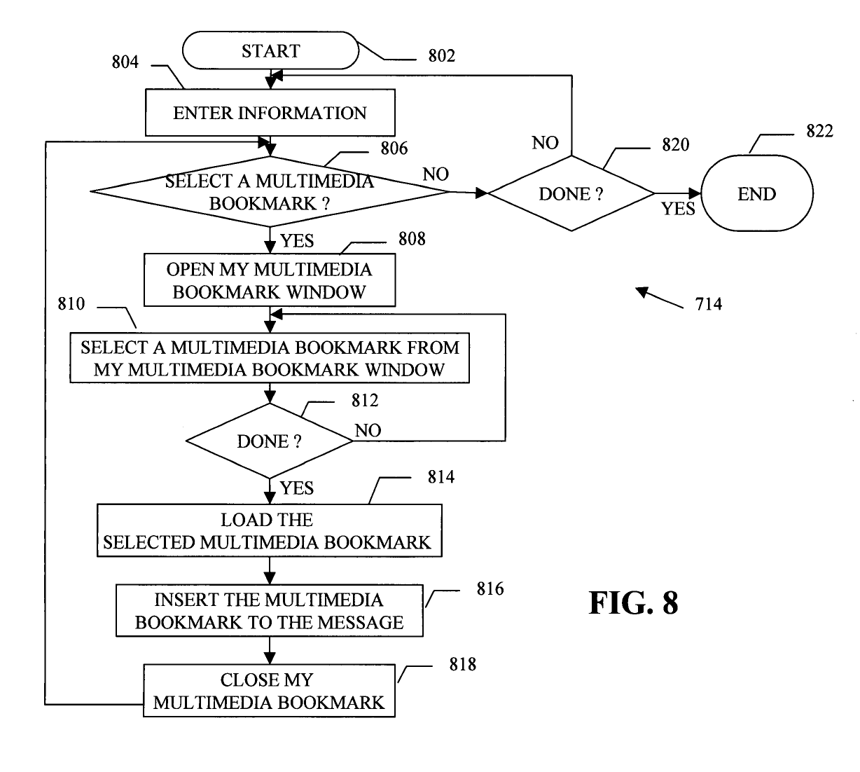

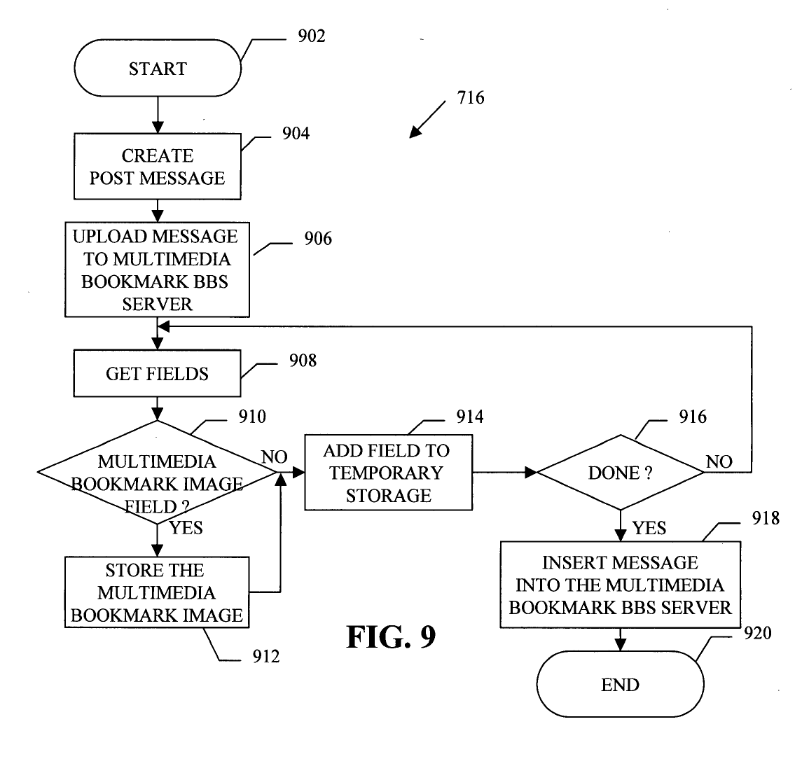

If the user wants to post a message at step 712, the “create message” subprocess 714 is to be started with posting window 400 of FIG. 4, and then the “post message” subprocess 716 is also to be started where the multimedia bookmark BBS server receives the message and stores it into the database of storage 214. The detailed sub-processes of both “create message” and “post message” are described with reference to FIGS. 8 and 9, respectively.

Finally, if the user wants to finish the process at step 718, the process is over at step 720. All of the sub-processes described in FIGS. 7, 8 and 9 can be stopped at any step of the process when a user closes the window or clicks the cancel button, which is not explicitly described in the figures.

2.3 Creating a Message

FIG. 8 is an exemplary flowchart illustrating the method of creating a multimedia bookmark message, according to an embodiment of the present disclosure. When the decision to post a message is made at step 712 of FIG. 7, the subprocess of “create message” 714 of FIG. 7 starts at step 802 of FIG. 8 with posting window 400 of FIG. 4.

Textual information of the message is entered into the input fields such as the title input field 416 and the description text input field 418 in the posting window at step 804 of FIG. 8. If the user wants to select a bookmark from the multimedia bookmarks stored at the user's local storage at decision step 806, the user opens My Multimedia Bookmark window 500 of FIG. 5 at step 808, where the stored bookmark images are displayed and one of them is to be selected at step 810.

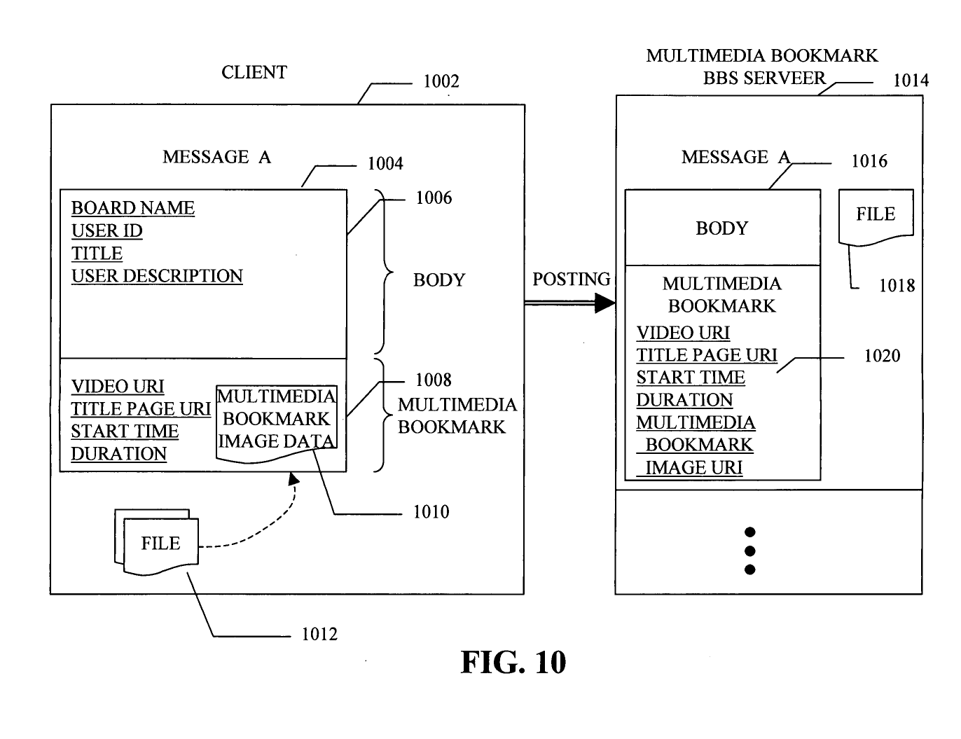

After selecting a multimedia bookmark at step 810, the user can close the My Multimedia Bookmark window by clicking on the Submit button 514 of FIG. 5. At this moment, before the My Multimedia Bookmark window is closed at step 818, the selected bookmark is loaded into the user's web browser from the user's local storage at step 814. More specifically, the multimedia bookmark client 238 of FIG. 2 is utilized for loading the selected bookmark into the web browser 232 in which the message structure is contained. The loaded bookmark is then inserted into the multimedia bookmark section of the message at step 816. The detailed structure of the message is described with reference to FIG. 10, which comprises body section and multimedia bookmark section. Thus, the selected bookmark can be shown in the multimedia bookmark image field 410 of the posting window by using the local URI for the stored multimedia bookmark image.

Alternatively, steps 814 and 816 can precede step 812, that is, whenever a multimedia bookmark is selected at step 810, the selected bookmark is loaded and inserted into the multimedia bookmark section of the message. Furthermore, alternatively, instead of within the subprocess 714 of FIG. 7, steps 814 and 816 can be utilized within step 904 of FIG. 9 which is a detailed flowchart for the subprocess of posting a message 716 of FIG. 7.

An exemplary embodiment for inserting a multimedia bookmark to a message at step 816 is to utilize a text encoder. The loaded multimedia bookmark image is encoded with a program such as a base64 text encoder, and then the encoded bookmark image is included in the multimedia bookmark section of message as a value of multimedia bookmark image field. Other multimedia bookmark information such as media URI, title page URI, start time and duration is also inserted into the multimedia bookmark section of the message. Alternatively, the file attaching method can be utilized to load and insert the multimedia bookmark image and its information into the message.

The multimedia bookmark section of the message contains the multimedia bookmark information and bookmark image. This makes a difference between multimedia bookmark BBS system and many other conventional BBS systems because this allows a user to play the video segment of interest directly from the appropriate position in accordance with the multimedia bookmark message.

Once the multimedia bookmark is inserted into the multimedia bookmark section of the message at step 816, the subprocess returns to decision step 806 to verify the decision. If the user wants to change again the selected bookmark, the multimedia bookmark selection process starts again from step 808. If a decision is made not to change the multimedia bookmark at decision step 806, then the subprocess checks whether the user decides to finish or not at decision step 820. If the user decides not to finish the work, the subprocess returns to step 804 wherein textual information of the message can be entered. However, if the user decides to finish the work at decision step 820, the subprocess ends at step 822.

2.4 Posting a Message

FIG. 9 is an exemplary flowchart illustrating the method of posting a multimedia bookmark message to a multimedia bookmark BBS, according to an embodiment of the present disclosure. When a multimedia bookmark message is created by the subprocess “create message” at step 714 of FIG. 7, another subprocess “post message” 716 of FIG. 7 starts at step 902 of FIG. 9.

The subprocess creates a post message at step 904. The structure of the post message will be described in more details below with reference to FIG. 10.

After the message is sent to multimedia bookmark BBS server 212 of FIG. 2 at step 906, each field of the post message is retrieved by the multimedia bookmark BBS server at step 908. In order to separate the multimedia bookmark image field from other textual fields, each retrieved field is examined at step 910. If the multimedia bookmark image field is found, the value of the multimedia bookmark image field is decoded with a program such as a base64 text decoder at step 912, and the decoded multimedia bookmark image (a separate file) is saved at storage 214 of Web host 210 of FIG. 2 or other web servers. After the decoded multimedia bookmark image is saved, the location of the saved multimedia bookmark image is also stored on the temporary storage at step 914 which will be inserted into the multimedia bookmark BBS server later.

After the field value or image location is added to the temporary storage at step 914, a query is made at decision step 916 whether more fields are to be inserted. If more fields exist at decision step 916, then the next field is retrieved and examined at steps 908 and 910, respectively. If no more fields exist at decision step 916, the subprocess inserts the values of each field stored in the temporary storage into the multimedia bookmark BBS server at step 918, and then the subprocess ends at step 920.

FIG. 10 illustrates an exemplary structure of the multimedia bookmark message which is posted to multimedia bookmark BBS server 212 by client 230 of FIG. 2, according to an embodiment of the present disclosure. In the figure, the multimedia bookmark message 1004 in the client 1002 has a body section 1006 and multimedia bookmark section 1008. The body section 1006 includes, what are usually included in the typical BBS, board name, user identifier (user id), the title of the message, and the user description for the message, whereas the multimedia bookmark section 1008 includes multimedia bookmark information such as video URI, title page URI, start time, duration, and multimedia bookmark image data 1010. The multimedia bookmark information is retrieved from the stored multimedia bookmark files 1012 in the user's local storage 236 of FIG. 2.

When multimedia bookmark message 1004 is transferred to multimedia bookmark BBS server 1014, the included bookmark image data 1010 might be extracted from the transferred message and then stored as a separate file 1018 at the multimedia bookmark BBS server. In this case, multimedia bookmark image URI 1020 indicating the storage location of the extracted multimedia bookmark image file is added to multimedia bookmark section of the transferred message. Then, the modified message is stored into the database of the multimedia bookmark BBS server.

2.5 Playing the Bookmarked Video Segment within a Message

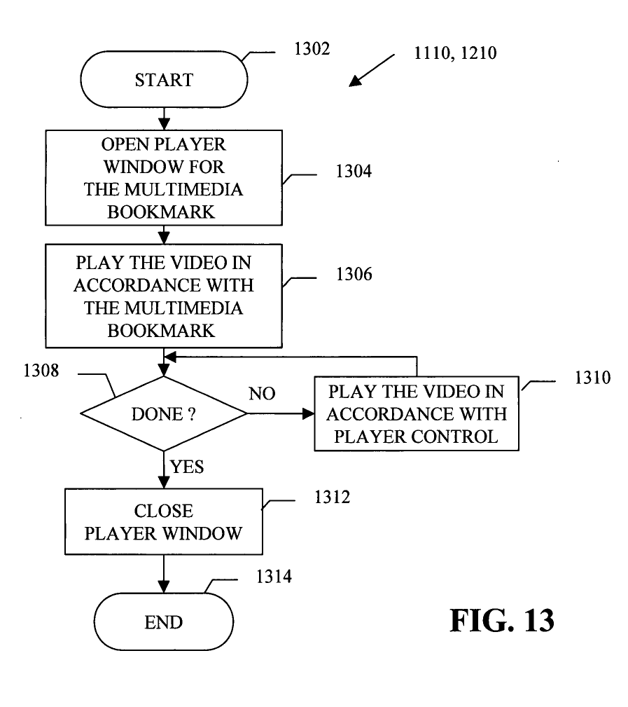

FIG. 11 is an exemplary flowchart illustrating the method of reading a multimedia bookmark message list from a multimedia bookmark BBS, according to an embodiment of the present disclosure. When the overall process begins at step 702 of FIG. 7, the subprocess “read message list” 704 of FIG. 7 starts at step 1102 of FIG. 11. The subprocess displays message list window 300 of FIG. 3 at step 1104. It then moves to decision step 1106 whether a user will play the bookmarked video segment in the message list window or not. If the decision to play the bookmarked video segment is made at steps 1106, the subprocess moves to the “Multimedia bookmark play” subprocess at step 1110 which is illustrated in more details in FIG. 13. After all, the subprocess “read message list” is terminated at step 1108.

FIG. 12 is an exemplary flowchart illustrating the method of reading a multimedia bookmark message from a multimedia bookmark BBS, according to an embodiment of the present disclosure. When the decision to read a message is made at step 706 of FIG. 7, the subprocess “read message” 708 of FIG. 7 starts at step 1202 of FIG. 12. The subprocess displays a message window 600 of FIG. 6 at step 1204. It then moves to decision step 1206 whether a user will play the bookmarked video segment in the message window or not. If the decision to play the bookmarked video segment is made at steps 1206, the subprocess moves to the “Multimedia bookmark play” subprocess at step 1210 which is also illustrated in more details in FIG. 13. After all, the subprocess “read message” is terminated at step 1208.

FIG. 13 is an exemplary flowchart illustrating the method of playing a multimedia bookmark from a multimedia bookmark BBS, according to an embodiment of the present disclosure. When the decision to play a bookmark is made at step 1106 or 1206 of FIG. 11 or 12, the subprocess “Multimedia bookmark play” 1110 or 1210 of FIG. 11 or 12 starts at step 1302 of FIG. 13. The subprocess then moves to step 1304 where the player window such as multimedia bookmark player 102 of FIG. 1 is opened and an additional browsing window might be opened, which displays a HTML page associated with the multimedia bookmark information such as the title page of the video. Within the player window, the video starts to play from the bookmarked position of the multimedia bookmark information at step 1306. As used herein, playing “from” the bookmarked position means starting playback of the video from a frame at or near (typically, within a few seconds of) the bookmarked position.

Decision step 1308 is made to check whether the allowed play is finished or not. If it is not finished, a user might control the position of time line so as to access another time point of the video at step 1310. Furthermore, in case of a pay-per-view business model, a player might be restricted to play the video segment of interest with the start time and duration contained in the multimedia bookmark information so that a user can only preview the predefined segment of the video. Thus, a user who has no right to play whole video can be restricted within the video segment of interest. If the play is finished, the subprocess closes the player window at step 1312, and is terminated at step 1314.

3. Multimedia Bookmark BBS Administration and Applications

3.1 Enhancing Visual Quality of Multimedia Bookmark Image

The video film is usually produced for a movie theater in which there is little light except the reflection of light in the screen. When a user watches the multimedia bookmark image using PC at office or home where there are usually bright lights, the reduced image sometimes looks too dark and even hard to recognize. Thus, it is needed to enhance the visual quality of the multimedia bookmark image that is a reduced image captured from the video. The exemplary method is to utilize the contrast calibration/enhancement method of which function is shown in FIG. 14.

FIG. 14 is a graph illustrating an exemplary contrast calibration/enhancement function, according to an embodiment of the present disclosure. The function is a contrast calibration function brightening darker area. This module is a component of the multimedia bookmark generator that is implemented in multimedia bookmark server 224 or in multimedia bookmark client 238 in FIG. 2.

3.2 Monitoring Media Host

From the view point of location where a multimedia bookmark image is captured from a video, there are two ways to capture the bookmark image: one is to utilize multimedia bookmark server 224 running at media host 220 in FIG. 2 to capture a multimedia bookmark image from the video stored at storage 226 and send the captured bookmark image to requesting client 230, and the other is to utilize multimedia bookmark client 238 running at client computer 230 to capture a multimedia bookmark image directly from a frame buffer of media player 234 playing the video.

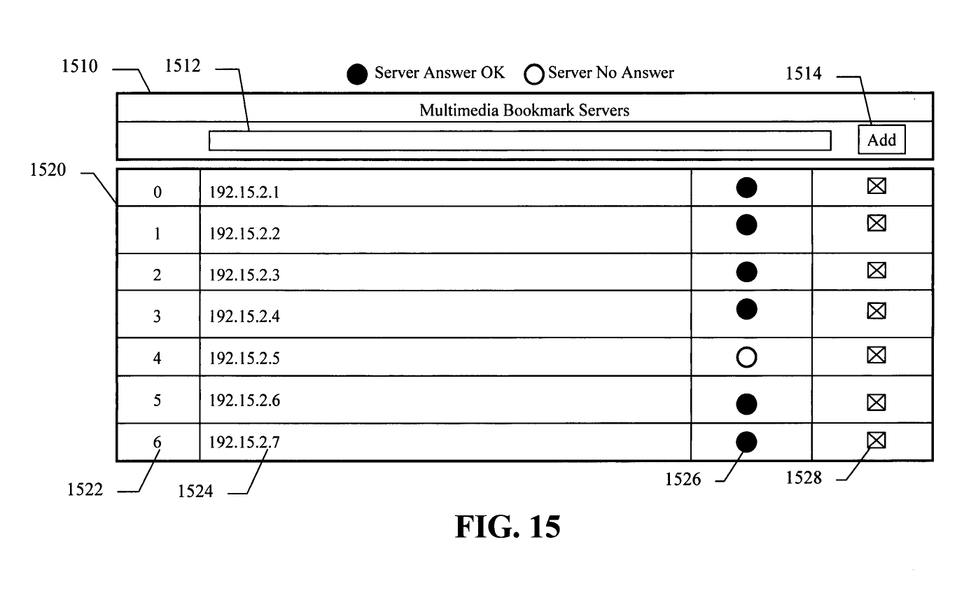

When the multimedia bookmark image is capture by the bookmark server, it might be required to monitor that the multimedia bookmark server is alive or not. FIG. 15 illustrates an exemplary GUI screen for monitoring status of the multimedia bookmark server, according to an embodiment of the present disclosure. The server register window 1510 is used to register the media hosts where the multimedia bookmark servers are running, which comprises input text box 1512 for IP address of a media host and the add button 1514 to register the IP address.

After registering media hosts, each registered media host is displayed as a single row in the media host monitoring window 1520. The row comprises index field 1522, IP address field 1524, status field 1526, and delete button 1528. The status field indicates the status of a registered media host with graphical symbols or texts specifying whether the multimedia bookmark server running at the media host is alive or not. The delete button 1528 is used to remove the corresponding row.

3.3 Reporting Multimedia Bookmark Usage Information

Multimedia bookmark usage information such as how many times a multimedia bookmark is captured and sent by e-mail for a group of videos or a specific video, or even a specific segment of a video is very valuable for identifying a group of video, a video, or a segment that users are interested in. The information can be used for diverse purposes like determining ranks of videos, advertising, etc.

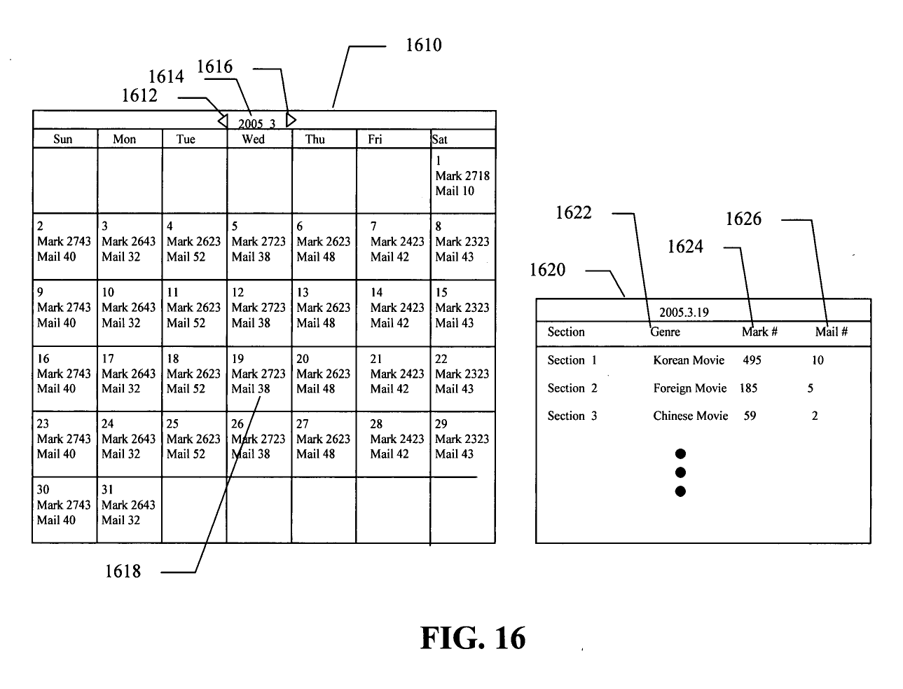

FIG. 16 illustrates exemplary GUI screens for providing multimedia bookmark usage information, according to an embodiment of the present disclosure. In the figure, a calendar form 1610 is utilized. By clicking on next month button 1612 and previous month buttons 1616, the calendar form shows the report on how many times multimedia bookmark is captured and sent by e-mail for a group of videos for the selected month represented in the year-month field 1614. Each day field 1618 comprises the count of multimedia bookmark captured by users and the count of multimedia bookmark e-mailed by users, where the text displayed on the day field 1618 is the hypertext that has a link to detail usage report 1620. The detailed usage report comprises category field 1622 indicating a subgroup of videos, and the count fields 1624 and 1626 for multimedia bookmark captured and multimedia bookmark e-mail sent for each sub-group, respectively.

3.4 Providing Advertising Multimedia Bookmark E-mail and News Letter

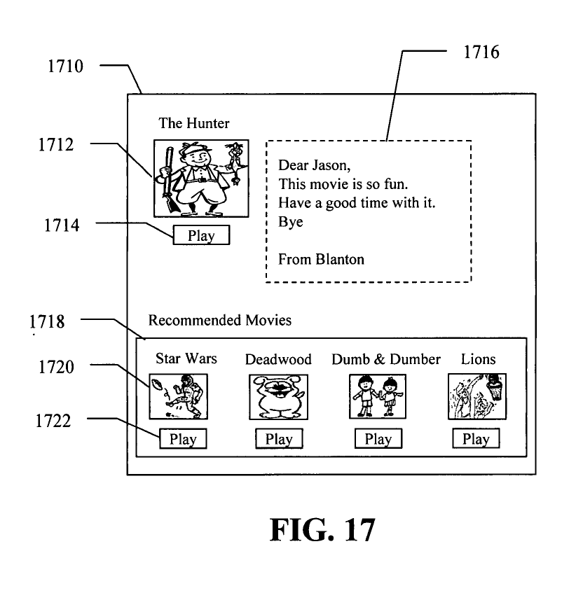

When a user sends a multimedia bookmark e-mail to others, a multimedia bookmark e-mail system can attach advertising multimedia bookmarks to the user's multimedia bookmark e-mail automatically. FIG. 17 illustrates an exemplary GUI screen of a multimedia bookmark e-mail that has advertising multimedia bookmarks attached automatically, according to an embodiment of the present disclosure. Note that the advertising multimedia bookmarks are prepared in advance by an administrator of the multimedia bookmark e-mail system or the multimedia bookmark BBS. In the figure, the multimedia bookmark e-mail 1710 comprises three parts: multimedia bookmark part with multimedia bookmark image 1712 and the play button 1714, message part 1716 where a sender's textual message is displayed, and advertising multimedia bookmark part 1718 where advertising multimedia bookmarks 1720 are attached. The multimedia bookmark made by a sender 1712 can be played from the bookmarked position by a recipient when clicking on the play button 1714 or the multimedia bookmark image. The advertising multimedia bookmark 1720 can also be played by clicking on each multimedia bookmark image 1720 or the play button 1722, used to help the recipient browse or play the video.

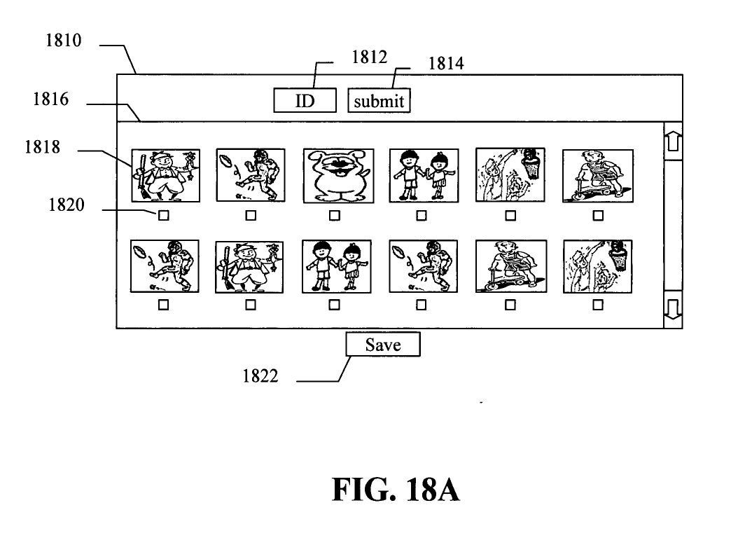

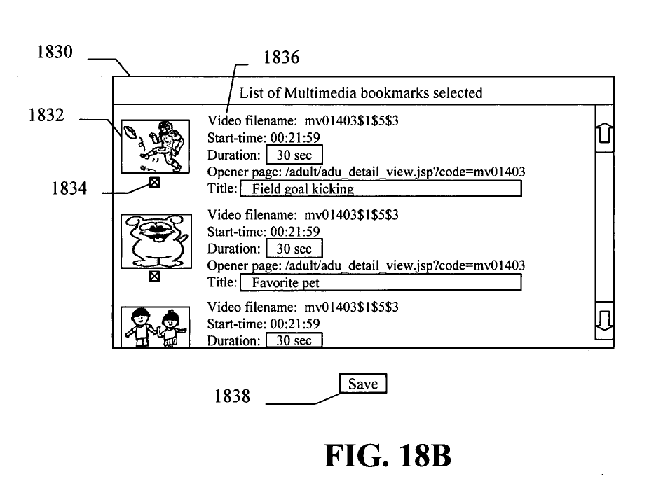

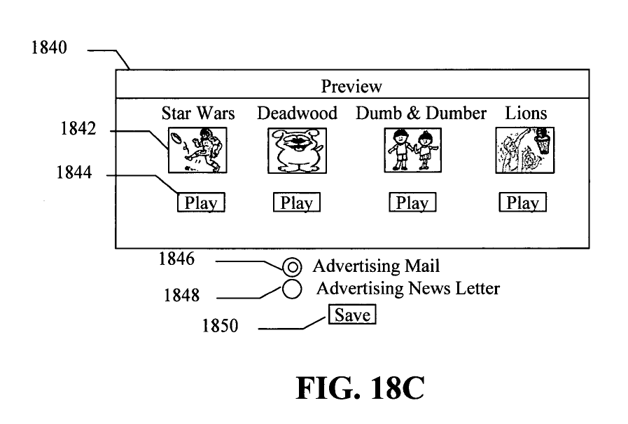

To prepare the advertising multimedia bookmarks, the administrator makes his/her own multimedia bookmarks from new or existing videos that he/she wants to advertise, and then selects some multimedia bookmarks to be attached from his/her own multimedia bookmarks. FIGS. 18A, 18B and 18C illustrate exemplary GUI screens of a managing tool for the administrator to select the advertising multimedia bookmarks from his/her own multimedia bookmarks, according to an embodiment of the present disclosure. FIG. 18A illustrates an exemplary GUI screen to select advertising multimedia bookmarks from the administrator's own multimedia bookmarks. By typing ID on the ID input text field 1812 and clicking on submit button 1814 in the initial GUI screen 1810, the administrator can view his/her multimedia bookmarks 1818 on multimedia bookmark list box 1816. By checking the check box 1820 below an interesting multimedia bookmark 1818, the administrator selects one advertising multimedia bookmark. By repeating the process, the administrator can select advertising multimedia bookmarks as he/she wants. The administrator then completes the selection by clicking on save button 1822, and a new GUI screen 1830 of FIG. 18B will appear.

FIG. 18B illustrates an exemplary GUI screen to list the advertising multimedia bookmarks selected by the administrator. After selecting the advertising multimedia bookmarks, the administrator can verify his/her selection by viewing a list of selected multimedia bookmark image 1832 and its multimedia bookmark information described in information fields 1836 such as video title, file location/name, start-time, duration, and the related Web page URI. The administrator can edit video title or allowable playing duration in information field 1836. Also, the administrator can remove the multimedia bookmark 1832 from the selected list by clicking on delete button 1834. The administrator then completes the verification by clicking on save button 1838, and a new GUI screen 1840 of FIG. 18C will appear.

After verifying the advertising multimedia bookmarks, the manager can preview the selected advertising multimedia bookmarks. FIG. 18C illustrates an exemplary GUI screen to preview the advertising multimedia bookmarks selected by the administrator. The preview window 1840 is similar to the advertising multimedia bookmark part 1718 of the multimedia bookmark e-mail 1710 in FIG. 17. The administrator can verify the final format of advertising multimedia bookmarks to be attached to a multimedia bookmark e-mail sent by a user. The advertising multimedia bookmark 1842 can be played by clicking on play button 1844. And then, by clicking the save button 1850 with “Advertising Multimedia Bookmark Mail” radio button 1846 checked, the advertising multimedia bookmarks are stored on database to be automatically attached into user's multimedia bookmark e-mail whenever a user sends a multimedia bookmark e-mail to other. By clicking the save button 1850 with “Advertising News Letter” radio button 1848 checked, the advertising multimedia bookmarks are stored on database to be automatically attached into a news letter e-mail whenever a promotion is done by sending a news letter e-mail to users.

3.5 Providing Multimedia Bookmark Storyboard

In order to choose a video from a video archive or determine to play a video, it is useful to have a storyboard of the video, which is a sequential series of thumbnail images captured from the video. Moreover, instead of just static images on the storyboard of the video, it might be more useful if users can play (highlighted) segments of the video from or around the positions where the thumbnail images are captured. This can be achieved if each thumbnail image of the storyboard is replaced by a multimedia bookmark, which is called as a multimedia bookmark storyboard hereafter. With the multimedia bookmark storyboard, users can not only view a series of multimedia bookmark images but also preview short video segments predefined in multimedia bookmark information, that is, their start point and playable duration.

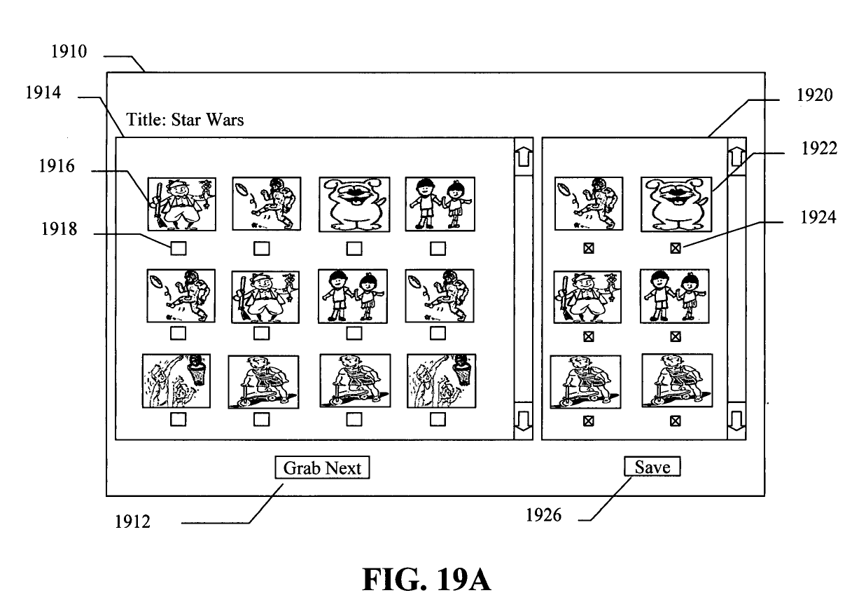

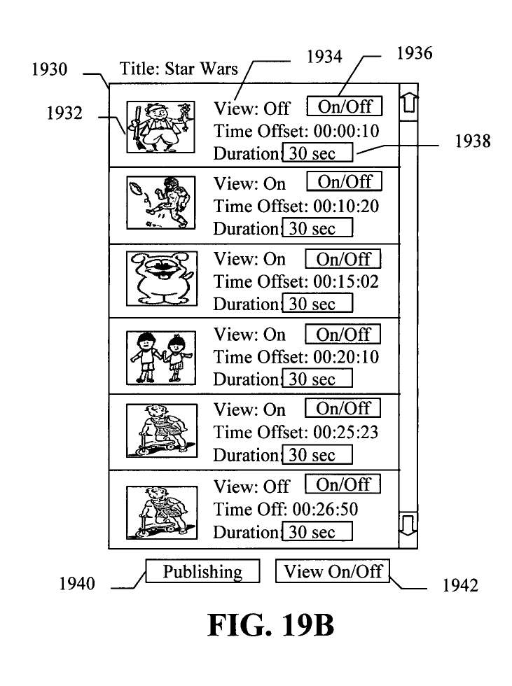

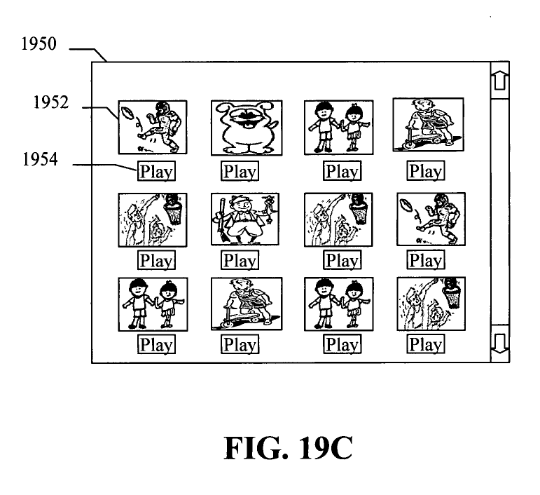

To make the Multimedia Bookmark Storyboard, an administrator who wants to make the storyboard may bookmark some positions of interest while watching the video. However, this is a tedious and time consuming job. Instead, the administrator can utilize a managing tool to make a multimedia bookmark storyboard of a video, which might allow the administrator to make the multimedia bookmark storyboard fast and easily. FIGS. 19A, 19B and 19C illustrate exemplary GUI screens of a managing tool for the administrator to make a multimedia bookmark storyboard of a video, according to an embodiment of the present disclosure. FIG. 19A illustrates an exemplary GUI screen 1910 to capture a sequential series of multimedia bookmarks at each regular time interval from a starting time point, for example, at every 5 minutes from the beginning of the video. By clicking on grab-next button 1912, an initial sequential series of multimedia bookmarks is captured and displayed in candidate multimedia bookmark list 1914. Note that, if the regular time interval is 5 minutes, the multimedia bookmarks will be made at 5 minutes, 10 minutes, 15 minutes, and so on. The administrator can then select a multimedia bookmark 1916 by checking the check box 1918. The selected multimedia bookmark will be displayed in selected multimedia bookmark list 1920. By repeating the selection process for the initial series of multimedia bookmarks, the administrator can select multimedia bookmarks that will be included in the storyboard. Then, the administrator can click on grab-next button 1912 to capture another sequential series of multimedia bookmarks by shifting the starting time point a little later, for example, 10 seconds after each previous captured position. Note that, if the time interval added is 10 seconds, the multimedia bookmarks will be made at 5 minutes and 10 seconds, 10 minutes and 10 seconds, 15 minutes and 10 seconds, and so on. The administrator can then select more multimedia bookmarks in the candidate bookmark list again. This process can be repeated until the administrator finishes selecting multimedia bookmarks that will be included in the storyboard. After finishing the selection, the administrator saves the selected multimedia bookmarks with bookmark image and appropriate information into database by clicking on save button 1926, and a new GUI screen 1930 of FIG. 19B will appear. Note that the administrator can cancel his/her selection of multimedia bookmark 1922 by clicking on delete button 1924 just below the bookmark in selected multimedia bookmark list 1920. Alternatively, the sequential series of multimedia bookmarks can be captured at time points determined by shot detection or clustering algorithms, instead of utilizing at each regular time interval.

After selecting multimedia bookmarks of a video to be included in a multimedia bookmark storyboard of the video, the administrator can verify his/her selection by viewing the multimedia bookmark storyboard with detailed information. FIG. 19B illustrates an exemplary GUI screen to list the selected bookmarks in multimedia bookmark storyboard 1930. The administrator verifies the multimedia bookmark image 1932 and its related information 1934, and can edit multimedia bookmark information such as duration and title by clicking On/Off button 1936. Finally, the administrator publishes the multimedia bookmark storyboard by clicking on the publishing button 1940, and then a new GUI screen 1950 of FIG. 19C will appear. Note that the “view on/off” button 1942 provides an option for displaying the multimedia bookmark storyboard on to the page related with the video or not.

FIG. 19C illustrates an exemplary GUI screen of a published multimedia bookmark storyboard of a video as a hypertext markup language (HTML) document. Now, the published multimedia bookmark storyboard can be included in any HTML page such as the synopsis page of the video. Users can now browse the video with the multimedia bookmark storyboard and preview a partial segment corresponding to a bookmark by clicking on multimedia bookmark image 1952 or play button 1954 just below the multimedia bookmark image.

4. Making Multimedia Bookmarks on DRM Packaged Videos

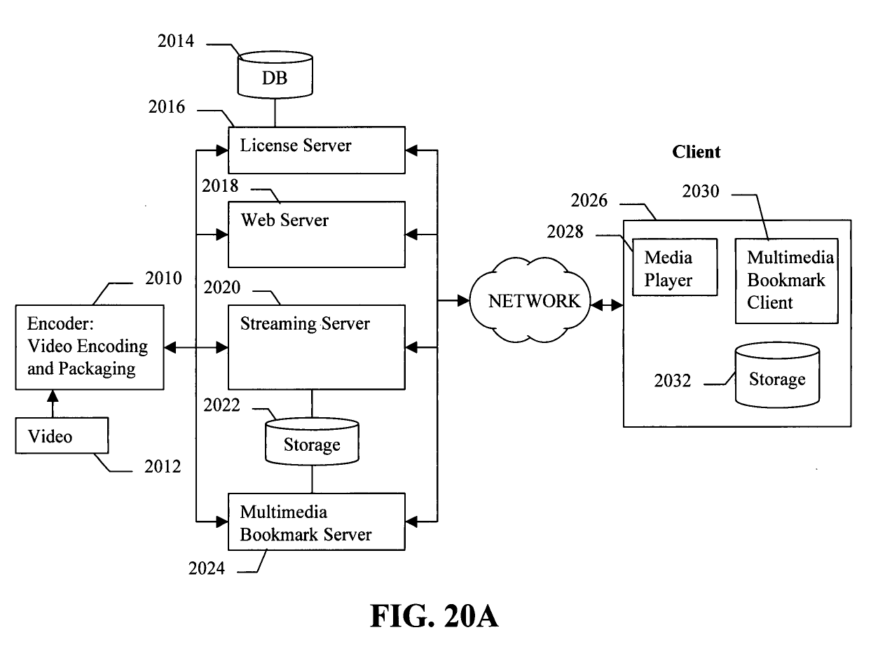

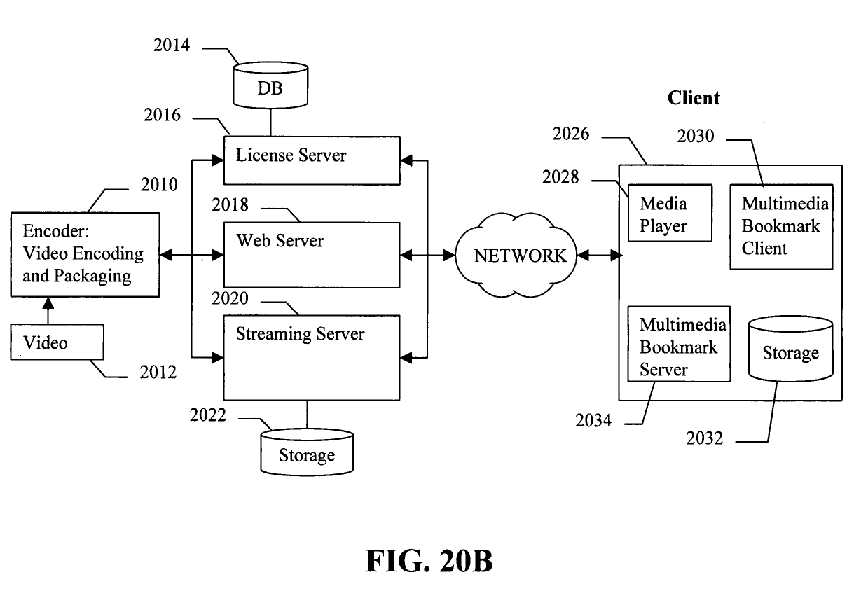

For some systems where only authorized users are allowed to access videos, the videos can be packaged with digital rights management (DRM) technologies. For the systems, making multimedia bookmarks on the DRM packaged videos needs more sophisticated controls. FIGS. 20A and 20B illustrate the general system architectures for making multimedia bookmarks on the DRM packaged videos when multimedia bookmark images are captured at a remote host or client computer itself, respectively, according to an embodiment of the present disclosure.

FIG. 20A illustrates the general system architecture for making multimedia bookmarks on the DRM packaged videos, wherein multimedia bookmark server module 2024 is running at a remote host computer. In the figure, video encoder 2010 encodes and packages the video source 2012 with DRM. The DRM packaged video is stored at storage 2022 where the packaged videos are accessed by streaming server 2020 and multimedia bookmark server 2024. A license key used to unpack the packaged video is stored at database 2014 of license server 2016. The Web server 2018 also has the information related to the license key and users, which is required by the client 2026 when the video starts to be played. Client 2026 comprises media player 2028 and multimedia bookmark client 2030 that takes charge of making and managing multimedia bookmarks stored at local storage 2032.

When a user of client 2026 makes a multimedia bookmark while playing a video with media player 2028, the client requests remote multimedia bookmark server 2024 to capture a multimedia bookmark image from the video with information on the user. Then, before capturing the multimedia bookmark image from the video, multimedia bookmark server 2024 negotiates with license server 2016 and Web server 2018, and requests license server 2016 to retrieve a license key of the user from database 2014. The license server will then return the license key of the user to the multimedia bookmark server if it exists. The multimedia bookmark server then unpacks the requested DRM packaged video stored at storage 2022 with the returned license key of the user, and captures a multimedia bookmark image from the video at a requested bookmarked position. The extracted multimedia bookmark image is sent back to client 2026.

FIG. 20B illustrates another general system architecture for making multimedia bookmarks on the DRM packaged videos, wherein multimedia bookmark server 2034 is running at a requesting client computer. In the figure, local multimedia bookmark server 2034 is located at client 2026 instead of being located at remote host computers in FIG. 20A. The actions are similar to those of FIG. 20A except that local multimedia bookmark server 2034 will capture a multimedia bookmark image directly from a video being played with media player 2028. In this case, when the video starts to be played, media player 2028 has already unpacked the DRM packaged video negotiating with license server 2016 and Web server 2018. Through the media player 2028, local multimedia bookmark server 2034 can extract a video frame from a frame buffer of the media player without negotiating with license server 2016 and Web server 2018 again.

Another embodiment for the making multimedia bookmark on DRM packaged video is to utilize a copy version of the DRM packaged video, which is encoded but not packaged with DRM. The copy version may be equal to the DRM packaged video only without the DRM information, or a low bit rate video that is also generated while the video source 2012 is encoded and packaged, or a low bit rate video transcoded from the DRM packaged video. The copy version of the DRM packaged video may also be stored at storage 2022. With the copy version, the multimedia bookmark server 2024 in FIG. 20A can be free from the negotiating with license server 2016 and web server 2018, which require sophisticated controls on them and time consuming operations. Thus, when client 2026 requests remote multimedia bookmark server 2024 to capture a multimedia bookmark image, the multimedia bookmark server captures the corresponding video frame from the copy version and then sends it to client 2026.

5. Sending Multimedia Bookmark E-mails for Broadcast Programs

Commonly-owned, copending U.S. patent application Ser. No. 09/911,293 filed Jul. 23, 2001 (Publication No. 2002/0069218) discloses system and method for transferring the multimedia bookmarks between users using e-mails and short message services (SMS). The prior art assumes an environment where videos or video streams are archived at separate sites connected to the Internet such as media host 220 of FIG. 2. Bookmark information of a multimedia bookmark includes the URI of a bookmarked video file, which specifies the location of the file that is stored at the sites. Thus, anyone who receives a multimedia bookmark e-mail including the bookmark information can access the video file.

It is disclosed herein method and system of multimedia bookmark and multimedia bookmark e-mail for analog and digital TV broadcast streams. A growing number of people can now watch TV programs by using DVRs or media PCs equipped with that analog/digital TV tuner, video decoder, and appropriate software modules such as Windows XP Media Center Edition 2005 of Microsoft Corporation. With these new consumer devices, TV viewers or PC users can record broadcast video programs into the local or associated storages of their DVR or media PC in a digital video compression format such as MPEG-2. The DVR and media PC allow their users to watch video programs in the way they want and when they want (generally referred to as “on demand”). Due to the nature of digitally recorded video, the users now have the capability of directly accessing a certain point of a recorded program (often referred to as “random access”) in addition to the traditional VCR controls such as fast forward and rewind.

It will be advantageous if users of media PC or DVR can generate multimedia bookmarks on the broadcast video programs stored at their local or associated storages, and send the multimedia bookmark to other users with their own media PCs or DVRs. In this case, just sending the URI of a bookmarked video program stored at local storage of sender's media PC or DVR does not allow the recipient of a multimedia bookmark to simply play the video from the bookmarked position.

The TV-Anytime Forum, an association of organizations which seeks to develop specifications to enable audio-visual services based on mass-market high volume digital local storage in consumer electronics platforms, introduced a scheme for content referencing with CRIDs (Content Referencing Identifiers) with which users can search, select, and rightfully use content on their personal storages of DVRs. The key concept in content referencing is the separation of the reference to a content item (the CRID) from the information needed to actually retrieve the content item (for example, the locator such as the URI of the bookmarked video file). The separation provided by the CRID enables a one-to-many mapping between content references and the locations of the contents. Thus, search and selection yield a CRID, which is resolved into either a number of CRIDs or a number of locators. In a TV-Anytime system, at least one of content creators/owners, broadcasters, or related third parties should originate CRIDs, and access to content should be requested with CRID of the content. Thus, any request to access content will be resolved with the CRID of the content, that is, CRID of the content will be transformed into a single or a number of locators of the content before the content is consumed or played. Ideally, the introduction of CRIDs into a broadcasting system is advantageous because it provides flexibility and reusability of content metadata. However, CRIDs require a rather sophisticated resolving mechanism. The resolving mechanism usually relies on a network which connects consumer devices to resolving servers maintained by at least one of content creators/owners, broadcasters, or related third parties. Unfortunately, it may take time and efforts to appropriately establish and maintain the resolving servers and network although the resolution can be done locally in case the content the CRID refers to is already available locally. CRID and its resolution mechanism are more completely described in the TV-Anytime official document which is now registered as a ETSI (European Telecommunications Standards Institute) Technical Specification, “Broadcast and On-line Services: Search, select, and rightful use of content on personal storage systems (TV-Anytime Phase 1); Part 4: Content referencing”, ETSI TS 102 822-4, V1.1.2, October 2004.

If the multimedia bookmark e-mail for a broadcast program is implemented by using TV-Anytime system, the CRID of a broadcast program stored in the sender's local storage is included in the multimedia bookmark e-mail. The CRID is transformed into a locator describing the location of the program stored in the recipient local storage by the remote or local resolving servers. The transformed locators or CRIDs will be sent back to the receiving device by the resolving servers. Then, the recipient of the multimedia bookmark e-mail with the receiving device can play the program stored in local storage of the receiving device from the bookmarked position.

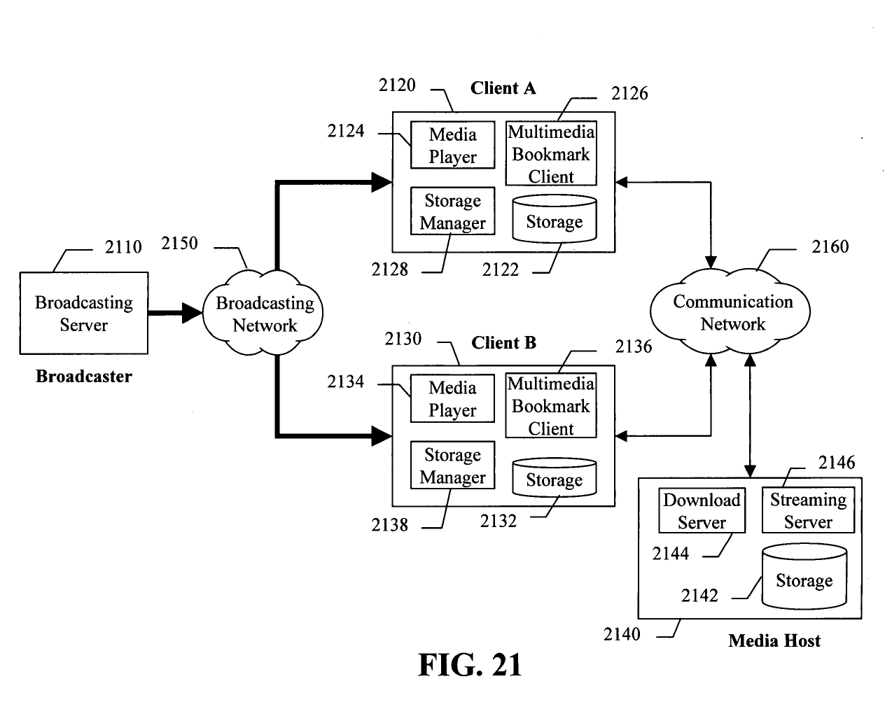

It is disclosed herein an exemplary method for sending multimedia bookmark e-mails between media PCs (or DVRs) without using such concept as CRIDs, thus neither requiring CRIDs for broadcast programs to be broadcast, nor requiring the resolving servers for CRIDs. FIG. 21 illustrates a system for sending multimedia bookmark e-mails between media PCs or DVRs. Broadcaster 2110 broadcasts video programs to media PCs (or DVRs) of TV viewers (client 2120 and 2130) through broadcasting network 2150 such as the Internet, cable, satellite, and terrestrial networks. The broadcast video programs might be recorded in local storages 2122 and 2132 of the clients, and played with media players 2124 and 2134 whenever the viewers want. With playing a program, a viewer of client A 2120 can make a multimedia bookmark on the program with the help of multimedia bookmark client module 2126, and save it in its local storage 2122. Also, the viewer can send a multimedia bookmark e-mail to another client B 2130 through communication network 2160 such as the Internet. If the program has already been recorded in local storage 2132 of the client B, the program can be played from the bookmarked position included in the multimedia bookmark e-mail. Otherwise, the program can be recorded later when it is rebroadcast on the same channel or available from other channels. Furthermore, the program can be downloaded at or streamed to the client B by download server 2144 or streaming server 2146 of media host 2140 connected to the communication network, respectively.

In order for the scenario of FIG. 21 to work correctly without CRID and CRID resolution mechanism, the multimedia bookmark e-mail includes the additional bookmark information which has extra information for identifying or searching the program in addition to the bookmark information described in commonly-owned, copending U.S. patent application Ser. No. 09/911,293 filed Jul. 23, 2001 (Publication No. 2002/0069218). In the present disclosure, the multimedia bookmark information for media PC or DVR comprises the following:
1. URI of a bookmarked program (file);
2. Bookmarked position;
3. Content information such as an image captured at a bookmarked position;
4. Textual annotations attached to a segment that contains the bookmarked position;
5. Title of the bookmark;
6. Metadata identification (ID) of the bookmarked program (file);
7. Descriptive information of the program;
8. Bookmarked date.
   Note that the field “URI of an opener web page from which the bookmarked file started to play” was included in the bookmark information of commonly-owned, copending U.S. patent application Ser. No. 09/911,293 filed Jul. 23, 2001 (Publication No. 2002/0069218), but it is not included in the bookmark information in the present disclosure since the multimedia bookmark is made on a broadcast program, not on a web page. Instead, the field “Descriptive information of the program” where the multimedia bookmark is made is included. It is also noted herein that the bookmarked position can be represented by using media locators for broadcast streams which is described in Section 9 Media Localization for Broadcast Programs.

In current broadcasting environment, TV viewers are currently provided with the information on current and future programs that are currently being broadcast and that will be available for some amount of time into the future such as title, channel number, scheduled start date and time and duration, episode number if the program belongs to a series, synopsis, etc. The EPG information is transmitted to the viewers by being multiplexed into broadcast video streams. The “Descriptive information of the program” can be obtained from any sources that can help the identification of a program such the EPG or metadata (for example, textual description, AV features such as color) or other alternatives and saved into the bookmark information by client 2126 when a multimedia bookmark is made at client A 2120 of FIG. 21.

Storage managers 2128 and 2138 of FIG. 21 could maintain the same directory structure and naming scheme of directories and recorded programs. For example, all recorded programs that are broadcast on February 2005 are stored at a directory whose name is “200502”, and a program that is scheduled to be broadcast at 9:30 PM on 16 Feb. 2005 at channel 205 has a file name such as “20050216-2130-205.mpg” if it is recorded. The directory path and file name is used in the field “URI of a bookmarked program” of the bookmark information in the present disclosure. Alternatively, it is disclosed herein a preferred method and system that do not require the same directory structure and naming schemes. The storage manager at each client can resolve the locations of the stored programs by keeping a mapping table (or its equivalent) for associating the descriptive information of a recorded program with the physical location of the program stored in its local storage. The mapping table will be searched by storage managers 2128 and 2138 when they access the recorded program instead of using the field “URI of a bookmarked program”.

When a viewer of client A 2120 makes a multimedia bookmark on a program recorded in local storage 2122, multimedia bookmark client module 2126 saves the bookmark information described in the present disclosure in its local storage 2122. The viewer then sends a multimedia bookmark e-mail of the multimedia bookmark to other person at client B 2130. If the program has already been recorded in local storage 2132 of the client B, the recipient at the client B can access and play the program by using the field “URI of a bookmarked program” if the program is stored in local storage 2132 with the same file name and path name. Alternatively, the recipient at the client B can access and play the program by using the mapping table (location resolution) if the two storage managers do not share the same naming scheme. If the program has not been recorded in local storage 2132 of the client B, multimedia bookmark client 2136 searches EPG for the program that will be rebroadcast or repeated on the same channel or be available from other channels using the field “Descriptive information of the program” in the bookmark information of the received multimedia bookmark e-mail. When searching EPG, multimedia bookmark client 2136 may utilize text search engine to match the title of the program and episode number if the program belongs to a series with broadcast EPG. If the program is found in the EPG, it will be scheduled to be recorded in local storage 2132. The recorded program can be played later by the recipient at client B. Also, multimedia bookmark client 2136 can search the video programs in media host 2140 using the field “Descriptive information of the program,” if the external media host exists. If the program is found in the media host, it can be downloaded at or streamed to client B by download server 2144 or streaming server 2146 of media host 2140, respectively.

It is noted that the viewer at client A 2120 can generate a “virtual bookmark” on a currently on-air broadcast TV program that has not been recorded in local storage 2122. When the viewer makes a bookmark on the on-air broadcast program that was not recorded in local storage 2122, multimedia bookmark client 2126 can save the field “Descriptive information of the program.” The “Bookmarked position” field can be obtained from the broadcast stream described in Section 9 Media Localization for Broadcast Programs. The virtual multimedia bookmark can be used for the following purposes: First, it can still be sent via multimedia bookmark e-mail to other people with whom the viewer wants to share a video segment around the bookmarked position of the program. The bookmarked program sent by bookmark e-mail can be automatically recorded in the recipient's local storage later by searching EPG schedule for the rebroadcast program if the program was not recorded, or can be downloaded, if needed, from the external media host by using the title of the program and other information included in the bookmark e-mail. Second, the viewer can also easily record the virtually bookmarked program in his/her own local storage later without manually setting the scheduled recording of the program. In other words, when the viewer selects a virtual bookmark from the current list of bookmarks, a small pop-up window showing the list of the same program that will be rebroadcast on the same channel or available from other channels appears. It is noted that the list is shown by automatically searching EPG or the external media host by using the title and other relevant information of the program included in the virtual multimedia bookmark. Then, if the viewer selects one of the list, the program will be recorded in his/her own local storage at its scheduled time, or will be streamed or downloaded from the media host.

6. Fast Generation of Thumbnail (Multimedia Bookmark) Image from DCT Encoded Image

Techniques are disclosed herein for fast generating and resizing of DCT encoded images in order to fast display multimedia bookmark images.

6.1 Introduction

Among many useful features of modern set top boxes (STBs) or DVRs, video browsing, visual bookmark, and picture-in-picture capabilities are very frequently required. The video browsing is more preciously described in “Real-Time Video Indexing System for Live Digital Broadcast TV Programs”, Ja-Cheon Yoon, Hyeokman Kim, Seong Soo Chun, Jung-Rim Kim, Sanghoon Sull, Lecture Notes in Computer Science, CVIR2004, vol. 3115, pp. 261-269, July 2004, which is hereby incorporated by reference. These features typically employ reduced-size versions of video frames, or thumbnail images. Furthermore, thumbnail images can be used to perform fast scene change detection with a STB/DVR that has a low-powered central processing unit (CPU). The scene change detection methods are described in “Rapid scene analysis on compressed video”, B. Yeo and B. Liu, IEEE Trans. Circuits and Systems for Video Technology, vol. 5, no. 6, pp. 533-540, 1995, and “Fast scene change detection for personal video recorder”, Jung-Rim Kim, Sungjoo Suh, Sanghoon Sull, IEEE Trans. Consumer Electronics, vol. 49, no. 3, pp. 683-688, August 2003, which are incorporated by reference herein. Most thumbnail extraction approaches extract DC images directly from a compressed video stream. A DCT coefficient for which the frequency is zero in both dimensions in a compressed block is called DC coefficient and that is used to construct the DC image. However if a block has been encoded with field DCT, DC coefficient as well as some AC coefficients are required for the DC image, which is described in “Fast Extraction of Spatially Reduced Image Sequences from MPEG-2 Compressed Video”, J. Song and B. L. Yeo, IEEE Trans. Circuits and Systems for Video Technology, vol. 9, no. 7, pp. 1100-1114. October 1999, which is incorporated by reference herein. In the process of DC image extraction, the bit length of a codeword coded with variable length coding (VLC) cannot be determined until the previous VLC codeword has been decoded. Thus, to extract the required coefficients for the DC image from a block, not only the codewords related with the DC image but also all other unused coefficient codewords should be fully decoded with variable length decoding (VLD). The present disclosure discloses a multiple-symbol lookup table (mLUT) specially designed for fast DC image extraction, which works on I-frame that is an anchor frame required for extracting P or B frames.

6.2 Brief Description

For fast DC image extraction from MPEG-1/2 video, a multiple-symbol lookup table (mLUT) is disclosed to fast skip several codewords that are not used to construct the DC image. The experimental results show that the method using the mLUT improves the performance greatly by reducing Lookup Table (LUT) count by 50%.

6.3 A Fast DC Image Extraction from I-Frame

For a frame-coded macroblock X 2210, where 8×8 blocks (Xᵢ, 0≦i≦3) are encoded with frame DCT coding, the DC image extraction is just to find DC coefficients for each block in the macroblock. As shown in “Fast scene change detection for personal video recorder”, Jung-Rim Kim, Sungjoo Suh, Sanghoon Sull, IEEE Trans. Consumer Electronics, vol. 49, no. 3, pp. 683-688, August 2003, which is incorporated by reference herein, for a block Xᵢ encoded with frame DCT coding, let Rᵢ be a corresponding 1×1 reduced block from 8×8 spatial block Pᵢ by reducing both horizontal and vertical resolution by 8. Then, the reduced block Rᵢ, which denotes an average value for 8×8 spatial block Pᵢ, can be written as

$${R}_{i} = \frac{1}{64} {V}_{F} {P}_{i} {H}_{F} = \frac{1}{64} {V}_{F} {C}^{t} {X}_{i} {CH}_{F} , \qquad ( 1 )$$

where V_{F}=[1 1 1 1 1 1 1 1], H_{F}=V^{t}_{F}, and C is an 8-point DCT matrix and 0≦i≦3.

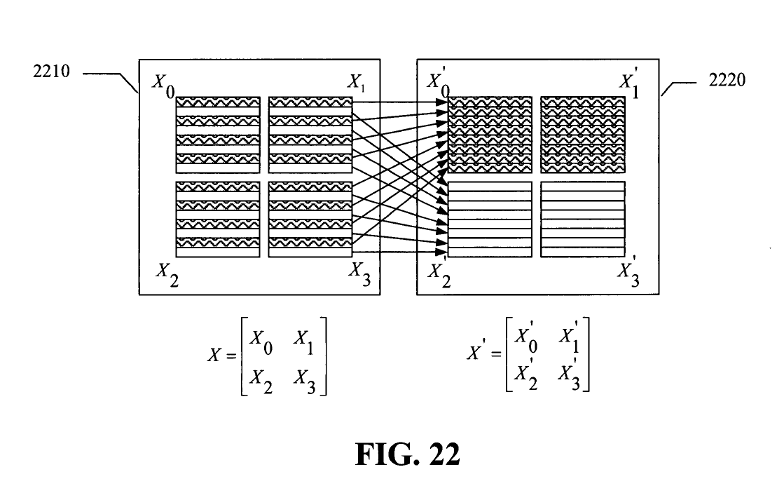

On the other hand, if a block is encoded with field DCT coding, the process of DC image extraction requires some AC coefficients as well as DC coefficient. FIG. 22 shows luminance macroblock structure in frame and field DCT coding. According to “Fast scene change detection for personal video recorder”, Jung-Rim Kim, Sungjoo Suh, Sanghoon Sull, IEEE Trans. Consumer Electronics, vol. 49, no. 3, pp. 683-688, August 2003, which is incorporated by reference herein, for a macroblock X 2220, where 8×8 blocks (X′ᵢ, 0≦i≦3) are encoded with field DCT coding, a DC image can be constructed by using only either top field blocks (X′₀, X′₁) or bottom field blocks (X′₂, X′₃). Let R′ᵢ be a 2×1 reduced block from 8×8 upper spatial block P′ᵢ by reducing horizontal resolution by 8 and the vertical resolution by 4. Then, the reduced block R′ᵢ, which represents two average values for two 8×8 spatial blocks P′ᵢ and P′₂ᵢ₊₁ where i=0 and 1, can be written as

$${R}_{i}^{′} = \frac{1}{32} {V}_{T} {P}_{i}^{′} {H}_{F} = \frac{1}{32} {V}_{T} {C}^{t} {X}_{i}^{′} {CH}_{F} , \qquad ( 2 )$$

where V_{T}=[1 1 1 1 0 0 0 0], H_{F} is the same matrix in (1), and C is an 8-point DCT matrix. Let each coefficient component of a block A be referenced by two indexes such as (A)₀₀ for a DC coefficient and (A)ᵢⱼ for an (i,j)^{th}, (i,j)≠(0,0), AC coefficient at row i and column j in the block A. Then, from (1) and (2) when a macroblock is encoded with field DCT coding, four DC coefficients ((X₀)₀₀, (X₁)₀₀, (X₂)₀₀ and (X₃)₀₀) can be approximately acquired by considering only two upper blocks as following:

$$[ \begin{matrix}{( {X}_{0} )}_{00} & {( {X}_{1} )}_{00} \\ {( {X}_{2} )}_{00} & {( {X}_{3} )}_{00}\end{matrix} ] \approx [ \begin{matrix}{( {X}_{0}^{′} )}_{00} + 0.906 {( {X}_{0}^{′} )}_{10} & {( {X}_{1}^{′} )}_{00} + 0.906 {( {X}_{1}^{′} )}_{10} \\ {( {X}_{0}^{′} )}_{00} - 0.906 {( {X}_{0}^{′} )}_{10} & {( {X}_{1}^{′} )}_{00} - 0.906 {( {X}_{1}^{′} )}_{10}\end{matrix} ] . \qquad ( 3 )$$

6.4 Design of the mLUT

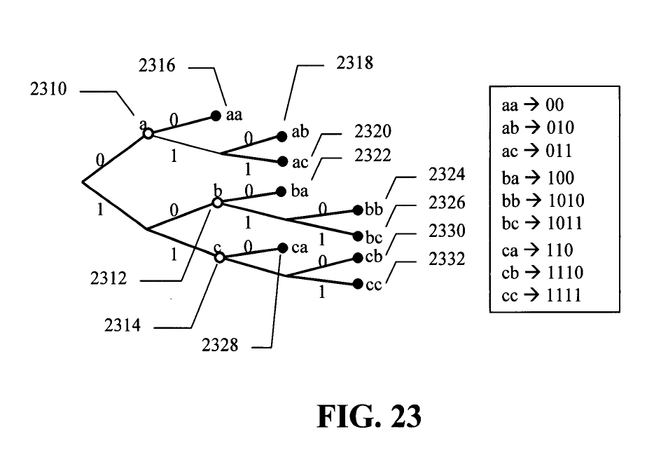

MPEG-2 VLC codeword is prefix-free code which states that no codeword may be the prefix of any other codeword, and therefore the codeword is uniquely decodable. >From the property of unique decodability of the codeword, it can be found that a concatenation of some codewords or a multiple codewords cannot be a prefix of any other multiple codewords. For example, FIG. 23 shows the binary code tree for the concatenation of two codewords represented by black leaf nodes. Using the original tree for single codeword that is represented by white nodes whose symbols are a 2310, b 2312, and c 2314, the tree can be buit simply by grafting a copy of the original tree onto each of its leaf nodes. The tree shows that each concatenation of two codewords whose symbols are aa 2316, ab2318, ac 2320, ba 2322, bb 2324, bc 2326, ca 2328, cb 2330, and cc 2332 has a different path from root node to leaf node, and therefore the concatenation of two codewords also are uniquely decodable. Thus, the uniquely decodable mLUT can be built by which fast the unused codewords for DC image extraction can be skipped.

In the DCT coefficients table one specified in MPEG-2 that is used for AC coefficients of intra blocks with intra-vlc-format, there are common prefix bits that can determine the bit length of several codewords that have same bit length. The prefix bits are called as length-prefix-bits. For example, just looking four bits of 1110 that is the length-prefix-bits for two VLC codewords such as 11100s and 11101s, where s is a sign bit, it can be found that the length of a VLC codeword starting with 1110 is 7 bits including a sign bit length whether the codeword is 11100s or 11101s. To cover all VLC codewords in DCT coefficient table one by the mLUT, the minimum bit length of the length-prefix-bits for longest codeword is 12 bits. Thus, the minimum entry size of mLUT is 4096 (2¹²) each of which entries can be accessed by the 12 bits address.

Let A be a partial bit sequence of a compressed MPEG-2 bit stream for a block compressed with VLC, then the bit sequence A is composed of codewords such as following format:
A=(DC)a₀a₁a₂ . . . aₙ₋₂aₙ₋₁(EOB), (4)
where DC denotes codewords for DC coefficient (A)₀₀, n is the number of AC coefficients, aⱼ is a codeword for j^{th} AC coefficient (0≦j<n), and EOB is the end of block codeword. To construct DC image from the block A coded with frame DCT coding, the only one codeword DC is required to be decoded with VLD. Whereas if the block A is coded with field DCT coding, an additional AC coefficient (A)₁₀ as shown in (3) is needed. The AC coefficient (A)₁₀ can be obtained from a₀ or a₁ according to the scanning order for DCT coefficients: a₀ for alternate scan and a₁ for zigzag scan. After extracting required codewords, the rest codewords can be skipped fast by using mLUT. The entry value of mLUT is referred for the sum of bit lengths of the concatenated codewords for the multiple-symbol, where the concatenated codewords act as the address into the mLUT. The value of i^{th} entry of mLUT can be calculated by following:

$${mLUT}_{i} = \{ \begin{matrix}{\sum }_{j = 0}^{h - 1} l ( {i}_{j} ) , & if {i}_{h - 1} = EOB \\ {\sum }_{j = 0}^{m - 1} l ( {i}_{j} ) , & otherwise\end{matrix} , \qquad ( 5 )$$

where h and m are the number of codewords or symbols determined by the bit sequence of address i, and iⱼ is a j^{th} codeword or a length-prefix-bits of a j^{th} codeword, which is contained in the bit sequence of i. l(iⱼ) is the bit length of the codeword determined by iⱼ. If iⱼ is an escape codeword ESC, even though the bit length of ESC itself is 6 bits, the bit length l(iⱼ) can be 24 bits due to the following two fixed length code (FLC) codewords for its run (6 bits) and signed_level (12 bits).

12 bit mLUT whose entry size is 4096 (2¹²) can be built, for example, and the values are determined by (5) with its entry address i (0≦i<4096). For instance, the 2394^{th} entry value of the 12 bit mLUT is 10, because the bit sequence of 2394 whose binary representation is 100101011010 has two AC coefficient codewords (i₀:100, i₁:101) including a sign bit for both and one EOB (0110). The rest two bits (10) are don't care bits due to the previous end of block codeword which indicates the block boundary. For example, let's the exemplary VLC bit sequence of a block with frame DCT coding is 00110010101101000110. Then, the process of the fast DC image extraction starts with extracting DC coefficient DC (001) from the VLC bit sequence by using a traditional method that utilizes general LUT such as a VLC table defined in the MPEG-2. After extraction of the DC coefficient form the VLC bit sequence, by looking up the length of multiple codewords for the residual bits of the VLC bit sequence from the 12 bits mLUT, the next 10 bits (1001010110) can be skipped and the start bit position of the next block can be pointed with one LUT count. Otherwise, with the method using traditional LUT the LUT count is three times for three subsequence codewords: two AC coefficient codewords and one EOB codeword.

6.5 Experimental Results

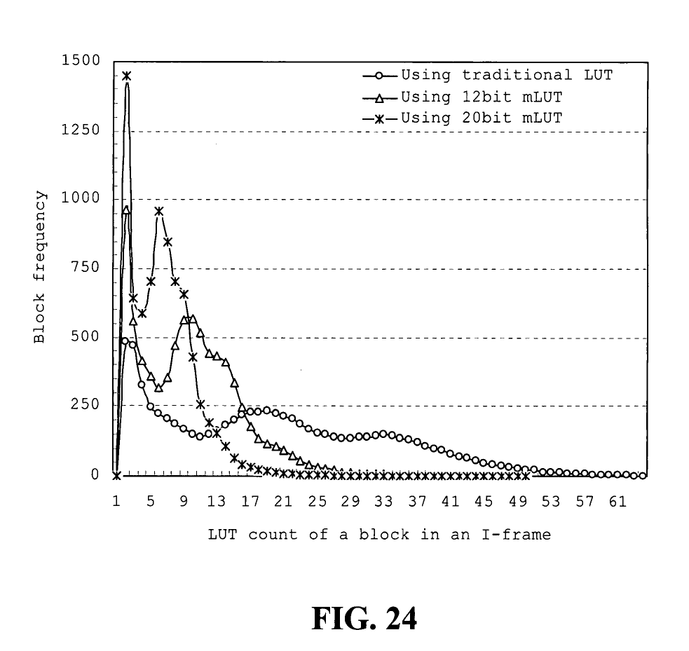

The kbit mLUT is tested with two videos: one is the MPEG-2 video elementary stream, Table-Tennis video sequence (704×480, 8 Mbps and 4:2:0 format), the other is a real terrestrial HDTV broadcast program (1920×1080, 19.4 Mbps, and 4:2:0 format). FIG. 24 shows that while extracting DC images for 38 I-frames in the Table-Tennis video by using the kbit mLUT, the block frequency at low LUT count of a block can be increased such that the required LUT count per frame can be dramatically decreased. Table 1 shows the results of the method using kbit mLUT: even the 12 bit mLUT requiring only 4 Kbytes memory can reduce the LUT count by 50% for the Table-Tennis and 37.4% for the HDTV broadcast program. The method using kbit mLUT achieves significant speed-gain for DC image extraction compared with a method using a traditional LUT.

TABLE 1
LUT count per block and reduction rate in DC image extraction
using a traditional LUT and the proposed kbit mLUT for Table-Tennis
video sequence and a HDTV broadcast program.

| Video | Traditional | kbit mLUT | | | | |
|---|---|---|---|---|---|---|
| sequence | LUT | k = 12 | k = 14 | k = 16 | k = 18 | k = 20 |
| Table- | 19.77 | 9.87 | 8.64 | 7.75 | 7.02 | 6.46 |
| Tennis | — | 50.09% | 56.28% | 60.82% | 64.49% | 67.32% |
| HDTV | 6.59 | 4.13 | 3.77 | 3.52 | 3.32 | 3.16 |
| broadcast | — | 37.4% | 42.77 | 46.51% | 49.62% | 51.98% |
| program | | | | | | |

7. Fast Resizing of Thumbnail (Multimedia Bookmark) Image from DCT Encoded Image

7.1 Introduction

In the conventional method, two steps are related to construct decoded and resized images from DCT encoded image. First step is fully decoding process and second step is resizing process. Fully decoding process is composed of entropy decoding, dequantization and full inverse DCT (IDCT). Full IDCT requires high computational complexity. Resizing process like bilinear interpolation also requires additional complexity proportional to the image resolution to be interpolated. However, requiring high computational complexity is not suitable for set-top box that has low-powered CPU and limited memory size. Thus, the present disclosure discloses an image resizing scheme avoiding full decoding processing which results in alleviating the computational load and reducing the memory requirement.

7.2 Conventional Method

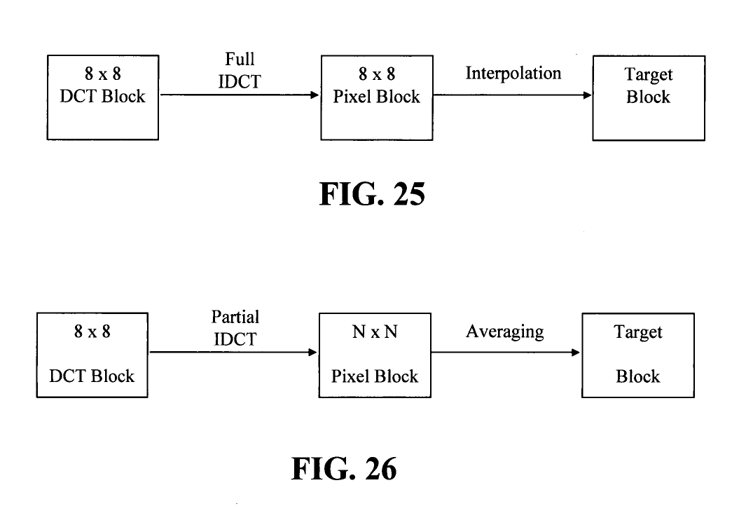

The construction of a reduced image from JPEG image can be divided into two parts. Those are full decoding part for spatial domain and interpolation part to attain the target resolution. As shown in FIG. 25, original size image is constructed by taking 8×8 IDCT for all 8×8 blocks and interpolation such as bilinear is performed to the original size of image in the spatial domain in conventional method. Three problems are related to this conventional scheme. First, full IDCT (8×8 block IDCT) requires high computational cost. It includes full entropy decoding, de-quantization and 8×8 IDCT process. Second, the image size to be interpolated is the same as the original image size. Since the interpolation tends to require more computations according to the larger image size, the image size to be interpolated should be reduced before interpolation. Third, the fact that the image size to be interpolated is the same as the original image size also causes the problem of memory requirement. The spatial domain image has to be stored at the memory before interpolation. Thus, it requires the same amount of the memory size of the original image size.

7.3 Detailed Description

Instead of using full IDCT in the conventional method, partial IDCT is substituted for full IDCT as shown in FIG. 26. Partial IDCT involves with partial entropy decoding and dequantization while providing N/8 reduced image by performing fast N-point IDCT. By performing partial IDCT, a reduced size of the image to be interpolated is produced. Thus, the target image size can be obtained by interpolation in lower computational complexity and the memory size of the reduced image size. Second, averaging for interpolation is employed. For set-top box which has low-powered CPU, multiplication is too expensive operation. Averaging for interpolation is employed since averaging can be done with addition and shift operation while typical interpolation method involves multiplication. Although partial IDCT based on fast N-point IDCT supports only N/8 reduced images, this limited reduction ratio can be diversified by averaging the output image of partial IDCT. By employing averaging, a flexible reduction ratio such as N/16, N/24, N/32 (N=1, 2, . . . , 7) is produced. As an example, Table 2 shows the reduction ratio by N/16 and N/24. In the table, a reduction ratio is expressed as a fractional number. If a reduction ratio is 3/16, the proposed scheme performs 3×3 IDCT and takes averages of every three pixels both horizontally and vertically. In the following section, the present disclosure discloses new schemes to construct a resized image from JPEG image to be fit for display device. One of the proposed schemes constructs a resized image without cropping an input image while the other scheme crops an input image.

TABLE 2
Reduction ratio and its computed value

| Reduction Ratio | $\frac{1}{24}$ | $\frac{1}{16}$ | $\frac{2}{24}$ | $\frac{1}{8}$ | $\frac{4}{24}$ | $\frac{3}{16}$ | $\frac{5}{24}$ | $\frac{2}{8}$ |
|---|---|---|---|---|---|---|---|---|
| | 0.0417 | 0.0625 | 0.0833 | 0.1250 | 0.1667 | 0.1875 | 0.2083 | 0.2500 |
| Reduction Ratio | $\frac{7}{24}$ | $\frac{5}{16}$ | $\frac{3}{8}$ | $\frac{7}{16}$ | $\frac{4}{8}$ | $\frac{5}{8}$ | $\frac{6}{8}$ | $\frac{7}{8}$ |
| | 0.2917 | 0.3125 | 0.3750 | 0.4375 | 0.5000 | 0.6250 | 0.7500 | 0.8750 |

A. No Cropping Algorithm

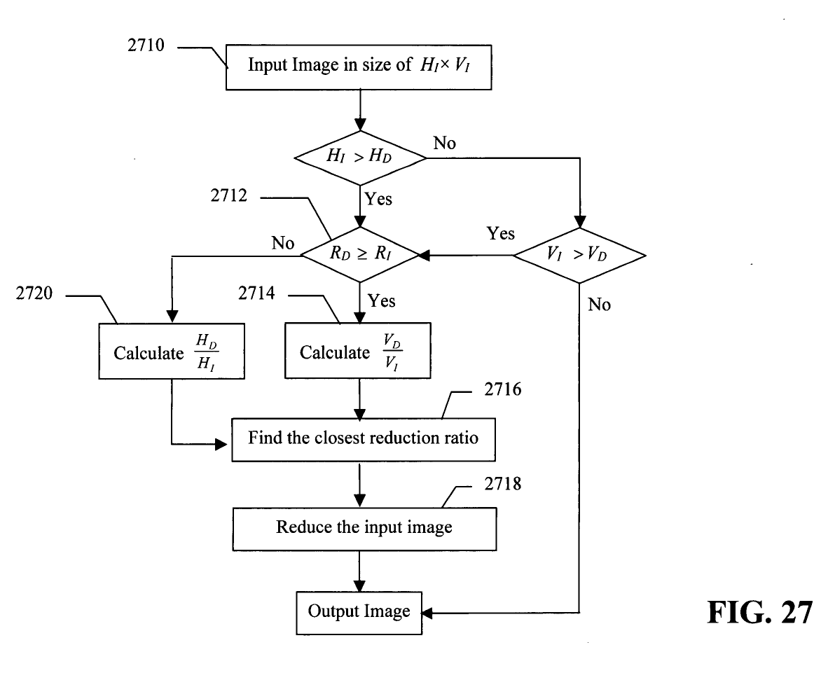

FIG. 27 illustrates an exemplary flow for the no cropping algorithm. Let H_{I} and V_{I} be horizontal and vertical resolutions of an input image 2710 and let H_{D} and V_{D} denote horizontal and vertical resolutions of a display device, respectively. Then horizontal and vertical ratio of an input image R_{I} can be written as

$${R}_{I} = \frac{{H}_{I}}{{V}_{I}} \qquad ( 6 )$$

Similarly, the ratio of display device R_{D} can be defined as

$${R}_{D} = \frac{{H}_{D}}{{V}_{D}} \qquad ( 7 )$$

Assume that R_{D} is larger than R_{I} at step 2712. This means that width of display is a sufficient size to display the reduced image of an input image. Thus the reduced image will be fit to be displayed if the input image is reduced with the reduction ratio that the height of the input image becomes less or equal to the height of the display. The reduction ratio can be determined by dividing V_{D} into V_{I} at step 2714 and finding the closest and equal or less predefined ratio in Table 2 at step 2716. For example, suppose that a JPEG encoded image of 2304×1728 resolution is resized for display in the SDTV of 720×480. In this case, first, it is checked whether the input image can be displayed in the SDTV without any resizing. Since the resolution of the input image is larger than that of the SDTV in both width and height, R_{I} and R_{D} are calculated to find a clue which dimension (width or height) should be used as. Since R_{I} is 1.3333 and R_{D} is 1.5 in the example, it is found that the reduction ratio should be determined based on the ratio of heights. The ratio of display height versus input image height is 0.2778. Then, from Table 2, it is found that

$$\frac{2}{8} ( = 0.2500 )$$

is the closest and equal or less reduction factor. Thus the input image is reduced at step 2718 by taking only 2-point IDCT in each 8×8 block both horizontally and vertically.

For the case that R_{D} is less than R_{I} at step 2712, the same procedure can be repeated except that now width is processed instead of height at step 2720. FIG. 27 illustrates the above explained scheme.

B. Cropping Algorithm

Suppose that R_{D} is larger than R_{I} as defined in (6) and (7) at step 2810. This means that width of display is a sufficient size to display the reduced-size image of an input image. However, if top and bottom region of the input image is cropped, the size of the reduced image will be closer to the size of display. Let R_{IV} denote horizontal and vertical ratio of a cropped input image in top and bottom region. Then R_{IV} can be written as

$${R}_{IV} = \frac{{H}_{I}}{{V}_{I} - α} , \qquad ( 8 )$$

where H_{I} is a width of an input image, V_{I} is a height of an input image, and a is a height of cropping region that makes the height of the cropped image V_{I}−α.

To find the best cropping size a at step 2812, let R_{D} equal to R_{IV} in the sense that the cropped input image has a same width and height ratio as display device. Then, the cropping size a of the input image can be expressed as

$$α = {V}_{I} - [ \frac{{H}_{I}}{{R}_{D}} ] \qquad ( 9 )$$

After cropping the input image, the reduction ratio can be calculated at step 2814 by dividing V_{D} into V_{I}−α and finding the closest and equal or less predefined ratio in Table 2. For example, suppose that a JPEG encoded image of 2304×1728 resolution is resized for display in the SDTV of 720×480. In this case, first, it is checked whether the input image can be displayed in the SDTV without any resizing. Since the resolution of the input image is larger than that of the SDTV in both width and height, R_{I} and R_{D} are calculated. Since R_{I} is 1.3333 and R_{D} is 1.5, the input image is cropped in upper or lower region by α=192 according to (9). The ratio of display height versus cropped input image height is 0.3125. Then

$$\frac{5}{16} ( = 0.3125 )$$

is found as the closest and equal or less reduction factor from Table 2. Thus the cropped input image is reduced by taking only 5×5 IDCT in each 8×8 block and taking averaging of every two pixels both horizontally and vertically.

For the case that R_{D} is less than R_{I}, the height of display sufficient to display the reduced image of an input image. However, if left and right area of the input image is cropped, the size of the reduced image will be closer to the size of display. Let R_{IH} denote horizontal and vertical ratio of a cropped input image in left and right region. Then R_{IH} can be written as

$${R}_{IH} = \frac{{H}_{I} - β}{{V}_{I}} , \qquad ( 10 )$$

where H_{I} is a width of an input image, V_{I} is a height of an input image, and β is a size of cropping region that makes the width of the cropped image H_{I}−β.

The cropping size β of the input image, which is calculated at step 2816, can be expressed as
β=H_{I}−[R_{D}V_{I}] (11)

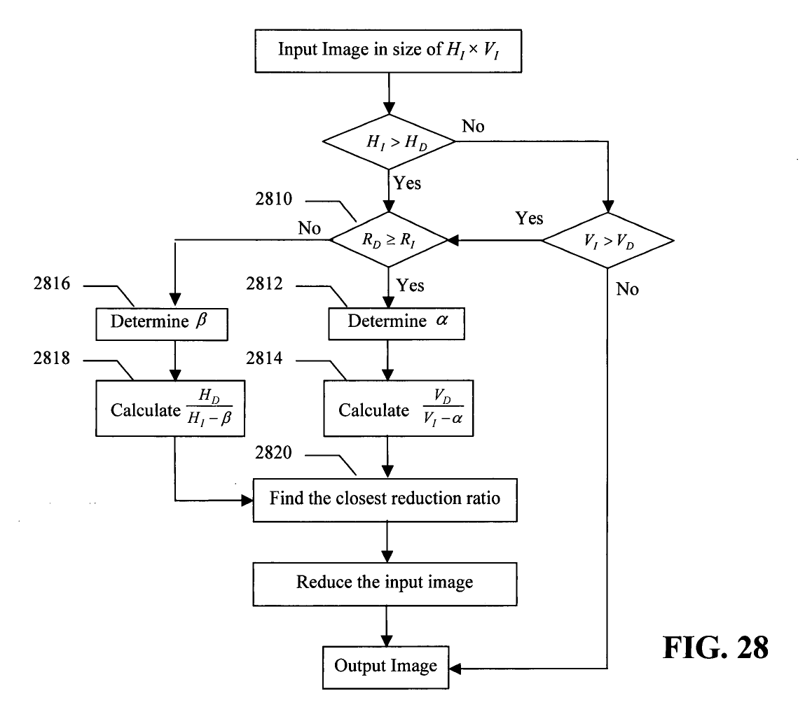

After cropping the input image, the reduction ratio can be calculated by dividing H_{D} into H_{I}−β at step 2818 and finding the closest and equal or less predefined ratio in Table 2 at step 2820. FIG. 28 shows how to reduce the input image to display in the desired device with cropping.

8. Fast Transcoding of DCT Encoded Video

8.1 Introduction

Some of digital cameras that are currently available utilize M-JPEG (Motion-Joint Photographic Experts Group) encoding scheme to compress digital video sequences. Various vendors have applied JPEG encoding to individual frames of a video sequence, and have called the result “M-JPEG.” JPEG is an international compression standard used for still images. It is standardized in ISO-IEC/JTC1/SC29/WG1 documents.

In order to view the digital videos or movies encoded in M-JPEG format in a digital camera, users have to connect the digital camera to TV monitor or PC, which is not convenient. Thus, users might want to easily view photos and movies through digital appliances including DTV, DVD player and STB just by inserting the memory card from the digital camera into a memory slot in a digital appliance. Most of current digital appliances have MPEG-2 decoder/decompressor chips/modules since the MPEG-2 video compression standard is used for digital broadcasting and DVD. The decoding of M-JPEG streams requires a computationally expensive steps of performing a large number of computations of inverse DCT (IDCT) for each frame, and thus, for the current digital appliances having low-powered CPUs (for example, 200 MIPS), the decoding of M-JPEG streams by using the software module is too slow. Therefore, it is desirable if there is a way of utilizing the computationally powerful MPEG-2 decoder chips in digital appliances to decode M-JPEG chips without using a dedicated M-JPEG decoder chips.

However, the digital videos encoded in M-JPEG cannot be directly decoded by a MPEG-2 decoder chip. Typically, M-JPEG movie streams consist of video streams and audio streams encoded in Wave audio format. Thus, if there is an efficient way of transcoding M-JPEG streams into MPEG-2 streams, MPEG-2 modules included in most of the digital appliances currently available can be fully utilized to decode M-JPEG streams. In other words, if a MPEG-2 decoding module that is implemented in either hardware or software is already available in a digital appliance, an M-JPEG stream can first be converted to an MPEG-2 stream by the disclosed transcoding technique, and then the resulting MPEG-2 stream can be decoded by the MPEG-2 decoding module without using a dedicated complete M-JPEG decoding module.

A simple way of transcoding is achieved by fully decoding a compressed video stream which has been encoded according to a first encoding scheme, and then fully encoding the decoded video according to a second encoding scheme. However, it is usually computationally expensive to fully decode a compressed video stream in a first encoding scheme and then encode the decompressed video in a second encoding scheme. Therefore, the present disclosure provides an efficient transcoder which partially decodes a compressed video stream encoded according to a first encoding scheme and then encodes the partially decompressed video stream according to a second encoding scheme. The present disclosure minimizes the computation needed for transcoding by first analyzing two encoding/compression schemes and then identifying the reusable parts (for example, blocks encoded in similar transform coding methods such as DCT) of a compressed video stream to be transcoded. An exemplary transcoder is described in details which partially decodes an M-JPEG video stream and then encodes the partially decompressed video stream into an MPEG video stream.

8.2 Detailed Description

The present disclosure is to provide a new transcoding technique, where an input encoded video stream conforming to a first DCT-based image compression scheme (e.g. M-JPEG) is efficiently transcoded into an output video streams conforming to a second DCT-based frame compression scheme (e.g. MPEG). Therefore, DCT blocks used for the first DCT-based compression are reused in the second DCT-based compression.

The present disclosure is to provide a technique for frame rate conversion during transcoding. The disclosed method first performs the syntax conversion and then frame rate conversion if needed. When the frame rate of the video stream encoded in a first compression scheme needs to be increased in order to meet the minimum frame rate supported by a second compression scheme (for example, MPEG-2), predicted pictures (P-pictures) are generated and inserted between intra pictures (I-pictures) by using skipped macroblock.

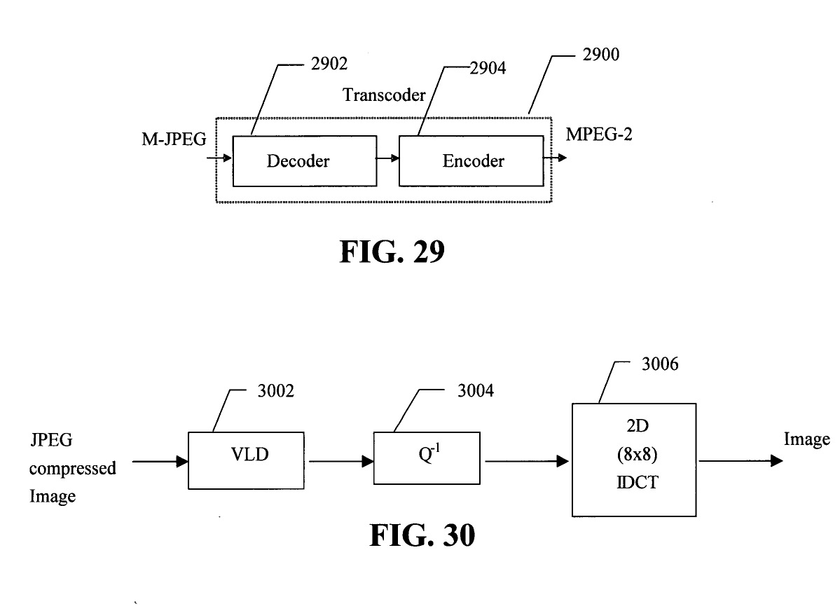

FIG. 29 shows a typical transcoder using a full decoder 2902 and a full encoder 2904. For the basic transcoder 2900, in order to transcode a M-JPEG stream to a MPEG-1/2 stream, a M-JPEG stream should be fully decoded by the MJPEG decoder 2902 and then the decoded stream is encoded by the full MPEG-1/2 encoder 2904.

A full JPEG decoder is illustrated in FIG. 30. The compressed image data is decoded first by a variable length decoder (VLD) 3002, and then passes to an inverse quantizer 3004 which outputs the values of the dequantized DCT coefficients. The DCT coefficients are then transformed back into the pixel domain by an IDCT unit 3006 to produce a decompressed image signal in the pixel domain.

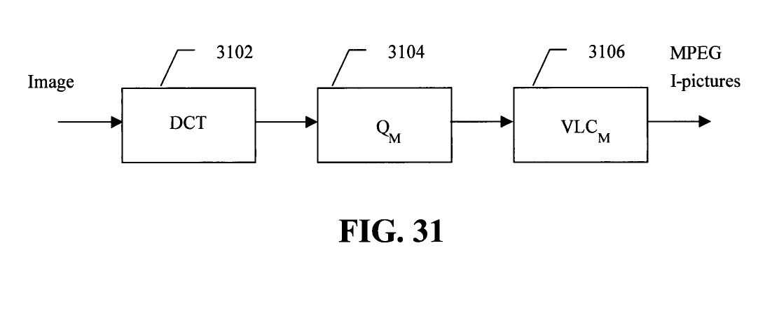

FIG. 31 shows an intra picture encoding module in a MPEG-1/2 encoder. The pixel domain raw image data is encoded by the DCT unit 3102, and then passes to a quantizer 3104 which outputs the values of the quantized DCT coefficients. The DCT coefficients are encoded into a MPEG-1/2 intra picture by a variable length coder (VLC) 3106.

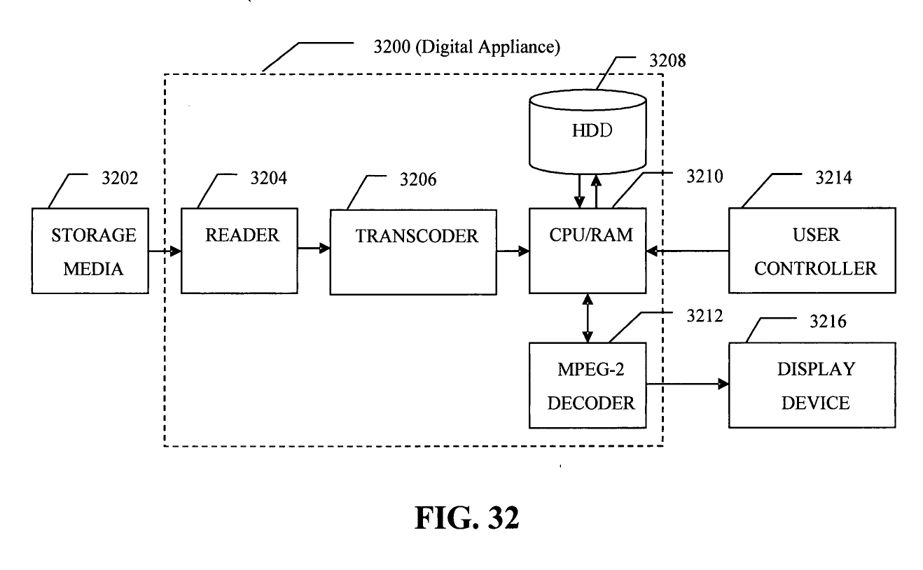

FIG. 32 illustrates an exemplary system of the present disclosure comprising a digital appliance 3200 with an optional hard disk drive (HDD) 3208. The storage media 3202 includes Compact Flash memory card, Memory Stick, Smart Media card, MMC (MultiMedia Card), SD (Secure Digital) card, XD Picture Card, and MicroDrive, etc. The digital movie files shot by digital cameras can be accessed through the reader 3204 by inserting a storage media 3202 to the corresponding slot. Then, the digital movie files stored in storage media are transcoded from M-JPEG to MPEG-2 by the transcoder 3206. The transcoder represents either a chip/DSP/RISC hardware 3206 or a software module running in the CPU/RAM 3210. The transcoder 3206 converts MCUs of an input M-JPEG file into macroblocks of MPEG, and adjusts the frame rate of the M-JPEG file if the frame rate of an M-JPEG file is not supported by MPEG-1/2 decoder chip 3212 wherein MPEG-2 allows the frame rate between 24 fps to 30 fps. After M-JPEG to MPEG transcoding, the resulting transcoded MPEG stream can be decoded by a MPEG decoder 3212. A user controller 3214 is provided, such as a TV remote control. A decoded stream is viewed on a display device 3216 such as a TV monitor.

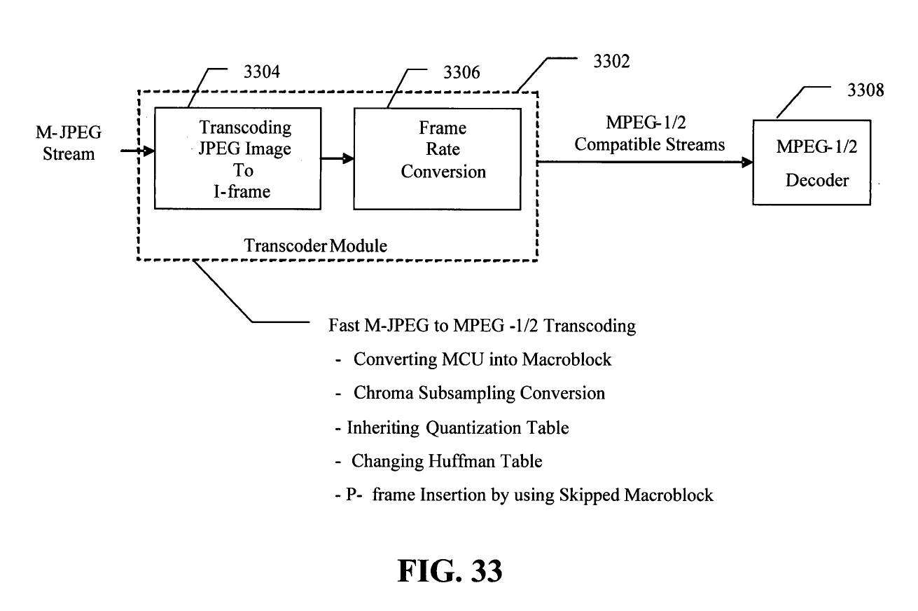

FIG. 33 shows a block diagram of the transcoder 3302 corresponding to 3206 in FIG. 32. The transcoder 3302 comprises the block 3304 that converts a JPEG frame to an I-picture, and the block 3306 that converts the frame rate. The block 3304 transforms a JPEG frame into an MPEG I-frame by processing chroma subsampling, Huffman table, block units, and quantization table. The block 3306 converts the stream from 3304 into a MPEG-1/2 compatible stream by inserting P-frames using skipped macroblock.

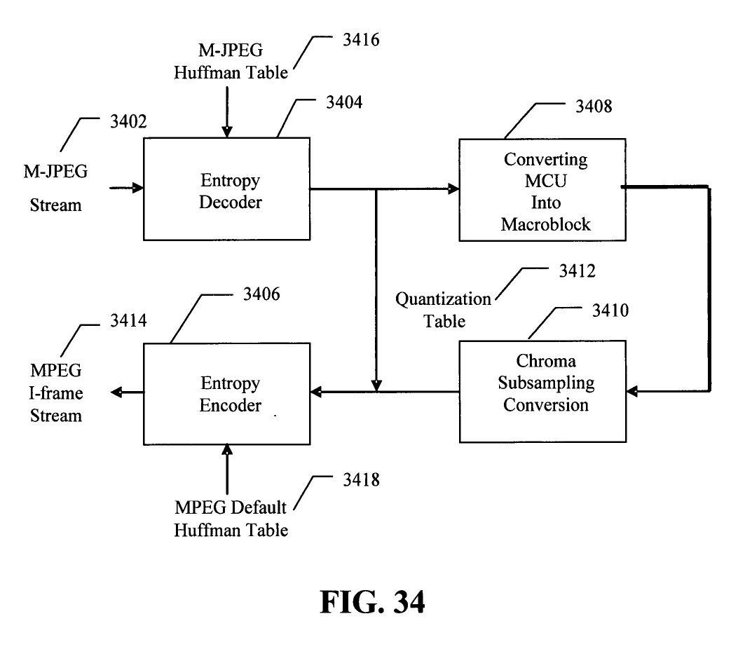

FIG. 34 illustrates a detailed diagram of the block 3304 of FIG. 33. The block 3404 performs entropy decoding of an M-JPEG stream 3402 using M-JPEG Huffman table 3416. The block 3408 converts or rearranges MCU blocks of JPEG to the corresponding macroblocks of MPEG. The JPEG specification does not put restriction on a chroma subsampling mode whereas three chroma subsampling modes (4:2:0 4:2:2 4:4:4 YCbCr chroma-subsampling) are allowed in MPEG-2, and only one mode 4:2:0 is allowed in case of MPEG main profile, in particular. Thus, the block 3410 performs the conversion of chroma subsampling mode (for example, using an average filter in the DCT transform domain) if a chroma subsampling mode that is not supported by MPEG-2 is used in a JPEG-coded input stream. The quantization matrix table 3412 of M-JPEG is inserted into an appropriate position for a quantization table of the resulting MPEG stream 3414. Then, the block 3406 performs entropy encoding by using the MPEG Huffman table 3418.

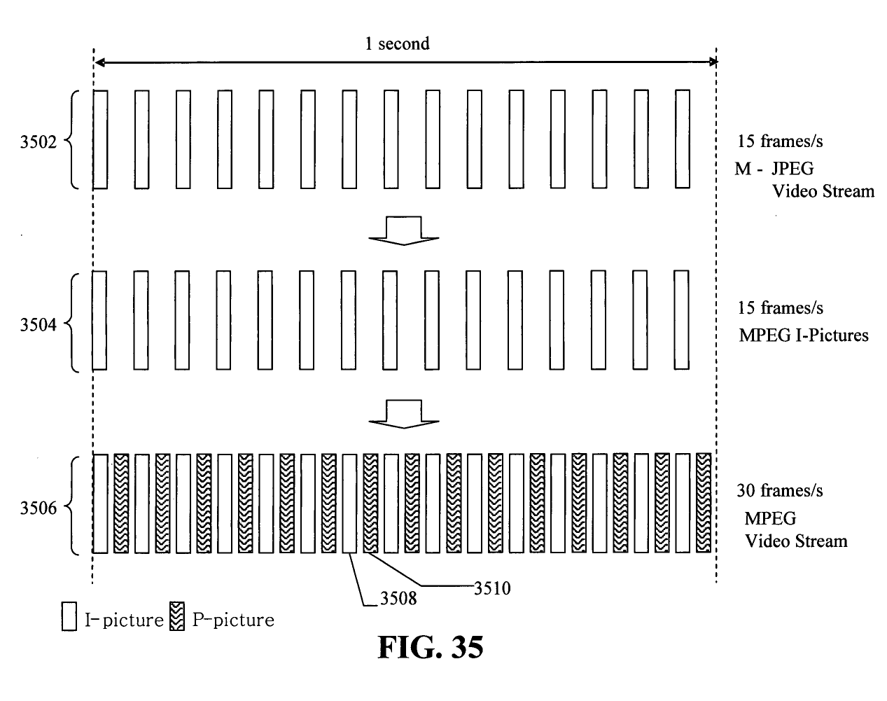

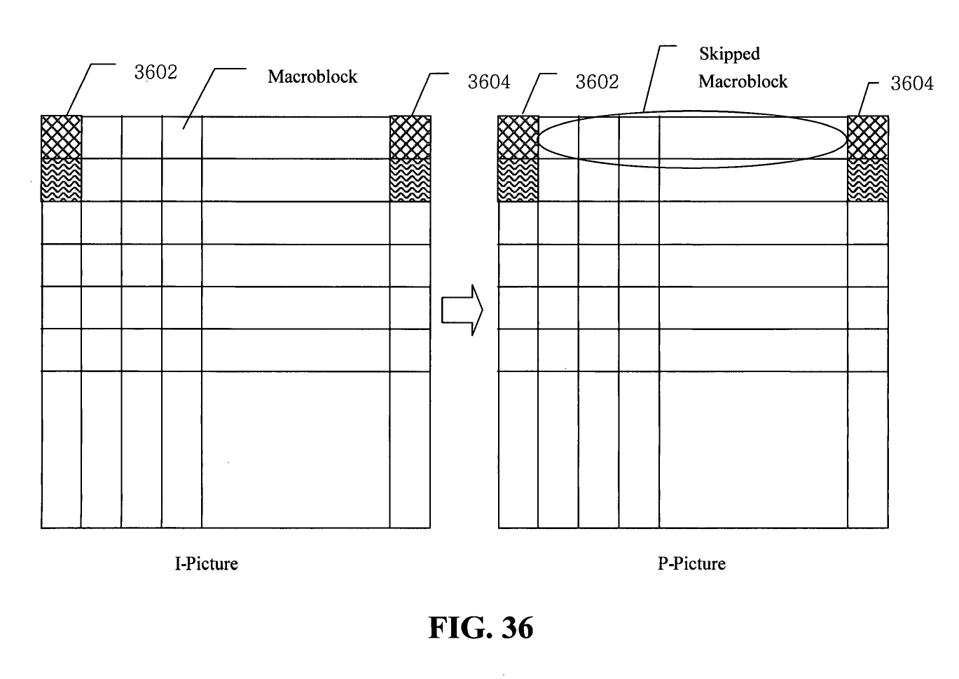

FIG. 35 illustrates a frame rate conversion method (corresponding to the block 3306 of FIG. 33) disclosed in the present disclosure. Digital cameras currently available support various compression schemes such as MPEG-EX/QX used by SONY, MOV and AVI. However, due to hardware cost, digital videos are usually encoded at the lower frame rate (for example, 16 fps in MPEG-EX/QX, 15 fps in MOV and AVI). Thus, the frame rate should be adjusted or increased so that it is in the range supported by the MPEG specification. For example, consider the case where the original M-JPEG video 3502 is encoded at the frame rate of 15 fps and needs to be transcoded to MPEG video 3506 with the frame rate of 30 fps. Then, a sequence of frames in M-JPEG video 3502 with the frame rate of 15 fps are first converted to a sequence of MPEG I-pictures at 15 fps 3504. However since the frame rate of MPEG video stream is constrained to the range of [24 fps, 30 fps] according to the MPEG standard specification, the frame rate of a sequence of MPEG I-pictures at 15 fps needs to be up-converted into a supported frame rate such as 30 fps shown in 3506. To convert a sequence of MPEG I-pictures at 15 fps 3504 to a 30 fps MPEG-compatible video stream 3506, a replica of each I-picture 3508 is encoded as a P-picture 3510, inserted immediately after the I-picture so that the frame rate of the resulting video stream is doubled. Herein, the replica is encoded as a P-picture by using a skipped macroblock to reduce the computation during the step of frame rate conversion, and to reduce the bit rate of the resulting MPEG video stream since a macroblock to be encoded as a P-macroblock has (0,0) motion vector and no difference in pixel values exists between the corresponding macroblocks of I- and P-pictures. However, to conform to the MPEG specification, the first macroblock 3602 and the last macroblock 3604 of a slice must not be skipped as illustrated in FIG. 36. The disclosed technique can be easily extended to convert a video stream with a given frame into a video stream with a different frame rate in a variety of ways. For example, the computation needed for transcoding from a 15 fps video to a 30 fps video can be further reduced by skipping appropriate 5 frames out of every 15 frames of an input video and then inserting two replicated P-pictures for every I-picture, resulting in a pattern like IPPIPPIPPIPP . . . for the resulting MPEG-1/2 video.

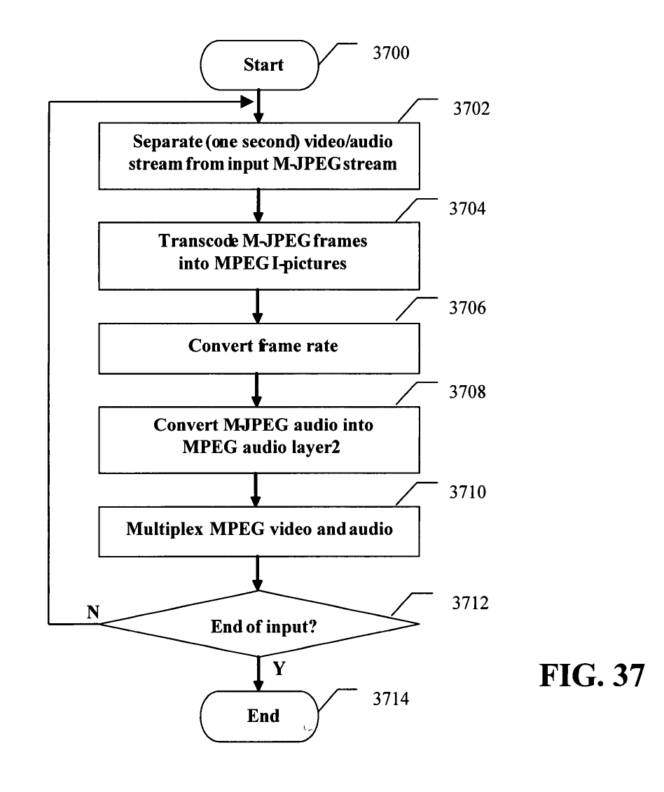

FIG. 37 illustrates a flow chart of the present disclosure on an M-JPEG to MPEG-1/2 transcoding scheme, especially for incrementally converting an original low frame rate M-JPEG video stream into a suitable frame rate MPEG-1/2 video stream. At Step 3702, a predetermined amount of an input M-JPEG stream (for example, one second) is demultiplexed into a JPEG frame sequence and an audio stream (for example, WAVE). At Step 3704, each of the M-JPEG images is converted into MPEG I-picture as follows: First, the M-JPEG image stream is source-decoded by a variable length decoding block (Huffman decoding). Then, the MCU blocks of a JPEG image are converted to macroblocks of a MPEG I-picture while the chroma subsampling mode used in M-JPEG is, if not supported by MPEG, converted into a chroma subsampling mode suitable for MPEG The quantization parameters used in M-JPEG is also passed to a MPEG I-frame bit stream. Finally, the step of source-encoding using a default MPEG Huffman table is performed. Note that during Step 3704, the DCT coefficients which are used in JPEG encoding are reused to reduce computation complexity. At Step 3706, the frame rate of an input video stream is adjusted to a frame rate suitable for the output video stream. At Step 3708, the audio stream demultiplexed from an input M-JPEG stream is transcoded into MPEG layer 2/3 audio stream. Since the bit rate of audio stream is usually much lower than that of video stream, the input audio stream can be fully decoded, and then re-encoded according to a second audio compression scheme. At Step 3710, the resulting video and audio streams encoded in MPEG are multiplexed into a single MPEG stream. Then, at Step 3712, it is checked if the whole input M-JPEG stream is transcoded.

Although the input and output video streams for a transcoding technique described in this provisional are assumed to be encoded by M-JPEG and MPEG, respectively, the disclosed technique can be applied to the transcoding between two streams encoded by any two compression schemes based a same transform coding technique (for example, DCT).

9. Media Localization for Broadcast Programs

To represent or locate a position in a broadcast program (or stream) that is uniquely accessible by both indexing systems and client DVRs is important to represent a bookmarked position for broadcast programs. To overcome the existing problem in localizing broadcast programs, a solution is disclosed in the above-referenced U.S. patent application Ser. No. 10/369,333 filed Feb. 19, 2003 using broadcasting time as a media locator for broadcast stream, which is a simple and intuitive way of representing a time line within a broadcast stream as compared with the methods that require the complexity of implementation of DSM-CC NPT in DVB-MHP and the non-uniqueness problem of the single use of PTS. Broadcasting time is the current time a program is being aired for broadcast. Techniques are disclosed herein to use, as a media locator for broadcast stream or program, information on time or position markers multiplexed and broadcast in MPEG-2 TS or other proprietary or equivalent transport packet structure by terrestrial DTV broadcast stations, satellite/cable DTV service providers, and DMB service providers. For example, techniques are disclosed to utilize the information on time-of-day carried in the broadcast stream in the system_time field in STT of ATSC/OpenCable (usually broadcast once every second) or in the UTC_time field in TDT of DVB (could be broadcast once every 30 seconds), respectively. For Digital Audio Broadcasting (DAB), DMB or other equivalents, the similar information on time-of-day broadcast in their TSs can be utilized. In this disclosure, such information on time-of-day carried in the broadcast stream (for example, the system_time field in STT or other equivalents described above) is collectively called “system time marker”.

An exemplary technique for localizing a specific position or frame in a broadcast stream is to use a system_time field in STT (or UTC_time field in TDT or other equivalents) that is periodically broadcast. More specifically, the position of a frame can be described and thus localized by using the closest (alternatively, the closest, but preceding the temporal position of the frame) system_time in STT from the time instant when the frame is to be presented or displayed according to its corresponding PTS in a video stream. Alternatively, the position of a frame can be localized by using the system_time in STT that is nearest from the bit stream position where the encoded data for the frame starts. It is noted that the single use of this system_time field usually do not allow the frame accurate access to a stream since the delivery interval of the STT is within 1 second and the system_time field carried in this STT is accurate within one second. Thus, a stream can be accessed only within one-second accuracy, which could be satisfactory in many practical applications. Note that although the position of a frame localized by using the system_time field in STT is accurate within one second, an arbitrary time before the localized frame position may be played to ensure that a specific frame is displayed. It is also noted that the information on broadcast STT or other equivalents should also be stored with the AV stream itself in order to utilize it later for localization.

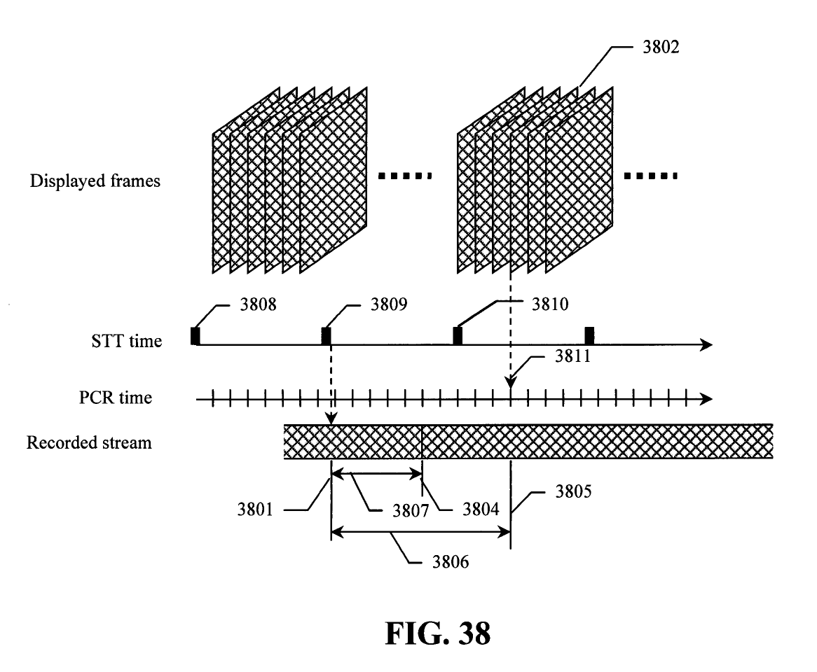

Another method is disclosed to achieve (near) frame-accurate access or localization to a specific position or frame in a broadcast stream. A specific position or frame to be displayed is localized by using both system_time in STT (or UTC_time in TDT or other equivalents) as a time marker and relative time with respect to the time marker. More specifically, the localization to a specific position is achieved by using system_time in STT that is a preferably first-occurring and nearest one preceding the specific position or frame to be localized, as a time marker. Additionally, since the time marker used alone herein does not usually provide frame accuracy, the relative time of the specific position with respect to the time marker is also computed in the resolution of preferably at least or about 30 Hz by using a clock, such as PCR, STB's internal system clock if available with such accuracy, or other equivalents. It is also noted that the information on broadcast STT or other equivalents should also be stored with the AV stream itself in order to utilize it later for localization. FIG. 38 illustrates how to localize the frame 3802 using system_time in STT and relative time. The positions 3808, 3809 and 3810 correspond to the broadcast STTs, respectively. Assume that the STT is broadcast once every 0.7 seconds. Then, the STTs at 3809 and 3810 could have the same values of system_time due to round-off whereas the STT in 3808 has a distinct system_time. The system_time or time marker for 3802 is the STT at 3809 obtained by finding the first-occurring and nearest STT preceding 3802. The relative time is calculated from the position of the TS packet carrying the last byte of STT containing system_time 3809 in resolution of at least or about 30 Hz. The relative time 3806 for the position 3802 could be calculated by the difference of PCR values between 3805 and 3801 in resolution of 90 kHz. Alternatively, the localization to a specific position may be achieved by interpolating or extrapolating the values of system_time in STT (or UTC_time in TDT or other equivalents) in the resolution of preferably at least or about 30 Hz by using a clock, such as PCR, STB's internal system clock if available with such accuracy, or other equivalents.

Another method is disclosed to achieve (near) frame-accurate access or localization to a specific position or frame in a broadcast stream. The localization information on a specific position or frame to be displayed is obtained by using both system_time in STT (or UTC_time in TDT or other equivalents) as a time marker and relative byte offset with respect to the time marker. More specifically, the localization to a specific position is achieved by using system_time in STT that is a preferably first-occurring and nearest one preceding the specific position or frame to be localized, as a time marker. Additionally, the relative byte offset with respect to the time marker maybe obtained by calculating the relative byte offset from the first packet carrying the last byte of STT containing the corresponding value of system_time. It is also noted that the information on broadcast STT or other equivalents should also be stored with the AV stream itself in order to utilize it later for localization. FIG. 38 also illustrates how to localize the frame 3802 using system_time in STT and relative byte offset. Assume also that the STT is broadcast once every 0.7 seconds. Then, the STTs at 3809 and 3810 could have the same values of system_time due to round-off whereas the STT in 3808 has a distinct system_time. The system_time or time marker for 3802 is the STT at 3809 obtained by finding the first-occurring and nearest STT preceding 3802. The position 3804 is the byte position of the recorded bit stream where the encoded frame data starts. The position 3801 is the byte position of the recorded bit stream corresponding to the position of the TS packet carrying the last byte of STT containing system_time 3809. The relative byte offset 3807 is obtained by subtracting the byte position 3804 from 3804.

Another exemplary method for frame-accurate localization is to use both system_time field in STT (or UTC_time field in TDT or other equivalents) and PCR. The localization information on a specific position or frame to be displayed is achieved by using system_time in STT and the PTS for the position or frame to be described. Since the value of PCR usually increases linearly with a resolution of 27 MHz, it can be used for frame accurate access. However, since the PCR wraps back to zero when the maximum bit count is achieved, we should also utilize the system_time in STT that is a preferably nearest one preceding the PTS of the frame, as a time marker to uniquely identify the frame. FIG. 38 illustrates the corresponding values of system_time 3810 and PCR 3811 to localize the frame 3802. It is also noted that the information on broadcast STT or other equivalents should also be stored with the AV stream itself in order to utilize it later for localization.

It will be apparent to those skilled in the art that various modifications and variations can be made to the techniques described in the present disclosure. Thus, it is intended that the present disclosure covers the modifications and variations of the techniques, provided that they come within the scope of the appended claims and their equivalents.

1. A multimedia bookmark (VMark) bulletin board service (BBS) system comprising:
a web host comprising storage for messages, a web server, and a VMark BBS server;
a media host comprising storage for audiovisual (AV) files, and a streaming server;
a client comprising storage for VMark, a web browser, a media player and a VMark client;
a VMark server located at the media host or at the client; and
a communication network connecting the web host, the media host and the client.

2. The BBS system of claim 1, wherein:
the media host comprises the VMark server for capturing a multimedia bookmark image at a requested bookmarked position of a given AV file stored at the storage of the media host and sending the image to the multimedia bookmark client of the client through the communication network.

3. The BBS system of claim 1, wherein
the client comprises the VMark server for capturing a multimedia bookmark image at a requested bookmarked position of a given AV file being played at the media player and passing the image to the multimedia bookmark client of the client locally.

4. The BBS system of claim 1, further comprising:
means for creating the VMark for a bookmarked position in a given AV file; and
means for saving the VMark in the client storage.

5. The BBS system of claim 1, further comprising:
means for uploading the VMark to the VMark BBS server; and
means for retrieving a message including the VMark of a given AV file from the VMark BBS server and playing the AV file from a bookmarked position without manually locating a bookmarked position in the AV file.

6. A method of performing a multimedia bookmark bulletin board service (BBS) comprising:
creating a message including a multimedia bookmark for an AV file; and
posting the message into the multimedia bookmark BBS.

7. The method of claim 6, wherein:
the message comprises a body section and a multimedia bookmark section.

8. The method of claim 6, further comprising:
reading the message from the BBS.

9. The method of claim 6, further comprising:
monitoring multimedia bookmark servers running at media hosts; and
reporting multimedia bookmark usage information.

10. The method of claim 6, further comprising:
generating advertising multimedia bookmarks; and
attaching the advertising multimedia bookmarks to user's e-mails and news letters of a BSS provider.

11. The method of claim 6, further comprising:
generating a multimedia bookmark storyboard of an AV file.

12. A method of sending multimedia bookmark (VMark) between clients comprising:
at a first client, making a VMark indicative of a bookmarked position in an AV program;
sending the VMark from the first client to a second client; and
playing the program at the second client from the bookmarked position.

13. The method of claim 12, wherein the VMark comprises:
bookmarked position; and
descriptive information of the program.

14. The method of claim 13, wherein the VMark further comprises one or more of the following:
Uniform Resource Identifier (URI) of a bookmarked program;
content information such as an image captured at a bookmarked position;
textual annotations attached to a segment that contains the bookmarked position;
title of the bookmark;
metadata identification (ID) of the bookmarked program; and
bookmarked date.

15. The method of claim 12, wherein:
if, previous to sending the VMark from the first client to a second client, the AV program has been recorded at the second client, playing the program at the second client from the bookmarked position; and
if, previous to sending the VMark from the first client to a second client, the AV program has not been recorded at the second client, recording the program later at the second client, then playing the program from the bookmarked position; and
recording the program later comprises:
rebroadcasting the program later; or
broadcasting the program on a different channel.

16. The method of claim 12, wherein:
if, previous to sending the VMark from the first client to a second client, the AV program has not been recorded at the second client, recording the program later at the second client, then playing the program from the bookmarked position; and
recording the program later comprises:
searching an electronic program guide (EPG) for the program utilizing descriptive information of the program included in the VMark; or
searching remote media hosts connected with a communication network for the program utilizing descriptive information of the program included in the VMark.

17. The method of claim 16, further comprising:
at the second client, keeping information on location resolution for associating the descriptive information of the recorded or downloaded program with the physical location of the program stored in local storage; and
searching the information on location resolution for the program when playing the program.

18. A system for sharing multimedia content comprising:
a multimedia bookmark bulletin board system (BBS); and
means for posting a multimedia bookmark to the BBS.

19. The system of claim 18, further comprising:
means for creating a multimedia bookmark for a bookmarked position in an AV file;
means for saving the multimedia bookmark in the client storage; and
means for uploading a message including the multimedia bookmark for the AV file into the multimedia bookmark BBS server.

20. The system of claim 18, further comprising:
means for retrieving a message including the multimedia bookmark for an AV file from the multimedia bookmark BBS server; and
means for playing the AV file by utilizing the multimedia bookmark without manually locating the bookmarked position in the AV file.
